(19) United States
(12) Patent Application Publication
(10) Pub. No.: US 2026/0350775 A1
(43) Pub. Date: Nov. 5, 2026

(54) WORKPIECE THERMAL PROCESSING MANAGEMENT SYSTEM

(71) Applicant: JBT Marel Corporation, Chicago, IL (US)

(72) Inventors: Jon A. Hocker, Fort Collins, CO (US); Richard D. Stockard, La Jolla, CA (US); Chandler C. Steele, New Braunfels, TX (US); George R. Blaine, Lake Stevens, WA (US)

(73) Assignee: JBT Marel Corporation, Chicago, IL (US)

(21) Appl. No.: 19/667,350

(22) Filed: May 4, 2026

Related U.S. Application Data
(60) Provisional application No. 63/799,535, filed on May 3, 2025.

(51) Int. Cl. G06T 7/00; G06T 7/40; G06T 15/08

(52) U.S. Cl. CPC G06T 7/0004; G06T 7/40; G06T 15/08; G06T 2207/10024; G06T 2207/30128

(57) ABSTRACT

A computer-implemented method of performing a quality assurance (QA) analysis for a thermally processed QA sample may include: capturing QA image sensor data of a QA sample with an image sensor assembly of a QA system; generating, with a computing device, at least one of a 2D model and a 3D model of the QA sample using the QA image sensor data; calculating, with a temperature measurement assembly, freezing curve data of the QA sample; performing, with a computing device, a QA analysis of the QA sample including comparing the freezing curve data of the QA sample with QA specification freezing curve data; and outputting, with a computing device, at least one of QA analysis data and thermal processing system adjustment instructions based on the comparison of the freezing curve data of the QA sample with the QA specification freezing curve data.

### CROSS REFERENCE TO RELATED APPLICATION

This application claims the benefit of U.S. Provisional Application No. 63/799535, filed May 3, 2025, the entire contents of which are incorporated herein by reference.

### BACKGROUND

For obvious reasons, it is vitally important in the industrial food processing industry to fully cook food products prior to packaging. Such food products may not be subjected to any further step or process for killing bacteria prior to consumption of the food. Moreover, the performance of an industrial food processing system, such as an oven, fryer, steamer, roaster, chiller, or freezer can be significantly impacted by physical attributes of the food product, such as the thickness of the food product. Often, food product thickness can vary between batches or can trend thicker throughout a production shift without detection by personnel. If, for example, a new batch of food product enters a cooking process, and the average thickness of the new food product is larger than the thickness of the prior batch, it is desirable to proactively control the thermal process to insure proper cooking.

Such proactive control is not widely practiced today. Typically, the control process is largely reactive. When an undercooked or otherwise under processed food product is detected as it leaves a thermal processing station, personnel typically respond by manually adjusting process settings.

In an effort to reduce the likelihood of food products not being fully cooked or otherwise not sufficiently thermally processed, the current food industry practice is to adjust the cooking or other thermal process so that the center of all of the workpieces reaches a minimum temperature, accounting for many process variations. Such desired minimum temperature typically is a temperature at which pathogens are instantaneously killed from the temperature of the food product. However, typically the desired temperature is higher than such kill temperature so that there is a desired confidence level that all of the food products have reached a sufficient temperature. Thus, the temperature to be achieved may be increased to a desired temperature of perhaps several standard deviations above the actual kill temperature. This approach can result in a significant proportion of the workpieces being overly-cooked or otherwise overly-processed, which causes a decrease in yield as well as a decrease in profit because the overcooking or overthermal processing drives off moisture from the food product, resulting in a reduction in the weight of the processed food product as well as its quality.

Applicants estimate that eliminating the overcooking in a single process line can result in an economic savings of hundreds of thousands of dollars per year. Other benefits include a reduction in labor required to monitor, control, and report on the process, a reduction in unscheduled sanitation procedures of the thermal processing system, including the thermal processing station and the conveyance systems removing the food product to and from the thermal processing station, as well as increased production line operational time.

Similar benefits can accumulate by reducing the likelihood of food products not being fully frozen or otherwise not sufficiently thermally processed. Under-frozen food, often caused by temperatures above a threshold temperature and/or inconsistent freezing, leads to significant quality loss, including mushy textures, reduced moisture, and increased risk of microbial growth. Overly frozen foods, which can be caused by temperatures below a threshold temperature, can compromise food quality and indicate energy waste. For instance, overly frozen product can become brittle and break when removed from a conveyor belt if the product freezes firmly to the belt. Further, when a product is overly frozen, more energy is used during the thermal process than is generally needed. In that regard, the thermal process can be made more efficient, such as by increasing belt speed and/or increasing loading density (which leads to higher throughput), reducing fan speed, increasing temperature, etc., or any combination thereof.

Systems and methods disclosed herein relate to improvements for industrial thermal processing of workpieces such as food products.

### BRIEF SUMMARY

In some aspects, the techniques described herein relate to a computer-implemented method of performing a quality assurance (QA) analysis for a QA sample that is at least one of thermally processed by a thermal processing system and to be thermally processed by a thermal processing system, the method including: capturing QA image sensor data of a QA sample with an image sensor assembly of a QA system; generating, with a computing device, at least one of a 2D model and a 3D model of the QA sample using the QA image sensor data; calculating, with a temperature measurement assembly, freezing curve data of the QA sample; performing, with a computing device, a QA analysis of the QA sample including comparing the freezing curve data of the QA sample with QA specification freezing curve data; and outputting, with a computing device, at least one of QA analysis data and thermal processing system adjustment instructions based on the comparison of the freezing curve data of the QA sample with the QA specification freezing curve data.

In some aspects, the techniques described herein relate to a computer-implemented method of performing a quality assurance (QA) analysis for a QA sample that is at least one of thermally processed by a thermal processing system and to be thermally processed by a thermal processing system, the method including: capturing QA image sensor data of a QA sample with an image sensor assembly of a QA system; generating, with a computing device, at least one of a 2D model and a 3D model of the QA sample using the QA image sensor data; determining, with a computing device, a temperature measuring location of the QA sample using the at least one of 2D model and 3D model of the QA sample; automatically obtaining, with a temperature measurement assembly, an internal temperature of the QA sample at the temperature measuring location; performing, with a computing device, a QA analysis of the QA sample including comparing the internal temperature of the QA sample at the temperature measuring location with a QA specification temperature of the QA sample; and outputting, with a computing device, at least one of QA analysis data and thermal processing system adjustment instructions based on the comparison of the internal temperature of the QA sample at the temperature measuring location with the QA specification temperature of the QA sample.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### BRIEF DESCRIPTION OF THE SEVERAL VIEWS OF THE DRAWINGS

To easily identify the discussion of any particular element or act, the most significant digit or digits in a reference number typically refer to the figure number in which that element is first introduced.

FIG. 1 illustrates an exemplary workpiece thermal processing management system in accordance with examples herein.

FIG. 2A illustrates a side view of an exemplary spiral conveyor-based thermal processing system suitable for use with a workpiece thermal processing management system described herein.

FIG. 2B illustrates a top view of the exemplary spiral conveyor-based thermal processing system of FIG. 2A.

FIG. 2C illustrates an exemplary industrial freezer suitable for use with a workpiece thermal processing management system described herein.

FIG. 3 illustrates a block diagram of a non-limiting example of a machine computing device according to various aspects of the present disclosure.

FIG. 4A illustrates a side view of an exemplary quality assurance (QA) station formed in accordance with systems and methods disclosed herein.

FIG. 4B illustrates a front view of the exemplary QA station of FIG. 4A.

FIG. 4C illustrates a first isometric view of the exemplary QA station of FIG. 4At.

FIG. 4D illustrates a second isometric view of the exemplary QA station of FIG. 4A.

FIG. 4E illustrates a schematic view of a portion of the exemplary QA station of FIG. 4A.

FIG. 4F illustrates an isometric view of an exemplary QA station formed in accordance with systems and methods disclosed herein.

FIG. 5 illustrates a front view of an exemplary QA station formed in accordance with systems and methods disclosed herein.

FIG. 6 illustrates a flowchart of a non-limiting example of a method of measuring enthalpy of a QA sample according to various aspects of the present disclosure.

FIG. 7 illustrates a block diagram of a non-limiting example of a QA computing device according to various aspects of the present disclosure.

FIG. 8 illustrates a graph of core temperature measurement for QA samples over a period of time according to various aspects of the present disclosure.

FIG. 9A illustrates a QA image for use in a texture analysis module according to various aspects of the present disclosure.

FIG. 9B illustrates the QA image of FIG. 9A filtered with a computing device for use in a texture analysis module according to various aspects of the present disclosure.

FIG. 10A illustrates a QA image for use in a texture analysis module according to various aspects of the present disclosure.

FIG. 10B illustrates the QA image of FIG. 10A filtered with a computing device for use in a texture analysis module according to various aspects of the present disclosure.

FIG. 10C illustrates the QA image of FIG. 10B filtered with a computing device for use in a texture analysis module according to various aspects of the present disclosure.

FIG. 11 illustrates a flowchart of a non-limiting example of a method of performing a QA analysis for a QA sample according to various aspects of the present disclosure.

FIG. 12 illustrates a block diagram of a non-limiting example embodiment of a computing device appropriate for use as a computing device according to various aspects of the present disclosure.

FIG. 13 illustrates an annotated graphical depiction or curve of a typical food freezing process based on known principles of heat transfer, with temperature on the y-axis and time on the x-axis.

### DETAILED DESCRIPTION

As discussed above, obtaining an accurate core or internal temperature of cooked or otherwise heated food products is difficult. Not knowing the exact location to probe for the lowest internal temperature is challenging. Thus, the food products may be cooked to a final target temperature that is higher than needed to reach the actual kill temperature during equilibration. However, as also noted above, such an approach can result in a significant proportion of the workpieces being overly-cooked or otherwise overly-processed, which causes a decrease in yield as well as a decrease in profit because the overcooking or over thermal processing drives off moisture from the food product, resulting in a reduction in the weight of the processed food product as well as its quality.

Eliminating overcooking in a single process line can result in an economic savings of hundreds of thousands of dollars or much more per year. This economic benefit arises from not having to cook or otherwise thermally process the food products based on the thickest, largest, or otherwise maximum or extreme food product in the population being processed. Other benefits include: (1) a reduction in labor required to monitor, control, and report on the process, (2) a reduction in unscheduled sanitation procedures of the thermal processing system, including the thermal processing station and the conveyance systems removing the food product to and from the thermal processing station, as well as (3) increased production line operational time.

The temperature of a cooked or otherwise heated food product leaving a thermal processing station is typically measured manually by inserting a thermal couple probe into the processed food product hopefully at or near the mass center of the workpiece. However, it is difficult for personnel to accurately determine where the mass center of the workpiece is located. An additional difficulty and source of temperature measurement error exists in placing the temperature probe at the estimated center of the workpiece even if the operator believes that he or she has identified the mass center. Moreover, a further source of error occurs when the measuring tip of the probe is positioned in what is thought to be the mass center of the workpiece, but in actuality is a void in the workpiece. A slight change in the position of a thermal probe can result in a significant difference in the temperature reading achieved, especially if the temperature probe is placed into a void in the workpiece.

With regards to frozen or cooled food products, it is also difficult to obtain an accurate internal temperature. A probe cannot be easily inserted into a frozen product, which is typically rigid after a freezing process due to ice crystal formation.

Yet a further source of error occurs when the time varies between picking the product from the cooking line to when it is measured. As can be appreciated, a temperature of a product changes quickly when it leaves a thermal processing system.

Carryover cooking (sometimes referred to as resting or equilibration) is when foods are halted from actively cooking and allowed to equilibrate under their own retained heat. Because foods such as meats are typically measured for cooking temperature near the center of mass as noted above, stopping cooking at a given central temperature means that the outer layers of the food will be at higher temperature than that measured. Heat therefore will continue to migrate inwards from the surface, and the food will cook further even after being removed from the source of heat.

In industrial cooking, an equilibration zone may be used to allow carryover cooking of a food product after leaving a thermal processing system, e.g., an oven. For instance, a food product may be thermally processed or cooked in an oven until the product presumably reaches a cooked level having a minimum core temperature. After leaving the oven, the food product may spend a certain amount of time in the equilibration zone to allow it to equilibrate under its own retained heat. However, the equilibration process must be appropriately managed to achieve an adequate core temperature and prevent bacteria growth in the outer layers of the food.

Moreover, thermal process variations can lead to inconsistent food product (e.g., core) temperatures at the exit of the thermal processing machine. For instance, workpieces vary in size and thickness and location in the thermal processing machine (e.g., at an inner or outer portion of a spiral belt). Moreover, thermal processing machine conditions such as temperature, humidity and workpiece load density vary between workpieces of a production run(s). Moreover, QA testing variations include core location determination, probe placement, voids at the core, and time between picking and probing the workpiece.

Sampling for food product (e.g., core) temperatures at the exit of the thermal processing machine (and/or at the end of an equilibration zone) can be done for only a small fraction of the workpieces being cooked or frozen, so a margin of error is built in to account for core temperature variation and/or time-temperature variation in all the workpieces from all the sources of variation, even those workpieces not sampled. Generally, for cooked products, sampling is done by collecting “core” temperature data from the products being processed, finding the temperature distribution data among the samples, and setting the thermal processing machine to achieve a target core temperature as two, three or more standard deviations above (or below) the mean of the data distribution. Note that different companies set their targets differently, for instance they may use two or three standard deviations from the mean of the largest measured workpieces, or a minimum kill temperature for the type of workpiece (e.g., 165 F. (the minimum kill temperature for poultry) plus 10 degrees, plus two standard deviations, etc.). A margin of safety may also be factored into the target core temperature based on variations in both time and temperature when using time-temperature calculations.

In an effort to at least partially automate the temperature measurement function of cooked or otherwise thermally processed food products, “pick-and-place” robots have been contemplated. The envisioned systems and equipment are situated over the food product stream, are used to remove selected food products from the food product stream and then transmit the food products to a temperature measurement location or station, where manual temperature measurement of the selected food product takes place.

Because improperly or underthermally processed food products present a high safety risk, a highly hygienic solution is desired to ensure that the food products are fully cooked or otherwise fully thermally processed. As such, it is desirable to have minimal equipment situated over the food product traveling to a thermal processing station, during thermal processing at the thermal processing station, as well as traveling away from the thermal processing station, unless the equipment in question operates at a cooking temperature, or is otherwise maintained at a highly hygienic state. Complex equipment located over food product being thermally processed presents a contamination hazard since contaminated droplets of water or other moisture can fall on the cooked or otherwise thermally processed food product. Moreover, oil and water droplets can cause instrumentation issues. For instance, if oil and water collect on a lens of a vision system, the vision system will produce faulty vision data.

Yet further, available systems that automatically pick a workpiece from a food product stream and obtain thermal processing-related data, such as temperature data, image data, and/or weight data are complex and expensive. In that regard, many industrial food processors are resistant to buy or implement such systems.

Systems and methods disclosed herein pertain to obtaining QA data of thermally processed workpieces, including particularly food products, in a semi-automated or automated, efficient, accurate, and consistent/repeatable manner such that necessary adjustments to the thermal processing and/or upstream or downstream processing of the work products can be made. In that regard, using the systems and methods disclosed herein, variation in thermally processed workpiece sampling data may be reduced, among other benefits. For instance, higher quality, more reliable data can be used to more effectively control workpiece thermal processing and associated processes, leading to increased yield and reduced costs. Further, reliable data generated using the systems and methods disclosed herein can help demonstrate the quality and safety of a thermally processed food product. The data can be made available to a purchaser of the thermally processed food product, such as part of routine quality inspections. These and many other benefits will become further appreciated herein.

In some aspects, systems and methods disclosed herein pertain to measuring a weight, size, and temperature of thermally processed food products in a semi-automated or automated, efficient, accurate, and consistent/repeatable manner to determine the degree of thermal treatment applied to the food product, and making necessary adjustments to the thermal processing based on the results of the temperature measurements. For instance, the exemplary thermal processing QA systems and methods disclosed herein may be used to obtain accurate dimensions of a thermally processed workpiece, such as by using data from one or more sensors configured to capture image data of the processed workpiece. Using the image data and any other suitable data, the exemplary thermal processing QA systems and methods disclosed herein may be used to determine a coldest part of a cooked food product (or the hottest part of a cooled product), often the core/centroid, and automatically place a temperature measuring device (e.g., a probe) in position to obtain a temperature measurement of the centroid. In some examples, the exemplary thermal processing QA systems and methods disclosed herein may be used to obtain information regarding a freezing curve of a workpiece, such as an enthalpy measurement of the workpiece, a hardness of the workpiece, a volume change of a workpiece, etc. In some examples, the exemplary thermal processing QA systems and methods disclosed herein may be used to obtain accurate weight measurements of a processed workpiece, and the weight measurements may be obtained substantially simultaneously with any image data. The weight data can be used together with dimensional data of a processed workpiece to determine a coldest part of a cooked food product (or the hottest part of a cooled product), to determine freezing curve data of a frozen food product, etc.

Examples of the present disclosure are also directed to thermal processing QA systems and methods that may be used to assess attributes of a workpiece, such as a quality of a workpiece after it is thermally processed. In some aspects, thermal processing QA systems and methods disclosed herein pertain to obtaining data regarding at least one aesthetic attribute of a thermally processed workpiece (e.g., a food product surface texture, markings, etc.) in a semi-automated or automated, efficient, accurate, and consistent/repeatable manner, and making necessary adjustments to upstream or downstream processing of the workpieces based on the results of the analysis.

Temperature data, image data, weight data, enthalpy data, hardness data, volume data, and any other data pertaining to a workpiece (hereinafter sometimes collectively “thermally processed workpiece QA data”, “QA data”, or the like) that is gathered by thermal processing QA systems and methods (such as machine learning model output data, as discussed below) may be processed by a computing device(s) of the system for assessing one or more attributes of a workpiece that is at least partially thermally processed or that is to be thermally processed.

For example, temperature data may be used with weight and dimensional data of a cooked workpiece to determine an amount of time at a given temperature required to achieve a desired level of pathogen reduction in the workpiece. More specifically, per food safety regulations, a cooked food product needs to simply reach a minimum pathogen kill temperature to achieve a required level of reduction of pathogens in the food product. Such pathogens can be killed over time, with the rate of kill depending on the temperature of the cooked food product achieved. If the temperature profile of the cooked food product over time is known, then the level of pathogen killed in the cooked food product can be determined.

The temperature profile of the cooked food product over time, or the process lethality data, may be used to make adjustments to the thermal processing and/or adjustments to upstream or downstream processing of the food product based on the results of the analysis. If such temperature profile can be determined with accuracy, then thermal processing parameters may be sufficiently tailored to the cooked food product in question, rather than having to take the potentially less efficient strategy of ensuring that all the food products have been heated to above the instantaneous kill temperature of the pathogens in question while accounting for many process variations. For instance, one or more of belt speed, workpiece spacing on the belt, and temperature, moisture, and/or airflow velocity in a thermal processing system may be adjusted.

Temperature data, enthalpy data, hardness data, volume data, etc., of a frozen food product may be used with dimensional and/or weight data of the frozen food product to determine whether the frozen food product is sufficiently frozen. Such data may be used to optimize an industrial freezing process.

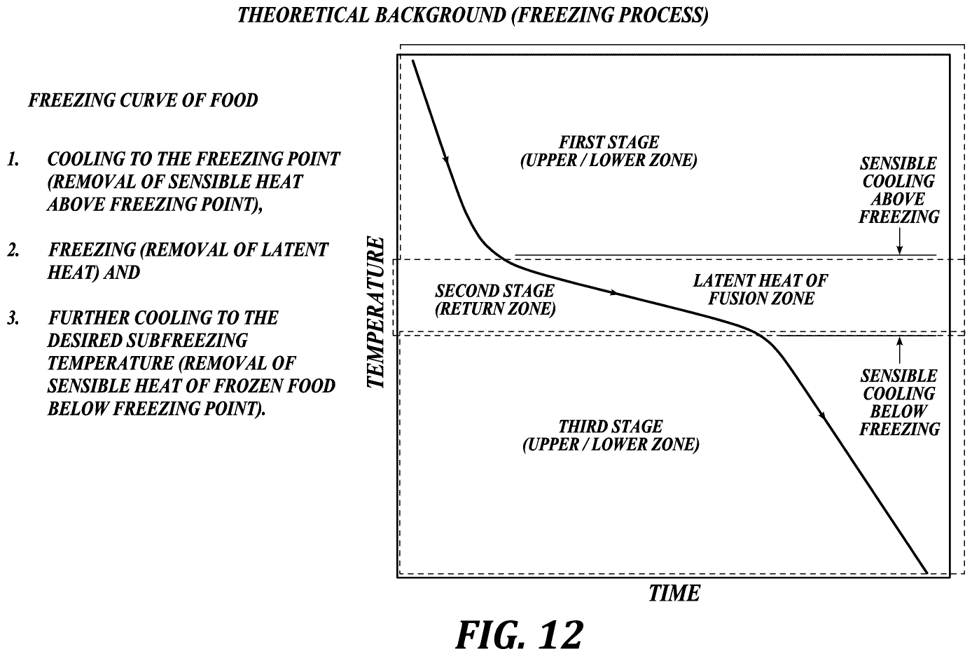

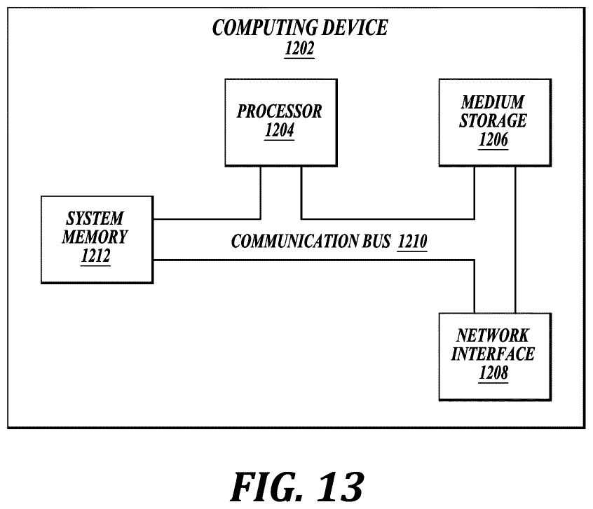

To better understand aspects of a freezing process, an annotated graphical depiction or curve of a typical food freezing process based on known principles of heat transfer, with temperature on the y-axis and time on the x-axis, will now be described with reference to FIG. 12. Different foods require different freezing temperatures and have different complexities, but they all generally adhere to a basic freeze curve as shown.

A first stage of freezing typically occurs when a food product is first subjected to a low temperature. In this first stage, sensible heat is rapidly removed from the food product, and the food product is cooled from an initial temperature to the freezing point. The graphical profile of this first stage is shown as a rapid drop in temperature over a short period of time.

The second phase of food freezing generally includes a phase change as water within the product turns into ice. During this second phase (also known as the “latent heat of fusion zone” or simply the “latent zone”), the rate of temperature change in the product decreases dramatically and the time at which the change occurs increases. The second phase of the typical food freezing curve shows the temperature remaining substantially constant at the freezing point for a long time as water changes to ice, which requires added energy. The constant temperature results because the hidden heat, called latent heat, must be removed before every water molecule in the food product can change its state.

In the third or last phase of cooling, sensible heat transfer again occurs, and the food product is sub-cooled to a temperature below the freezing point. The freezing curve shows that the product is cooled well past the freezing point until a target temperature is reached. The graphical profile of the third phase is like the first phase of freezing in that the temperature change is rapid while the time element is much shorter. Generally, an industrial freezing process must cool the food product at least through the second stage of freezing. If the product is still in the latent zone at the end of the industrial freezing process, the product is under-frozen. As noted above, insufficient freezing leads to significant quality loss in the food product, including mushy textures, reduced moisture, and increased risk of microbial growth.

In some examples, when a frozen workpiece is out of spec (e.g., under or over frozen), a calculated and/or predicted freezing curve of the workpiece may be different than a required freezing curve, the stage of the freezing curve achieved for the workpiece by a thermal process may be different than a required stage, or the like. The systems and methods disclosed herein may be used to determine how far out of spec the frozen workpiece is (e.g., the freeze quality) and provide a list of possible corrective actions that may be taken by personnel and/or automatically change a setting in the freezer or another machine associated with the freezer (e.g., an upstream oven).

As used herein, the term “frozen QA sample”, “frozen food”, “frozen product”, “frozen workpiece”, or the like may refer to a food product or workpiece that has been subjected to one or more stages of freezing. As used herein, the phrase “freezing curve” of a frozen workpiece may refer to a calculated freezing curve of the frozen workpiece, a predicted freezing curve of the frozen workpiece, information regarding a stage of the freezing curve achieved for the workpiece by a thermal process, or any combination thereof.

As another example, image data of a workpiece may be used to determine if an appearance of the workpiece is within allowed specifications. For instance, image data of a breaded workpiece may be used to determine if the breading texture is within specification, if breading voids are present, if char or grill marks are within specification (“spec”), etc. In some examples, when a workpiece is out of spec, the systems and methods disclosed herein may be used to determine how far out of spec the workpiece is and provide a list of possible corrective actions that may be taken by personnel and/or automatically change a setting in a machine. It should be appreciated that image data may be used to assess a partially or fully thermally processed workpiece (e.g., a breaded workpiece that has been cooked) or that is to be thermally processed (e.g., a breaded workpiece that has not yet been cooked). In that regard, the term “thermally processed workpiece QA data” should not be seen as limiting.

In some examples, the thermal processing QA systems and methods disclosed herein may be used to assess a production run, such as by sending thermally processed workpiece QA data to a monitoring system for further processing. In some examples, the systems and methods disclosed herein may be used to identify one or more additional processing steps for the workpiece, such as sorting, picking, packaging, etc. In some examples, the QA systems and methods disclosed herein may be used to perform a global optimization to assign the thermally processed workpiece to a package configuration based on the assessment.

Other examples of thermally processed workpiece QA data collection, analysis, and use will become appreciated.

As will also become appreciated, the thermal processing QA systems and methods disclosed herein allow a user to obtain significantly higher accuracy thermally processed workpiece QA data, such as compared to data obtained from manual measurements taken with a probe or by visual or manual subjective inspection. Further, the thermally processed workpiece QA data obtained using the thermal processing QA systems and methods disclosed herein can be obtained in a fraction of the time it takes to perform manual measurements and/or observations. In addition, the thermal processing QA systems and methods disclosed herein are configured to directly process and use the thermally processed workpiece QA data without the need for any manual inputs, reducing or eliminating data transmission errors. The thermally processed workpiece QA data and any related data can be processed to determine appropriate machine adjustments, which may be carried out manually or automatically.

The thermal processing QA systems and methods disclosed herein can be used to obtain highly accurate thermally processed workpiece QA data in less time compared to prior art methods. Further, the semi-automated or automated nature of the thermal processing QA systems and methods disclosed herein enable sampling of a suitable number of workpieces with high accuracy and in a reasonable amount of time without the expense of a complex fully automated system.

The thermal processing QA systems and methods disclosed herein can be used to automatically record and store data for historical review. At least one of short and long term historical data may be used in controlling automation of a processing apparatus (e.g., automatically change a setting in the machine). For instance, a short term running average of historical thermally processed workpiece QA data may be used for control/automation, rather than using an instantaneous thermally processed workpiece QA data value. In other aspects, artificial intelligence, such as one or more machine learning models may use short and/or long term historical thermally processed workpiece QA data for baseline data and training one or more machine learning models.

In that regard, the thermal processing QA systems and methods disclosed herein can be used to continually train and update aspects of the thermal processing QA systems and methods during routine monitoring. For instance, the thermally processed workpiece QA data generated and processed by the thermal processing QA systems and methods disclosed herein may be used to train one or more machine learning models, which can be used to perform at least one of QA analysis, provide a list of possible corrective actions that may be taken, automatically change a setting in the machine, etc. The thermal processing QA systems and methods disclosed herein provide a comprehensive approach that assists QA personnel in the routine monitoring of production by providing faster, more accurate data with the ability to continually train and update the system during routine monitoring.

The foregoing benefits as well as other benefits will be further appreciated from the description that follows.

References to “work product”, “work piece”, “substrate”, “food item”, “food product”, “product”, “sample” or the like may be used synonymously. One example of a work product or workpiece is a food product, such as, for example, beef, pork, poultry, fish, vegetables, fruits, and nuts.

Moreover, “thermally processed workpiece” “processed workpiece”, “thermally processed QA sample”, “QA sample”, or the like may be used to generally refer to any workpiece, food product, etc., that is analyzed using the thermal processing QA systems and methods disclosed herein. In that regard, a “thermally processed workpiece” “processed workpiece”, “thermally processed QA sample”, “QA sample”, or the like may include a workpiece that has already been at least partially thermally processed by a thermal processing system, an incoming workpiece that has not yet been thermally processed, etc. Moreover, when referring to a “workpiece”, “food product”, or the like, it may also include a thermally processed QA sample or QA sample.

As used herein, the term “cooked QA sample”, “cooked food”, “cooked work product”, “heated food” or the like may refer to a food product or workpiece that has been subjected to one or aspects of a cooking process, such as cooking in an oven, a fryer, a steamer, roaster, etc. It should be appreciated that the work “cooked” or “heated” may be used to describe a workpiece that is only partially cooked or heated. Moreover, “temperature data”, a “temperature profile”, or the like of a cooked food product may include the profile/temperature of the food product immediately after a cooking process (e.g., to assess the core temperature achieved during a cooking process), and/or one or more of a core temperature and food outer layer(s) temperature during a carryover cooking process (e.g., to assess whether an adequate core temperature will be achieved and/or to determine the risk of bacteria growth in the outer layers of the food).

As noted above, the term “frozen QA sample”, “frozen food”, “frozen product”, “frozen workpiece”, or the like may refer to a food product or workpiece that has been subjected to one or more stages of freezing. Moreover, the phrase “freezing curve” of a frozen workpiece may refer to a calculated freezing curve of the frozen workpiece, a predicted freezing curve of the frozen workpiece, information regarding a stage of the freezing curve achieved for the workpiece by a thermal process, or any combination thereof.

It should further be understood that thermal processing is not limited to cooking or freezing of the food products, but rather could involve the chilling, proofing, drying, or cooling of food products. For instance, some food products are thermally processed to achieve a “super chilling” effect (e.g., in a high or warm end of the latent zone, e.g., near 0 C. or 32 F.), and it may be beneficial to determine whether a food product has been sufficiently cooled or over cooled. In this regard, the thermal processing QA systems and methods disclosed herein may be adapted for use with a chiller, proofer, dryer, refrigerator, or similar system, and the thermal medium can be a chilled or low temperature fluid medium that is cooled by a refrigeration system.

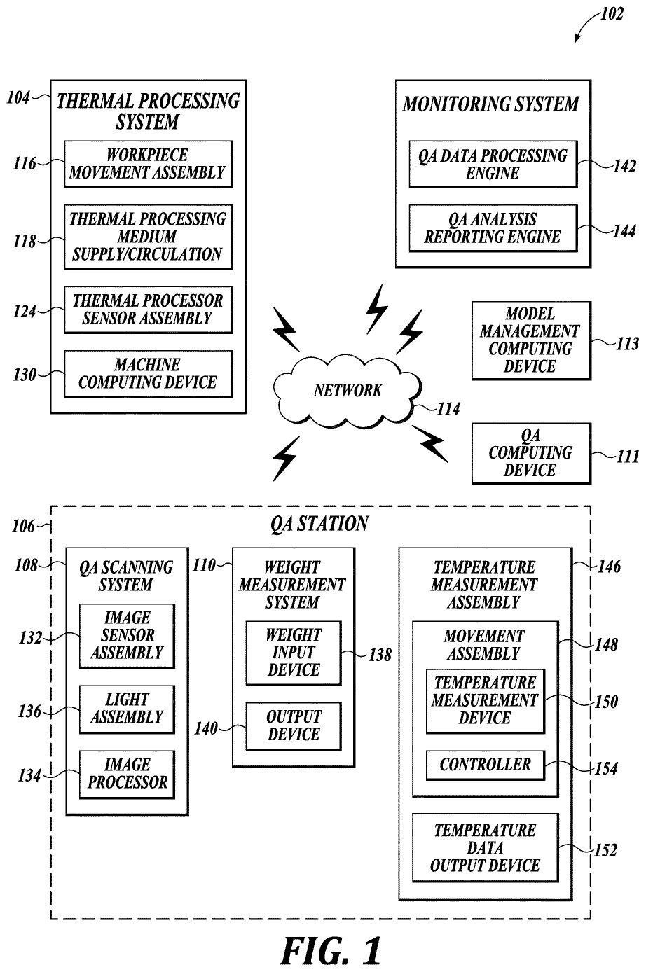

FIG. 1 depicts a schematic illustration of a non-limiting example of a workpiece thermal processing management system 102 that can be used to gather and process thermally processed workpiece QA data for assessing one or more attributes of a workpiece processed by a workpiece thermal processing machine or system and/or to be processed by the machine or system (or a “thermally processed QA sample”). The workpiece thermal processing management system 102 may include various networked computing devices configured for carrying out aspects of gathering and processing thermally processed workpiece QA data for assessing one or more attributes of the thermally processed QA sample, as well as other aspects of processing the thermally processed QA sample and/or workpieces of the same type (e.g., conveying, coating, cooking, frying, freezing, sorting, packaging, etc.).

In the depicted example, the workpiece processing management system 102 includes a thermal processing system 104, a QA station 106 having an integrated QA scanning system 108, weight measurement assembly 110, and temperature measurement assembly 146, a QA computing device 111, an optional monitoring system 112, and a model management computing device 113 communicatively coupled together through a network 114. The network 114 can be any kind of network capable of enabling communication between the various components of the workpiece thermal processing management system 102. For example, the network can be a WiFi network.

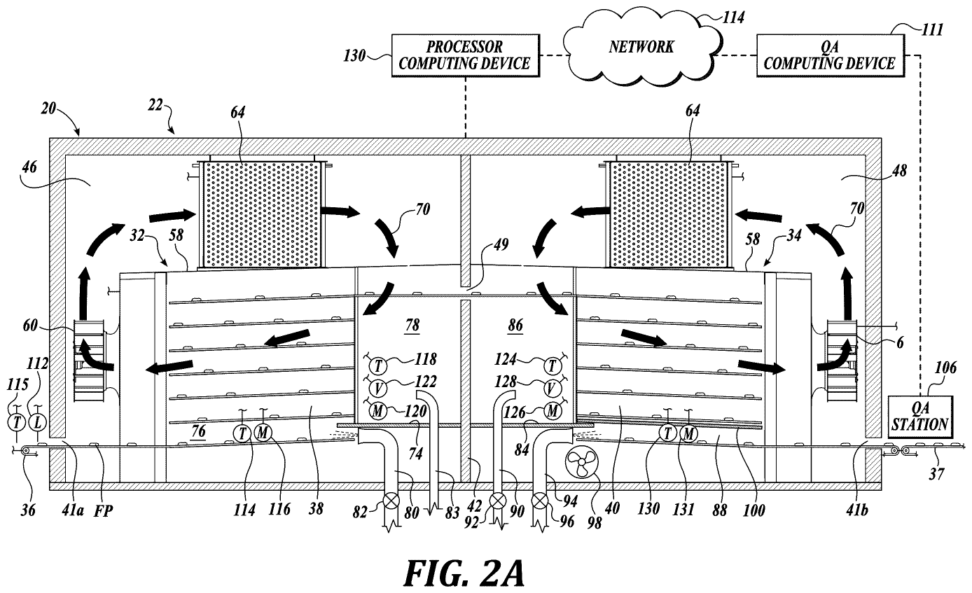

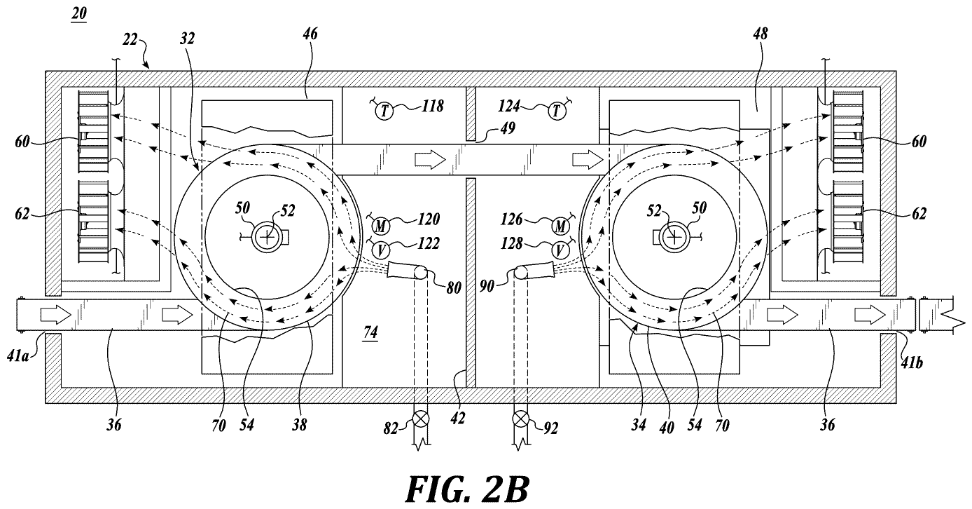

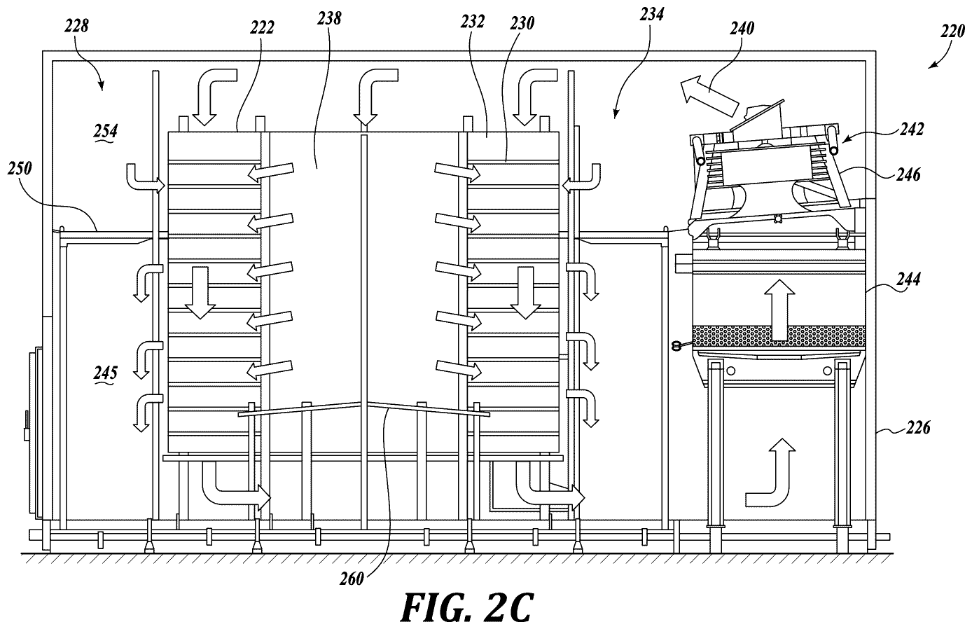

The thermal processing system 104 will first be described with reference to FIGS. 1 and 2. The thermal processing system 104 is generally configured to carry out thermal processing of a workpiece before the workpiece is designated as a thermally processed QA sample to be scanned, probed, weighed, etc. by the QA station 106. In that manner, the quality of workpieces thermally processed by the thermal processing system 104 (such as whether the workpieces have reached the required core temperature) may be analyzed with data gathered from the QA station 106. However, in some examples, the QA station 106, including a QA scanning system 108 and/or a weight measurement assembly 110 may additionally or alternatively be used upstream of the thermal processing system 104 for gathering QA data relevant to incoming workpieces, such as visual appearance data (e.g., breading voids, texture, markings, etc.).

The thermal processing system 104 includes a workpiece movement assembly 116, such as one or more conveyors, configured to carry workpieces, such as food products FP, between various portions of the thermal processing system 104. For instance, the workpiece movement assembly 116 may carry the food products FP between an oven inlet 41a and an oven outlet 41b of a spiral oven 20, as shown in FIG. 2A, or another thermal processing system. The workpiece movement assembly 116 may move food products FP from an upstream system(s), such as a bulk-to-organized workpiece infeed system (e.g., the Aggregated To Organized Automated Line Loading System And Method shown and described in U.S. patent Ser. No. 19/093727, hereby incorporated herein in its entirety), a cutting assembly, a coating assembly (e.g., a breading machine, a texturizing machine (e.g., a “knuckler”), a marinating assembly, etc.), etc. After thermal processing, the workpiece movement assembly 116 may move food products FP to a downstream system(s), such as another thermal processing system (e.g., a freezer), a pick-up station, a sorter, a packager, etc. The various components of the thermal processing system 104 may be controlled by a machine computing device 130.

The thermal processing QA systems and methods may be used with or otherwise incorporated into a spiral conveyor-based thermal processing system, such as the exemplary spiral oven 20 shown in FIGS. 2A and 2B. Although exemplary aspects of the thermal processing QA systems and methods are described with reference to a spiral conveyor-based thermal processing system, it should be appreciated that the thermal processing QA systems and methods may instead be adapted for use with any suitable thermal processing system, such as a convection oven, a linear convection oven, and impingement oven, a linear impingement oven, a spiral oven, a spiral impingement oven, a microwave oven, a radio frequency oven, etc. Moreover, as will become further appreciated below, the thermal processing QA systems and methods may be adapted for use with other types of thermal processing systems, such as freezers.

An exemplary spiral conveyor-based thermal processing system suitable for implementing aspects of the thermal processing QA systems and methods described herein will now be described. Spiral conveyor-based thermal processing systems include a heating surface or a cooling/freezing surface in the form of a pervious conveyor belt for conveying work pieces, including food products, through a thermal processing chamber in spiral or helical paths. If the work piece is being cooked or otherwise heated, the heat source, such as steam, heated air, or mixtures thereof, is provided within or adjacent the cooking chamber for heating the work pieces.

An advantage of thermal processing systems utilizing spiral conveyor belts is that a relatively long processing path may be achieved with a small footprint. For example, a 300-foot-long thermal processing conveyor belt in a spiral configuration can be contained within about a 10-foot high, 20-foot wide, and 40-foot-long housing. The housing holds a first ascending spiral conveyor stack and a second descending spiral conveyor stack.

However, spiral conveyor thermal processing systems do have some inherent drawbacks relative to a linear oven or freezer of a comparable length. In a linear oven or freezer, the upper and lower surfaces are exposed to being impinged upon by the thermal processing medium traveling at very high speeds, resulting in fast and efficient thermal transfer to the work product. However, in a spiral oven, the work products are less directly accessible to the thermal processing medium since the work products are arranged in stacked layers or tiers, thus requiring a less direct thermal processing methods than direct impingement of the thermal processing medium onto the work product.

In spiral conveyor configurations, a fan system is used to direct the flow of thermal processing medium horizontally across multiple tiers of the spiral belt path. The fan system is used to draw the processing medium across the stacks and then typically up to a location above the spiral belt path and through a heat exchanger to either heat or cool the thermal treating medium. Once exiting the heat exchanger, the treated medium is directed to flow downwardly along an exterior portion of the belt path diametrically opposite to the location of the circulating fans to draw the heating medium laterally into the spiral stacks and then across a bridge to an adjacent spiral belt path.

In the exemplary spiral oven 20 depicted in FIG. 2A, the spiral oven 20 generally includes a rectangularly shaped housing 22 sized to contain first and second spiral or helical conveyor units 32 and 34.

A continuous powered conveyor belt 36 for carrying work products through the spiral oven 20 is arranged in tiers forming an ascending spiral stack 38 in conveyor unit 32 and arranged in tiers forming a descending spiral stack 40 in conveyor unit 34. As shown in FIG. 2A, the conveyor belt 36 enters the spiral conveyor unit 32 at the bottom thereof at an inlet 41a in housing 22 and then travels in a spiral path until reaching the top of the spiral stack 38, and then extends tangentially from the top of stack 38 to the top stack 40 to descend along the spiral conveyor unit 34 to eventually exit the unit 34 from the bottom tier of the stack 40 through outlet 41b. The inlet 41a and outlet 41b can be substantially sealed from the ambient by steam knives or other means.

A center or mid wall 42 divides the two spiral conveyor units 32 and 34 into first and second separate chambers or compartments 46 and 48 wherein different process media conditions can be employed. For example, the temperature of the air, air/vapor mixture, steam, or other processing medium, the moisture content in the air, the medium velocity, etc., may be different in the first and second compartments created by the mid or cross wall 42 to support different cooking steps. A close fitting opening 49 is provided in wall 42 to allow passage of the conveyor belt 36 and the work products being carried thereon. If needed, a steam knife or similar/other sealing system can be used to provide a seal between the first and second compartments 46 and 48.

As shown in FIG. 2B, the center of the conveyor spirals 38 and 40 extend around a central drive system 50 that rotates the conveyor units 32 and 34 about a central axis 52. The drive system 50 includes a cylindrical drive drum 54 that frictionally and rotationally drives conveyor belt 36 over supports (not shown) that are fixed in place exterior to the drum, thereby to rotate the belt about axis 52. The belt 36 tightens around the drive drum 54, creating enough friction or engagement therebetween to drive the belt forward to slide over and upward over the drum supports.

A top panel structure 58 overlies the conveyor spirals 38 and 40. Circulation fans 60 and 62 are positioned at outward sides of the conveyor units 32 and 34 to draw processing medium, for example, air, across the interior of the conveyor spirals 38 and 40 (and around drum 54) so as to thermally treat the work products being carried on the conveyor belt 36 and then direct such processing medium upwardly along end walls of the housing 22 toward a ceiling of the housing. Thereafter, the processing medium is directed through a heat exchanger 64 positioned on or above the top panel structure 58. The processing medium extends transversely across the top of each of the spirals 38 and 40. The heat exchanger 64 may be mounted on or just above the structure 58 by an appropriate mounting structure.

The thermal processing air/vapor mixture, steam alone or in combination with other thermal processing medium, being circulated by the fans 60 and 62, when passing through the heat exchanger 64, is heated as desired. The heated processing medium flows horizontally over the top structure 58 until reaching the cross wall 42, wherein the processing medium is deflected downwardly to flow along the exposed adjacent portion of the conveyor spirals 38 and 40 and enter into the spirals in a lateral direction, as depicted by arrows 70, thereby heating the work product primarily by condensation then followed by convection heat transfer.

The spatial arrangement of the fans 60 and 62, the heat exchanger 64, and optimally positioned mid wall 42 in relation to the respective spirals enables flow distribution to be substantially uniform to each tier within the individual spirals to deliver air flow mixture to approach the surfaces of the food items on the conveyor diagonally.

The first and second compartments 46 and 48 may each be divided into various thermal processing zones. For instance, in the example shown, a first mezzanine 74 located in a lower portion of the first compartment 46 divides the first compartment 46 (and therefore the conveyor spiral 38) into a lower first processing zone 76 below the first mezzanine 74 and an upper second processing zone 78 above the first mezzanine 74. The first mezzanine 74 extends substantially horizontally from the mid wall 42 toward the conveyor spiral 38 and is shaped to fit around a side portion of the conveyor spiral 38. The first mezzanine 74 is shown as substantially planar in construction. Appropriate braces or reinforcements can be used to provide the needed structural integrity of the mezzanine.

Optionally, the first mezzanine 74 is adjustable in elevation by an appropriate actuating system. For instance, the actuation system may be communicatively coupled to a system computing device, discussed below, which outputs one or more signals to the actuation system to alter the height of the first mezzanine 74 as desired. FIG. 2 shows the first mezzanine 74 as located at an elevation between the first and second lowest tiers of the conveyor spiral 38. However, the first mezzanine 74 can be positioned at a higher elevation, for example, at the level of the second lowest tier or at a level above the second lowest tier of the conveyor spiral 38.

A thermal processing medium delivery conduit or pipe 80 may be used to deliver thermal processing medium in the form of saturated or superheated steam that is under pressure at the point of discharge to the lower first processing zone 76 for enhanced thermal processing of the work product. The rate of steam flow from the pipe can be controlled by adjusting a valve 82, which is schematically shown as located near the outlet of the pipe 80. The steam supply pressure may be controlled using a pressure control set valve to a value between, e.g., 0.1 to 150 PSIG.

In cooking, optionally a sensed control variable is the humidity level in the zone 76. Using the sensed humidity level, the rate of steam flow is adjusted to enable the steam to expand to atmospheric conditions to deliver an instantaneous dew point temperature of 212° F. more readily for interacting with the incoming work product (food items) on the entering conveyor. This is due to the lesser amount of de-superheating required at lower steam pressures.

The steam flowing from pipe 80, which fills the lower volume of zone 76 and then eventually flowing into the fan 60, functions to advantageously heat the work product by condensation heat transfer, which is capable of transferring heat to the work product very quickly, and much more rapidly than by convection heat transfer. In this regard, the heat transfer coefficient for steam condensation heat transfer is 2700 Kcal/hr-M2-° C., whereas the heat transfer coefficient for forced convection heat transfer is 30 to 35 Kcal/hr-M2-° C. Of course, condensation heat transfer stops when the work products'surfaces reach the dew point temperature of the surrounding atmosphere (for example, within the enclosure), and thereafter convection heat transfer is required.

The steam delivered by pipe 80 may be saturated steam at atmospheric pressure, so that the high heat transfer coefficient noted above can be utilized. The saturated steam used can be controlled to a desired temperature based on type of substrate being processed. For example, for products with high fat content such as pork, it may be desirable to employ a saturated steam temperature that is lower than 212° F. early on in the process to control the product yield loss associated with surface fat, since fat starts to melt at lower temperatures in the range of 131-135° F.

Moreover, food items may be processed to optimize a combination of things, such as desired product attributes (e.g., color, texture, mouth feel etc.), product yields, and throughputs. Thus, the process conditions needed to achieve these objectives are necessarily path specific, requiring suitable operating parameters for the defined zones. For example, in zone 76, condensation conditions may be dictated by product specificity to advantageously heat the work product by condensation heat transfer, and in zone 78, convection conditions may be defined to compliment the condensation conditions employed in zone 76 for the work product.

The highest energy transfer onto the surfaces of food items occurs through condensation at or around the highest dew point temperature which is 212° F. This is true irrespective of the type of substrate being processed, as long as the surface temperature is below the actual dew point temperature being used for the process. In that regard, the adjustable first mezzanine 74 can be set so low such that entering gases (steam or other) can bypass the first zone 76 with the result of only mixing in the fan 60 and adding to overall mixture proportions with gas mixture in zone 78 unmodified by relevant exposure to food items. In the alternative, the efficient use of steam may be used to achieve condensation heat transfer in processing zone 76, and to at least some extent, the steam can also mix with the heated air in processing zone 78 to boost the enthalpy level in processing zone 78 for enhanced heating of the work product (e.g., food product) while in the processing zone 78.

Further, if it is desired to have more steam in processing zone 78 than available from leakage from zone 76, steam can specifically be supplied to zone 78 by, for example, a steam delivery pipe or conduit 83, as schematically shown in FIG. 2A. In this case, since condensation heat transfer is not being relied upon, the steam can be supplied at a higher pressure than in zone 76, for example, from about 60-80 PSIG.

The second chamber or compartment 48 may also be divided into zones. For instance, a second mezzanine 84 may be located in a lower portion of the second chamber 48 to effectively divide the second chamber 48 (and therefore the conveyor spiral 40) into a third upper processing zone 86 and a fourth lower processing zone 88. In the example shown, the second mezzanine 84 extends substantially horizontally from the mid wall 42 toward the conveyor spiral 40 and is shaped to fit around a side portion of the conveyor spiral 40. The second mezzanine 84 is shown as substantially planar in construction. Appropriate braces or reinforcements can be used to provide the needed structural integrity of the mezzanine.

Optionally, the second mezzanine 84 is adjustable in elevation by an appropriate actuating system. For instance, the actuation system may be communicatively coupled to a system computing device, discussed below, which outputs one or more signals to the actuation system to alter the height of the second mezzanine 84 as desired.

FIG. 2A shows the second mezzanine 84 located at an elevation between the first and second lowest tiers of the conveyor spiral 40. However, the second mezzanine 84 can be positioned at a higher elevation, for example, at a level above the second lowest tier or the third lowest tier of the conveyor spiral 40, depending on the dwell time needed for each processing zone 86 and 88.

In the example shown, the third upper processing zone 86 may be generally used for convection finish cooking, and the fourth lower processing zone 88 may be generally used for adiabatic equilibration. The third upper processing zone 86 may support convection finish cooking when a thermal processing medium, for example, air/vapor mixture heated by heat exchanger 64, is drawn by fan 62 across the interior of the conveyor spiral 40, as described above.

If enhanced thermal processing of the work product in the third upper processing zone 86 is desired, a thermal processing medium delivery conduit or pipe 90 may also deliver thermal processing medium to the zone 86. For instance, the thermal processing medium may be in the form of steam. The rate of steam flow from pipe 90 can be controlled by adjusting a valve 92, which is schematically shown. If required, the steam from pipe 90 functions to advantageously heat the work product by condensation or enhanced convection heat transfer (in case the surface temperature of the food items is higher than the surrounding dew point).

A thermal processing medium delivery conduit or pipe 94 may deliver thermal processing medium to zone 88 to achieve and maintain the pre-determined reference temperature and/or humidity level. In some examples, zone 88 will require a lower temperature than the preceding zone 86 where the food products FP are in a final stage of cooking. In that regard, a vent 98 may be used to egress hot air from zone 88. The rate of thermal processing medium flow from pipe 94 can also be controlled by adjusting a valve 96, which is diagrammatically shown.

As shown in FIG. 2A, an annular shaped barrier 100 may optionally be positioned just below the second tier from the bottom in conveyor spiral 40. The barrier 100 functions to catch liquid drippings from the tiers located above the barrier. Such drippings typically consist of moisture and fat drippings from the interior of the work product which has not evaporated when reaching the exterior surface of the work product. If such drippings were allowed to fall on to the work products as the work products are leaving the housing 22, such adulteration of the work product may be unacceptable visually, as well from a sterilization point of view.

The barrier 100 can take various forms, for example, the barrier can be generally in the form of an annularly shaped sheet that is mounted relative to the conveyor spiral 40 by mounting brackets or other means. The barrier 100 can be positioned at a slope to direct the drippings to a collection location. The barrier is shown as sloped to match the slope of the tiers. However, the barrier can be at a different slope than the tiers so as to facilitate the flow of the liquid drippings to a collection location. Alternatively, the barrier can be in the form of a shallow truncated cone, so that the drippings flow to the outer perimeter of the barrier for collection.

Although the barrier 100 is shown as located below the second lower most tier of conveyor spiral 40, the barrier can be at different elevation relative to the spiral 40. For example, the barrier may be located just below the third lower most tier of the conveyor spiral. In this case, the second mezzanine 84 could be located at the elevation of the barrier 100 or at a different elevation of the barrier 100. Ideally, the mezzanine 84 will be located at or below level of the barrier to prevent any form of adulteration to remain on the surfaces of the food items during equilibration.

The machine computing device 130 or any suitable control system may be employed to control the operation of the spiral oven 20 to help ensure that the work products (e.g., food products FP) are properly thermally processed, for example, are cooked to achieve desired product core temperature and qualities consisting of sensory attributes such as color, flavor, texture, mouthfeel, etc., via in-oven conveyor path thermal processing.

The machine computing device 130 receives input signals from various measurement devices, sensors, and/or instruments of an oven monitoring system that monitors, among other process parameters, the temperature, air/vapor mixture velocity, and moisture content within the housing 22 at various locations, the speed of the conveyor belt 36, and the loading density of food products on the conveyor belt, such as from a bulk-to-organized workpiece infeed system, as discussed above, from a food product forming machine (e.g., by monitoring the strokes of former), a vision system, or any combination thereof. The machine computing device 130 may also communicate (e.g., receive input signals from and output signals to) one or more computing devices in networked communication with the control system, such as QA computing device 111. In that regard, the machine computing device 130 may process thermally processed workpiece QA data to control the operation of the spiral oven 20.

The machine computing device 130 controls the components of the spiral oven 20 so as to operate within set point parameters, including the speed of the conveyor belt 36, the speed of the fans 62, the operation, including the thermal output, of the heat exchangers 64, and the quality and volume of steam from delivery pipes 80, 90, and/or 94. These components are in communication with the machine computing device 130 by wired connection or wirelessly.

For instance, the machine computing device 130 controls the speed of the conveyor belt 36 by controlling the conveyor drive system 50. The speed of the conveyor belt affects the dwell time of the work products in the various processing zones of the spiral oven 20. In addition, the machine computing device 130 controls the temperature and moisture level within the upper and lower processing zones by controlling quality and volume flow rate of the thermal processing medium (steam, air, air/vapor mixture etc.) introduced into these processing zones. The control system also controls temperature and flow rate of the convection thermal processing medium in the upper second and upper third processing zones by controlling the temperature, volume, and speed of the hot air/vapor mixture circulated through these processing zones.

The machine computing device 130 may control various other components and subsystems of the thermal processing system 104, such as the level of the loading of the food product onto the conveyor belt 36, e.g., by controlling operation of a delivery conveyor that delivers the food product to the conveyor belt. In that regard, the oven monitoring system may be configured to measure a loading frequency or density of food product FP loaded onto the conveyor belt 36 from a delivery conveyor, not shown. The monitoring system may further be configured to measure the output load frequency or density of the food product FP unloaded from the conveyor belt 36 to an outfeed conveyor 37.

An input load monitor/sensor 112 is schematically shown in FIG. 2A. The load monitor/sensor 112 can take various forms, including a scale to weigh the food product FP. Alternatively, the load monitor can be in the form of an optical scanner capable of scanning the food product and determining the volume of the food product, then calculating the weight of the food product by using the known density of the food product. Such scanning systems are well known in the art. For example, see U.S. Pat. No. 7,452,466. The disclosure of this patent is incorporated herein by reference in its entirety. The information from the load monitor/sensor 112 is transmitted to the machine computing device 130 and/or the QA computing device 111. In addition or in the alternative, the level of loading of food products on the conveyor belt may be determined and controlled by a bulk-to-organized workpiece infeed system, as discussed above.

The oven monitoring system may also be configured to measure the temperature and moisture level within the various processing zones 76, 78, 86, and 88 of the conveyor spirals 38 and 40, as well as the velocity of the air/vapor mixture flowing through the convection processing zones 78 and 86. These operational parameters can be measured by a temperature sensor 114 and a moisture sensor 116 in the lower first processing zone 76. A temperature sensor 118, a moisture sensor 120, and a fluid velocity sensor 122 can be utilized in upper second heating zone 78. Correspondingly, a temperature sensor 124, a moisture sensor 126, and a fluid velocity sensor 128 can be utilized in upper third processing zone 86. Also, correspondingly, temperature sensor 130 and moisture sensor 131 can employed in the fourth processing zone 88. These sensors are in communication with the machine computing device 130, which can be by hard wiring or wireless transmission. Of course, alternative and/or additional sensors can be employed.

One or more of the temperature sensors 114, 118, 124, and 130 may be configured to sense the dry bulb and wet bulb temperatures within their respective processing zones. The reason for also measuring the wet bulb temperature is that as the food product is carried through the spiral oven 20, its surface temperature gradually increases. Eventually, this surface temperature will reach the dew point temperature of the moist, hot air in the processing zone. At that point, the moisture in the heating medium within the processing zone will not condense on the surface of the food products. Instead, the moisture on the surface of the food products will begin to evaporate, which tends to cool the food product somewhat. The temperature at which this transition occurs will be the wet bulb temperature. Nonetheless, the energy delivered to the surfaces of the food product must still be sufficient to cook the food product to the desired target temperature (such as in zones 76, 78, and 86) while achieving sensory attributes sought and also kill the desired level of pathogens on and/or in the food product FP. As an alternative, the monitoring system can measure the dry bulb temperature and humidity level in the processing zones. From this information it is possible to determine the wet bulb temperature, relative humidity, and dew point within the processing zones.

The oven monitoring system can also be configured to measure the initial temperature of the food products FP entering the first lower processing zone 76 by, for example, the use of a first temperature measuring device 115. The first temperature measuring device 115 may be configured as a thermal imaging camera. If a thermal imaging camera is used, the thermal imaging camera can also be trained to measure the size of the food products FP, at least the two-dimensional area of the food products. These sensors also are in communication with the machine computing device 130.

Although FIG. 2A and FIG. 2B depict specific components and sub-assemblies of a thermal processing system, it should be appreciated that any other suitable arrangement of thermal processing components may be used.

For instance, as noted above, the workpiece thermal processing management system 102 may instead be adapted for use with an industrial freezer, dryer, chiller, etc. In that regard, an exemplary industrial freezer 220 suitable for use with the workpiece thermal processing management system 102 will be described with reference to FIG. 2C. The industrial freezer 220 is generally configured to carry out a thermal process of workpieces, such as food products. In the non-limiting example shown in FIG. 2C, the industrial freezer 220 generally includes a refrigeration assembly configured to supply and circulate a thermally treated medium (e.g., cooled air) within an insulated freezer chamber of the industrial freezer 220, and a workpiece movement assembly configured to move workpieces within the industrial freezer 220 for thermal processing. The industrial freezer 220 may include a sensor assembly configured to obtain sensor data regarding one or more physical properties associated with the workpieces and/or the industrial freezer 220 and a machine computing device configured for controlling and/or activating aspects of the industrial freezer 220 (like the thermal processor sensor assembly 124 and machine computing device 130 described with reference to FIG. 1).

In some examples, the industrial freezer 220 may be a spiral freezer system having a spiral stack contained within an insulated freezer chamber (see U.S. Pat. No. 1,003,930, entitled “System and method for adjusting air flow in spiral conveyers”, incorporated herein by reference in its entirety), a fluidized bed freezer or a “flow” freezer commonly used for quickly freezing food products as individual pieces (known as Individual Quick Freezing or “IQF”) (see International Patent Application No. PCT/IB2024/053913, entitled “Product Overblow Management Assembly”, incorporated herein by reference in its entirety), an impingement freezer (see U.S. Patent App. Pub. No. 20130042889A1, entitled “Systems and methods for impingement air treatment”, incorporated herein by reference in its entirety), a combined impingement/plate freezer (see U.S. Pat. No. 9,739,520, entitled “Combined impingement/plate freezer”, incorporated herein by reference in its entirety), etc.

In the example shown in FIG. 2C, the industrial freezer 220 is a spiral freezer having a spiral stack 222 contained within an insulated freezer chamber 226. The spiral stack 222 is formed from a pervious conveyor belt 230 that supports and transports products within the freezer chamber 226. The conveyor belt 230 moves in both linear and spiral patterns within the spiral freezer system 220. More specifically, the conveyor belt 230 moves in a linear pattern at the entry and exit portals (not shown) of the spiral stack 222, and the conveyor belt 30 moves in a spiral or helical path within the spiral stack 2222. The conveyor belt 30 moves products within the spiral stack 222 in an ascending or descending spiral or helical path as is well known in the art.

The conveyor belt 230, when formed as a spiral stack 222, is configured into a plurality of tiers 232 that are stacked on top of one another (i.e., known in the art as a “self-stacking” conveyor belt). Each tier 232 of the stack 222 forms a pervious annulus through which gas may flow. When formed in a spiral stack 222, the plurality of tiers 232 creates an inner cylindrical channel 238, through which the treatment gas may also travel. Products (not shown) travel on the conveyor belt 230 and are frozen by treatment gas 240 in the freezer chamber 226. Exemplary spiral stacks 222 may have any number of tiers 232, typically in the range of about 8 to about 25 tiers.

Suitable embodiments of spiral stacking belts are shown and described in U.S. Pat. No. 3,938,651, issued to Alfred et al., and U.S. Pat. No. 5,803,232, issued to Frodeberg, the disclosures of which are hereby expressly incorporated by reference. However, it should be appreciated that other suitable spiral belt assemblies are also within the scope of the present disclosure.

The gas circulation system 234 includes a gas treatment supply unit embodied as freezer unit 242 for supplying refrigerated treatment gas 240 to food products within the spiral stack 222. The freezer unit 242 includes an evaporator 244, at least one fan 246, and other necessary components, such as a compressor, condenser, etc. (not shown), for supplying suitable treatment gas 240 for heat exchange with the products, as is well known in the art.

The freezer unit 242, through fan 246, is configured to direct the treatment gas 240 toward the top of the spiral stack 222 for eventual downward, vertical flow through the stack 222. In that regard, the fan 246 directs treatment gas 240 horizontally across the top of the stack 222 to become predominantly vertical downward flow within the stack. The freezer chamber 226 may include contoured walls to help direct the treatment gas 240 toward the top of the stack 222. It should be appreciated that the freezer unit 242 may instead direct the treatment gas 240 toward the bottom of the stack to become predominantly vertical upward flow in a different configuration.

Moreover, it should be appreciated that the freezer unit 242 may instead be located within the freezer chamber 226 such that the fan 246 directs the treatment gas 240 directly downwardly (or upwardly) into the stack 222. After exiting the stack 222, the treatment gas 240 (or return gas, after exiting the stack 222) is drawn by the suction of fan 246 (or another fan) for heat exchange and continuous recirculation within the freezer chamber 226.

A flow path modification assembly 228 helps direct the flow of treatment gas 240 within the spiral stack 222 and freezer chamber 226. The directional arrows in FIG. 2 depict an exemplary flow pattern of the treatment gas 240 through the spiral stack 222 and freezer chamber 226.

Thermal processing operations of the industrial freezer 220 may be controlled through the machine computing device 130, the QA computing device 111, another computing device(s) in communication with the network 114, and/or manually. Control of the industrial freezer 220 may be in response to data gathered by one or more sensors of the sensor assembly 124 regarding the industrial freezer 220.

In that regard, the sensor assembly 124 may include various sensors and devices for detecting and/or measuring a physical property of the industrial freezer 220 related to thermal processing. For instance, the sensor assembly 124 may include sensors configured to measure and/or detect various physical properties during some or all of a thermal process. For example, the freezer sensors may include temperature, humidity, pressure, optical (e.g., a vision system), motion, and utility consumption sensors, flow meters, RFID sensors, and other sensors to measure or detect various physical properties of the industrial freezer 220, such as during the freezing process.

Temperature sensors may be used to measure the temperature of the freezer chamber 226 and/or its components before, during, and after one or more steps of the thermal process. For instance, temperature and humidity sensors may measure the temperature and humidity inside the freezer chamber 226 at various locations inside the chamber during the freezing process to accurately determine the chamber temperature and humidity at each location of measurement and during various steps of the freezing process. Temperature and humidity sensors may measure the temperature and/or humidity of or at the refrigeration assembly, the workpiece movement assembly (e.g., conveyor 230), the freezer floor, freezer walls, freezer parts, etc., during thermal processing to, for instance, assess aspects of the corresponding thermal process.

Suitable sensors may be used to measure frost build-up on the conveyor belt 230 and/or the evaporator 244, which can compromise thermal processing. For instance, pressure sensors may be used to measure a pressure differential across the evaporator 244 to determine frost build-up, such as that described in U.S. Provisional Patent App. No. 63/888061, entitled “WORKPIECE PROCESSING PREDICTION AND OPTIMIZATION SYSTEM” incorporated by reference in its entirety herein. Pressure sensors may similarly be used to measure frost build-up on the conveyor belt 230. In some examples, a pressure differential across the conveyor belt 230 indicative of frost build-up may be measured using a flexible tube having its open ends disposed inside the freezer chamber 226 (e.g., with outlets at both sides of the spiral stack 222) and the remainder of the flexible tubing outside of the freezer chamber 226 and containing water. For instance, the water may reside in a U-shaped bend in the tube. In that regard, a displacement of the water can be measured by comparing the height of the water column on both sides of the flexible tube. Commonly this pressure differential is read as “inches of water column” or “inches of water” as a measure of pressure differential across the stack. Any suitable sensors may be used to determine frost build-up.

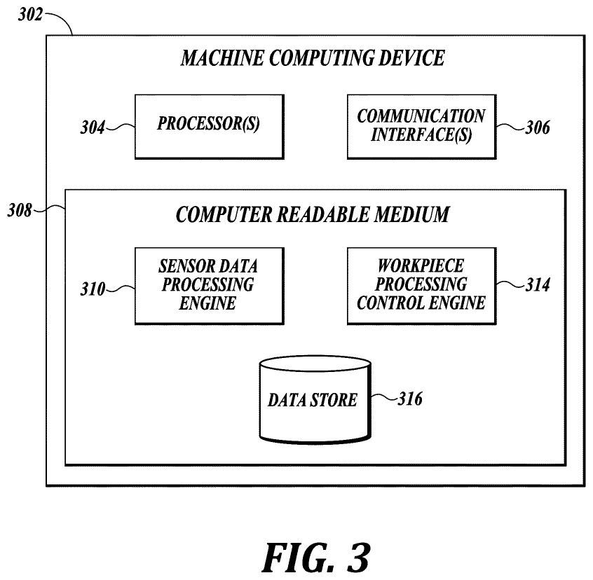

Exemplary aspects of the machine computing device 130 will now be described with reference to FIG. 3. As noted above, the machine computing device 130 may be generally configured for controlling components of the thermal processing system 104, such as in response to sensor data transmitted from the above-described sensors and other data or inputs (such as from the QA computing device 111). In the exemplary block diagram of FIG. 3, the machine computing device 130 includes a processor(s) 304, a communication interface(s) 306, computer readable medium 308, and at least one data store 316. As shown, the computer readable medium 308 has stored thereon logic that, in response to execution by the one or more processor(s) 304, cause the machine computing device 130 to provide a sensor data processing engine 310 and a workpiece processing control engine 314.

The machine computing device 130 may be implemented by any computing device or collection of computing devices, including but not limited to a desktop computing device, a laptop computing device, a mobile computing device, an edge computing device, a programmable logic controller (PLC), a server computing device, a computing device of a cloud computing system, and/or combinations thereof. In some examples, the processor(s) 304 may include any suitable type of general-purpose computer processor. In some examples, the processor(s) 304 may include one or more special-purpose computer processors or AI accelerators optimized for specific computing tasks, including but not limited to graphical processing units (GPUs), vision processing units (VPTs), and tensor processing units (TPUs).

In some examples, the communication interface(s) 306 includes one or more hardware and or software interfaces suitable for providing communication links between components. The communication interface(s) 306 may support one or more wired communication technologies (including but not limited to Ethernet, FireWire, and USB), one or more wireless communication technologies (including but not limited to Wi-Fi, WiMAX, Bluetooth, 2G, 3G, 4G, 5G, and LTE), and/or combinations thereof.

As used herein, “computer-readable medium” refers to a removable or nonremovable device that implements any technology capable of storing information in a volatile or non-volatile manner to be read by a processor of a computing device, including but not limited to: a hard drive; a flash memory; a solid state drive; random-access memory (RAM); read-only memory (ROM); a CD-ROM, a DVD, or other disk storage; a magnetic cassette; a magnetic tape; and a magnetic disk storage.

As used herein, “engine” refers to logic embodied in hardware or software instructions, which can be written in one or more programming languages, including but not limited to C, C++, C#, COBOL, JAVA™, PHP, Perl, HTML, CSS, JavaScript, VBScript, ASPX, Go, and Python. An engine may be compiled into executable programs or written in interpreted programming languages. Software engines may be callable from other engines or from themselves. Generally, the engines described herein refer to logical modules that can be merged with other engines or can be divided into sub-engines. The engines can be implemented by logic stored in any type of computer-readable medium or computer storage device and be stored on and executed by one or more general purpose computers, thus creating a special purpose computer configured to provide the engine or the functionality thereof. The engines can be implemented by logic programmed into an application-specific integrated circuit (ASIC), a field-programmable gate array (FPGA), or another hardware device.

As used herein, “data store” refers to any suitable device configured to store data for access by a computing device. One example of a data store is a highly reliable, high-speed relational database management system (DBMS) executing on one or more computing devices and accessible over a high-speed network. Another example of a data store is a key-value store. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, such as a hard disk drive, a flash memory, RAM, ROM, or any other type of computer-readable storage medium. One of ordinary skill in the art will recognize that separate data stores described herein may be combined into a single data store, and/or a single data store described herein may be separated into multiple data stores, without departing from the scope of the present disclosure.

The sensor data processing engine 310 of the machine computing device 130 may be configured to process operational parameter sensor data for the spiral oven 20 (e.g., temperature, moisture, and/or fluid velocity sensor data), including any data associated therewith (e.g., workpiece loading/unloading data). The sensor data processing engine 310 of the machine computing device 130 may also be configured to process QA analysis data of the thermally processed QA samples that is sent from or retrieved from the QA computing device 111. Data processed by the sensor data processing engine 310 may be transmitted to or retrieved by the workpiece processing control engine 314.

Operational parameters of the thermal processing system 104 may be changed or otherwise controlled by the workpiece processing control engine 314. In that regard, the workpiece processing control engine 314 may analyze data received from the sensor data processing engine 310 to determine operational parameter changes of the thermal processing system 104, such as adjusting one or more of a belt speed, workpiece spacing on the belt, a temperature, moisture, and/or airflow velocity in a portion(s) of the thermal processing system 104, etc. The workpiece processing control engine 314 may also receive/process instructions from the QA computing device 111 to make any necessary processing adjustments to ensure subsequently processed workpieces are within the required spec, to optimize thermal processing of workpieces, etc. For instance, if the sensor data processing engine 310 receives thermally processed QA sample(s) temperature data from the QA computing device 111 indicating that the food products are over or undercooked (which may be determined in combination with other QA sample data, such as weight data and/or dimension data), the workpiece processing control engine 314 may adjust one or more of a belt speed, workpiece spacing on the belt, a temperature, moisture, and/or airflow velocity in a portion(s) of the spiral oven 20, etc., to optimize thermal processing. Moreover, if the sensor data processing engine 310 receives thermally processed QA sample(s) temperature data from the QA computing device 111 indicating that the food products are over or under frozen (which may be determined in combination with other QA sample data, such as weight data and/or dimension data), the workpiece processing control engine 314 may adjust one or more of a belt speed, workpiece spacing on the belt, a temperature, moisture, and/or airflow velocity in a portion(s) of the industrial freezer 220, etc., to optimize thermal processing.

Referring back to FIG. 1, exemplary aspects of the QA station 106 will now be described. As noted above, the QA station 106 is configured to gather and process thermally processed workpiece QA data for assessing one or more attributes of a thermally processed QA sample (or simply “QA sample”) processed by the thermal processing system 104 or to be processed. The QA station 106 may include an integrated QA scanning system 108, weight measurement assembly 110, and a temperature measurement assembly 146. The QA computing device 111, although shown separately, may also define an integral part of the QA station 106. In general, the QA station 106 may be configured to capture, package, and send QA temperature data, QA image data, QA weight data, and any other relevant data (“thermally processed workpiece QA data”) for a QA sample to a computing device (such as the QA computing device 111, the monitoring system 112, the model management computing device 113, and/or the machine computing device 130), for performing a QA analysis or otherwise processing the QA data. The QA analysis may include determining whether the QA sample is within a specified temperature range, a specified freezing curve stage, and/or within an appearance spec and optionally determining any corresponding steps that should be taken.

Exemplary aspects of the QA scanning system 108 will first be described.

FIG. 1 depicts a block diagram that illustrates aspects of a non-limiting example of the QA scanning system 108 according to various aspects of the present disclosure. In the depicted example, the QA scanning system 108 includes an image sensor assembly 132 having at least one image sensor for capturing QA image data of the QA sample being viewed. The QA scanning system 108 may further include a light assembly 136 configured to sufficiently illuminate the QA sample being captured by the image sensor assembly 132. The QA scanning system 108 may further include an image processor 134, which may be used to receive, process, and package QA image data captured with the image sensor assembly 132 for sending to the QA computing device 111 or another computing device (such as the machine computing device 130 of the processing system 104). The QA scanning system 108 may include any other components necessary or suitable for the application and/or environment, such as a heater, a conveyance system, etc. Moreover, the QA scanning system 108 used in the systems and methods described herein excludes any type of scanning that could be done by human observation, which would not support the needed processing speed and accuracy of the workpiece processing management system 102.

The image sensor assembly 132 of the QA scanning system 108 will first be described in detail. The image sensor assembly 132 may include any suitable image sensor or combination of image sensors for capturing and/or generating QA image data relevant for assessing the quality of the intended QA sample. In some examples, the image sensor assembly 132 may include one or more cameras for capturing still images of a QA sample and a support surface on which it rests. For instance, the light assembly 136 may include one or more optical still cameras, for example a greyscale camera, an RGB camera, an infrared (IR) and/or UV camera, thermal imaging device, thermal camera, a charge coupled device (CCD), etc. An optical still camera can be used to acquire and/or generate one or more complete still images of a QA sample for detecting certain characteristics, such as, e.g., the outer contour or perimeter of the QA sample, a depth or height of the QA sample, markings on the sample (e.g., char marks), breading gaps, etc. The image sensor assembly 132 may also include one or more additional still cameras, for example a multispectral or hyperspectral camera. Additional still cameras such as multispectral or hyperspectral cameras can be used to acquire images/data of specific regions or characteristics of a QA sample, such as coating (e.g., breading) texture.

In some examples, the image sensor assembly 132 may be movable relative to a stationary or fixed QA sample. For instance, in one example, the image sensor assembly 132 may include one or more image sensors placed at the end of a robot arm such that numerous still images may be taken of a QA sample and/or its surroundings with the image sensor from various angles. In such an example, the image sensor assembly 132 may include one or more still cameras or other cameras (e.g., a stereo camera). In such an example, the robot-controlled image sensor assembly 132 may capture enough images of a QA sample to generate a 3D model of the QA sample. The support surface on which a QA sample is placed may also be captured by the image sensor for determining the sensor's distance from the surface, which may be used in calculating the product height. The image sensor assembly 132 may also or instead include one or more image sensors mounted to a linear actuator, as described below.

It can be appreciated that capturing images at various angles can generate even more reliable, complete image data of a QA sample. In other words, using a still camera or other camera moveable relative to the imaging support surface allows for viewing of a QA sample at more/better angles, thereby eliminating QA image data gaps and improving QA image accuracy.

In the examples described herein, the image sensor assembly 132 may also or instead include image sensor technology suitable for capturing image data needed to generate a 3D model of a QA sample and/or a 2D representation of the height or elevation of the scene. In some examples, the image sensor assembly 132 includes at least one of a 3D vision system or 3D laser scanning technology like LiDAR (Light Detection and Ranging), structured light scanning, or photogrammetry, a stereo depth camera, a Time-of-Flight (ToF) stereoscopic camera, or the like, or combinations thereof.

In some examples, the image sensor assembly 132 includes a stereo depth (e.g., stereoscopic) camera configured to generate a 3D depth image or height map of the QA sample. For instance, at least one Intel RealSense Depth Camera (e.g., D405) may be used. When using one or more stereo depth cameras or in a similar image sensor assembly configuration, each camera may be configured to optimize the contrast of captured images (e.g., minimizing white pixels) to optimize object segmentation, e.g. separation of the QA sample from the background and miscellaneous noise within the image. In that regard, each camera may also be configured to optimize resolution, exposures, frame rate, etc., to maximize an accuracy of a still camera image. In some examples, multiple still images of the same QA sample are acquired to define a QA image, and a temporal filter may be used to filter out temporal noise in the image.

In one example, the image sensor assembly 132 includes a structured light source and scanner configured to capture QA sample depth and surface information for generating a height map or 3D model of the product and/or a 2D representation of the height or elevation of the scene (sometimes also referred to herein as a “3D laser scanner” or the like). In one example, the structured light source/scanner is a SICK® TriSpector 1000 3Dlaser scanner. A 3D laser scanner such as the SICK® TriSpector 1000 3Dlaser scanner digitally captures the size and shape of physical objects using a line of laser light. Generally, with a 3D laser scanner, a laser probe projects a line of laser light onto a surface supporting an object to be scanned while sensor cameras continuously record the changing distance and shape of the laser line in three dimensions (XYZ) as it sweeps along the object. The shape of the object appears as millions of points called a “point cloud” on the computer monitor as the laser moves around capturing the entire surface shape of the object.

For the laser to sweep along a QA sample, the structured light scanner may be movable relative to an imaging support surface on which the QA sample rests, and/or the imaging support surface may be movable relative to the structured light scanner. For instance, the structured light scanner may be movable by a robot or an actuator relative to the imaging support surface. In this manner, the laser line emanating from the scanner may sweep along the QA sample and the imaging support surface as the structured light scanner is moved by the robot/actuator.

In one example, the structured light scanner is a SICK® TriSpector 1000 3Dlaser scanner mounted to a linear actuator, such as a belt-driven linear actuator available from Festo Corporation of Islandia, NY. In one specific example, a Festo® toothed belt axis ELGE-TB actuator is used. The linear actuator may include an integrated encoder to track the movement of the scanner for accurately capturing image data relative to sweep distance of the laser line. In addition, the linear actuator as well as the scanner may be I/O link capable for ease of integration.

In other examples, the QA sample may be moved relative to a stationary structured light scanner with a conveyance system, such as with an endless conveyor belt. In such an example, the endless conveyor belt may define the imaging support surface. An encoder may be used to track belt movement for accurately capturing image data relative to sweep distance of the laser line.

In some examples, the image sensor assembly 132 may additionally include a still optical camera, stereo camera, etc., mounted to the linear actuator, such as one of the cameras described above. In such an example, the image sensor assembly 132 can capture still images of a QA sample at various angles in addition to capturing a structured light scan. It can be appreciated that capturing both still images at various angles and a structured light scan can generate even more reliable, complete image data of a QA sample.

In one example, the image sensor assembly 132 may include a robot capable of identifying and retrieving (e.g. picking) a sample of QA samples being conveyed from the thermal processing system 104. For instance, a 3D laser scanner (such as the SICK® TriSpector 1000 3Dlaser scanner) may be secured on an end of a robot arm also having grippers, and the robot may move the 3D laser scanner over a QA sample for scanning, pick the QA sample from the conveyor, and place the QA sample on a scale of the QA station 106 to obtain temperature and weight data. The 3D laser scan data could be used to generate a 3D model to determine height and volume of the QA sample, which could be combined with the weight data to obtain density. Such an example could simplify a QA station because only a scale would be needed, and scanning while weighing could be avoided. The robot may be a relatively inexpensive robot capable of identifying and retrieving, e.g., a few samples a minute to be place on a QA station platform. For instance, the robot used may be the VIM-303 robot available from Visual Robotic Systems, Inc. of Eugene, OR. In other examples, the robot may be a Universal Robots UR series robot available from Buchanan Automation of Snohomish, WA. In yet other examples, only manual retrieval of QA samples from the product flow of the thermal processing system 104 is used to minimize complexity and cost of the workpiece thermal processing management system 102. In such an example, imaging, weighing, and temperature sensing of the QA sample occurs at the same or substantially same location of the QA station 106.

As noted above, the QA scanning system 108 may include a light assembly 136 configured to sufficiently illuminate a QA sample being captured by a camera of the image sensor assembly 132. If a still camera is used, the light assembly 136 may include a light source configured to project a flash of light onto a QA sample and the support surface on which it rests as an image is captured with the camera. In other examples, a light source may produce a constant low level of light that is projected onto a QA sample/support surface. The light source may be one or more of a strobe light (e.g., camera flash) mounted near the camera lens, a ring light surrounding a camera lens, ambient light, etc. The light assembly 136 may further include a shroud assembly or other devices (e.g., air knives, mist evacuations systems, etc.) for sufficiently controlling the lighting conditions, regardless of the environment.

The QA scanning system 108 may further include an image processor 134, which may be used to receive, process, package, and/or send QA image data captured with the image sensor assembly 132 to the QA computing device 111 or another computing device (such as the monitoring system 112, the model management computing device 113, and/or the machine computing device 130 of the thermal processing system 104). In that regard, the image processor 134 may receive still images, 3D laser scan images, etc., and may perform any pre- or post-processing for sending QA image data to the QA computing device 111 or another computing device. For instance, the image processor 134 may send QA image data to the model management computing device 113 for training one or more machine learning models, as discussed herein. Any image data generated by a camera and/or scanner of the QA station 106, whether pre-or post-processed, may simply be referred to herein as “QA image data.”

Pre-or post-processing may include generating views from image data, formatting image data and/or views generated from image data, adding metadata to image data, packaging/condensing/transposing image data for transmitting to the QA computing device 111 or another computing device, etc. For instance, one or more of the imaging and/or calibrating methods described in U.S. Pat. Nos. 8,839,949, 10,471,619, 10,654,185, 10,721,947, 11,475,977, 10,427,882, 10,869,489, 11,266,156, 11,570,998, incorporated by reference in their entirety, may be used for pre-processing. It should be appreciated that some or all of the pre-or post-processing may instead be carried out by the QA computing device 111 or another computing device (such as the model management computing device 113).

In some examples, the image processor 134 may include one or more formatting modules configured to format image data for optimal transport to and/or processing by the QA computing device 111 or another computing device. For instance, formatting modules of the image processor 134 may perform at least one of transforming the image data, re-sizing the image data, labeling the image data, augmenting the image data, etc. In the specific example of a still image, formatting modules may perform at least one of gray-scaling the image, translating the image, rotating the image, scaling/re-sizing the image, adjusting contrast of the image, changing the contrast of the image data, adapting the image to certain model constraints, etc.

In some examples, the image processor 134 may process the 3D laser scan data for generating views/images from 3D scan data. For instance, the image processor 134 may receive 3D laser scan sensor data from the image sensor assembly 132 and generate a 3D point cloud of the scene. The image processor 134 may also package the 3D point cloud data in a suitable format for processing by a computing device, such as for creating a 3D model of a QA sample and/or a 2D representation of the height or elevation of the scene. In that regard, the image processor 134 may package the 3D point cloud data in a suitable format for transmission and/or further processing, such as CSV, .las, .ply, .png, .pdf, or similar. The 3D model of the QA sample and/or a 2D representation of the height or elevation of the scene may instead be generated by another computing device, such as the QA computing device 111.

The image processor 134 may include access to or otherwise be incorporated into a suitable structured light/3D laser scan software program(s) for scanner configuration and setup. The 3D scan software program(s) may be integrated into the 3D laser scanner or accessible on a remote or cloud-based server. If 3D laser scanner is a SICK® TriSpector1000 3Dlaser scanner, the integrated SOPAS software may be used to configure the scanner. 3D laser scan configuration may include defining parameters for objects, planes, region of interest, fields of view, blobbing (what are you blobbing, size, min width rectangle, etc.), pixel size (e.g., based on encoder counts), sensors, scan trigger points, data pre-processing, data output transmission, etc. For instance, the imaging support surface on which a QA sample rests during scanning (and optionally during weighing) may be defined as a plane. The plane may be used as a reference from which all height measurements may be determined.

Using a task module in the integrated SOPAS software or a similar software tool, the plane may be defined by using a predetermined percentile of points that are flat when scanned (e.g., the top 6%), ignoring an area in which a QA sample is normally located on the surface (e.g., a circle substantially centered on the surface). A plane can be built from those points. The plane may be ascertained for each 3D scan either with or without a QA sample resting on the imaging support surface. In this manner, any height measurements of a QA sample are always effectively calibrated because they may be calculated with reference to the imaging support surface plane for each scan image.

In other examples, a plane representing the imaging support surface may be calculated as parallel to a background in a still camera depth image using one or more plane equations, such as after a black background of an imaging surface is defined as a region of interest (ROI) for the image. Aspects or features of a background in a depth image may be used to obtain pixel samples of the background, such as by defining four corners or portions of the background. The plane can be calculated as substantially parallel to the four corners or portions of the background (e.g., a mean of pixels may be used to estimate a plane if not flat). After defining the plane, a 3D affine transformation matrix may be calculated to enable the image of a QA sample to be rotated and translated as a 3D object on top of the background plane.

After scanning, the image processor 134 may execute one or more modules (e.g., in SOPAS) to blob out the QA sample and separate it from the plane. In one example, an image segmentation machine learning model may be used to separate the QA sample (e.g., shown as a color image) from the plane (e.g., shown as a black background). For instance, the image segmentation machine learning model may incorporate the Segment Anything Model (SAM) available from Meta AI, FastSAM from Ultralytics, or another suitable image segmentation model using image segmentation techniques.

Each QA project may be identified as a “job” by correlating the scan and still image data to the QA sample plant number, system line/machine number, sub-lane number of the processing system, QA bin number, product sku or serial number, QA machine number, date/time, etc. In that regard, the image processor 134 may add metadata to any QA image data to indicate an origin of the QA sample being scanned/imaged.

The image processor 134 may format or package the QA image data for sending to the QA computing device 111 or another computing device either automatically when acquired by the camera, scanner, etc., in response to a request, and/or upon a trigger, such as when other QA data (e.g., weight data) for a specific QA sample or job is ready for sending. For instance, for each scan and still image, the QA image data may be exported to the QA computing device 111 or another computing device through a command channel. In that regard, the image processor 134 may be configured with an output interface for sending the QA image data to the QA computing device 111 or another computing device, such as ftp. In one example, the image processor 134 may output a .png file containing image data (e.g., FRS (reflectance) data, height data (peak height, min height, etc.), encoder data, etc.) along with any command strings and any other data to the QA computing device 111 or another computing device.

As noted above, the QA station 106 may further include a weight measurement assembly 110 configured to gather QA weight data of a QA sample. In general, the weight measurement assembly 110 is configured to capture QA weight data of a QA sample that may be used to assess one or more attributes of the QA sample for QA analysis, such as its process lethality, freezing curve stage, etc. The QA computing device 111 may use the QA weight data combined with 2D and/or 3D data and/or temperature data to determine, for instance, whether the thermal processing parameters of the thermal processing system 104 need to be adjusted, such as based on a calculated time-temperature profile or freezing curve.

Examples of a weight measurement assembly 110 for use in the QA station 106 will now be described. FIG. 1 depicts a block diagram that illustrates aspects of a non-limiting example of the weight measurement assembly 110 according to various aspects of the present disclosure. In the depicted example, the weight measurement assembly 110 includes a weight input device 138 for capturing QA weight data and an output device 140 for outputting the QA weight data to a processing device for QA analysis. For instance, the output device 140 may output the QA weight data to the QA computing device 111 through suitable wired or wireless means, such as through an ethernet, serial, or USB connection, Bluetooth, etc. In some examples, the QA weight data may be manually outputted (or inputted into) to the QA computing device 111 by a technician.

The weight input device 138 may be any suitable weight measurement device suitable for capturing a substantially accurate weight of the QA sample, whether the QA sample is stationary or being moved by a conveyance system. In one example, the weight input device 138 is a simple bench scale, such as an analog or digital scale (e.g., an iScale) that is configured to capture an analog or digital weight reading of a QA sample. In one example, the weight input device 138 is a high precision platform or bench scale having an integrated load cell and controller, optionally of food grade, stainless steel. The load cell may have an accuracy up to a tenth of a gram or the like depending on the application. Preferably, the scale is I/O capable for ease of installation and use.

The platform of the scale may also define the imaging support surface on which a QA sample is placed for being imaged by the image sensor assembly 132. In that regard, the QA sample can be weighed while simultaneously being imaged/scanned by the image sensor assembly 132. The image and weight data (as well as any other relevant QA sample data) can be timestamped for later retrieval and/or correlation when carrying out a QA analysis.

To support accurate imaging/scanning, the platform of the scale may preferable remain substantially stationary (not move in the vertical direction) when supporting a QA sample, especially if calibration of the scale platform is done before weighing and imaging the QA sample as described above. In other examples, calibration of the scale platform may be done when the QA sample is on the platform, such as by defining the platform as a plane in the scanner configuration as described above. In such an instance, scale platform movement after receiving a QA sample would not adversely affect simultaneous imaging.

In some examples, the weight input device 138 may be a support device that moves in response to the weight of a QA sample, and the degree of movement of the support device is measured by the image sensor assembly 132. For instance, the imaging support surface may be supported by high precision springs that allow for vertical movement under the increased load/weight of a QA sample. The vertical movement captured by the image sensor assembly 132 may be translated into a weight measurement for the QA sample by the image processor 134 and/or the QA computing device 111.

In some examples, the weight input device 138 may be incorporated into a conveyance system having a conveyor belt that moves product over the weight input device 138. For instance, the weight input device 138 may be configured as a load or weigh cell positioned beneath a belt portion of a conveyor belt such that when a QA sample passes over the weigh cell, a weight measurement for the QA sample may be taken. In that regard, the weight input device 138 may be configured as a weigh deck. For situations where a weigh deck is already in place at a food processing plant for weighing/sorting products processed by a processing machine, data captured by the weigh deck may be sent to the QA computing device 111 or another computing device for QA analysis and processing (such as the model management computing device 113 for training one or more machine learning models and/or the monitoring system 112 for QA weight analysis and reporting).

In some examples, the weight input device 138 may be defined by the conveyor belt itself, wherein vertical displacement of the belt caused by the weight of the QA sample may be measured to determine the product weight. For instance, vertical displacement of the conveyor belt may be captured in images by the image sensor assembly 132 and thereafter processed by the image processor 134 or the QA computing device 111 to determine the product weight. However, in an effort to minimize complexity of the QA station 106, the weight input device 138 may be simply configured as a substantially stationary bench scale, as discussed above.

If the image sensor assembly 132 is placed above a vertically displaceable imaging support surface for measuring weight and the vertical displacement of the surface is not used for measuring weight, the QA station 106 may be configured to accommodate for such vertical movement when processing the QA image data. For instance, in some examples, the image sensor assembly 132 may move vertically with the imaging support surface such that the distance between the image sensor assembly and the imaging support surface remains substantially constant. In other examples, the image processor 134 and/or the QA computing device 111 may account for such vertical displacement of the imaging support surface (such as by running a dynamic calibration module). In the examples described herein, the imaging support surface or platform height may be calibrated each time a QA sample is weighed/imaged/scanned, such as by defining the surface as a plane in the scanner configuration and/or in the image.

Referring again to FIG. 1, a non-limiting example of the temperature measurement assembly 146 according to various aspects of the present disclosure will now be described. In the depicted example, the temperature measurement assembly 146 includes a movement assembly 148 configured to move a temperature measurement device 150 into a temperature measurement position with respect to a QA sample, such as when a QA sample is located on an imaging support surface (e.g., a bench scale surface). The temperature measurement assembly 146 may be controlled by a controller 154, which may retrieve and/or receive input signals from the QA computing device 111 or another computing device for controlling movement of the movement assembly 148. For instance, the QA computing device 111 may determine a target measurement location of the QA sample (e.g., the core) based on an analysis of QA sample image data and optionally QA sample weight data, as will be described further below. The QA computing device 111 may then instruct the movement assembly 148 to correspondingly move the temperature measurement assembly 146 into a temperature measurement position with respect to a QA sample, such as for obtaining a temperature measurement of the core.

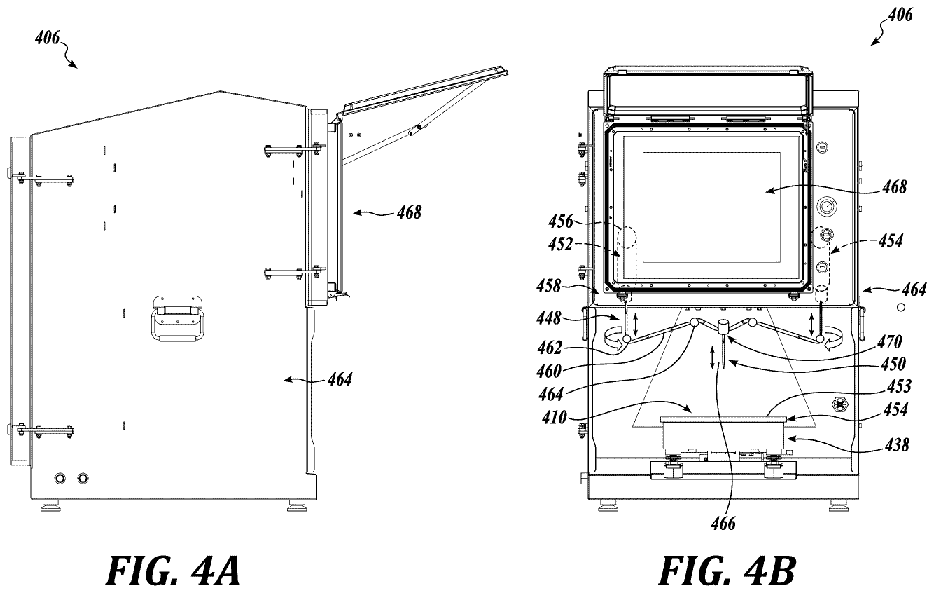

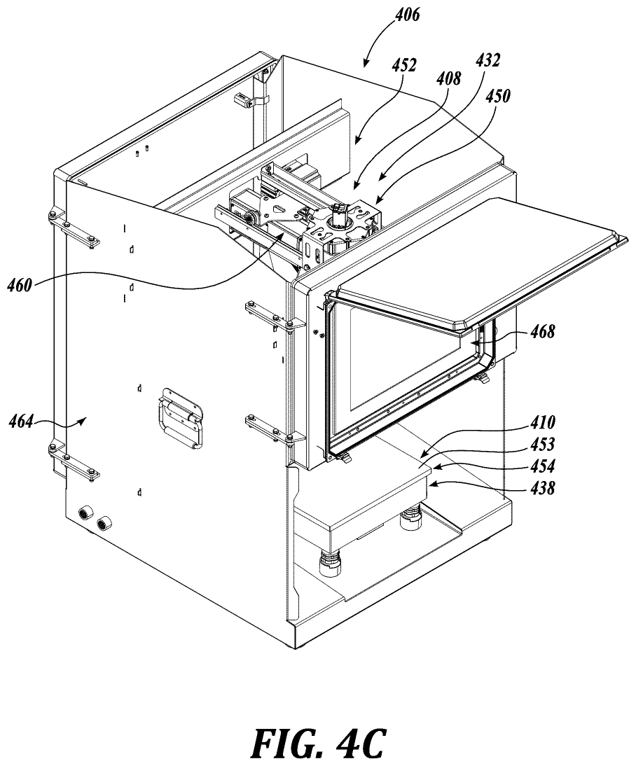

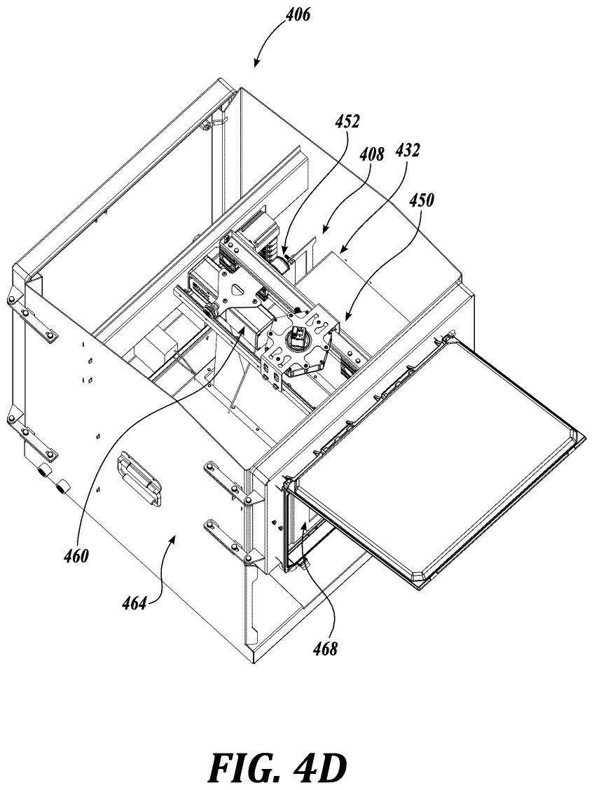

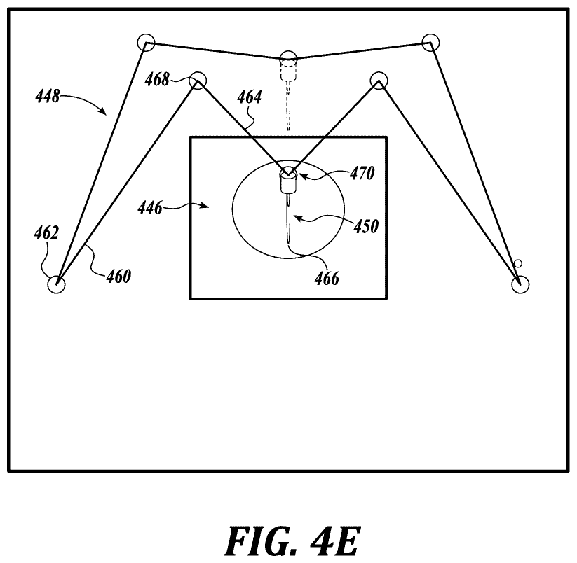

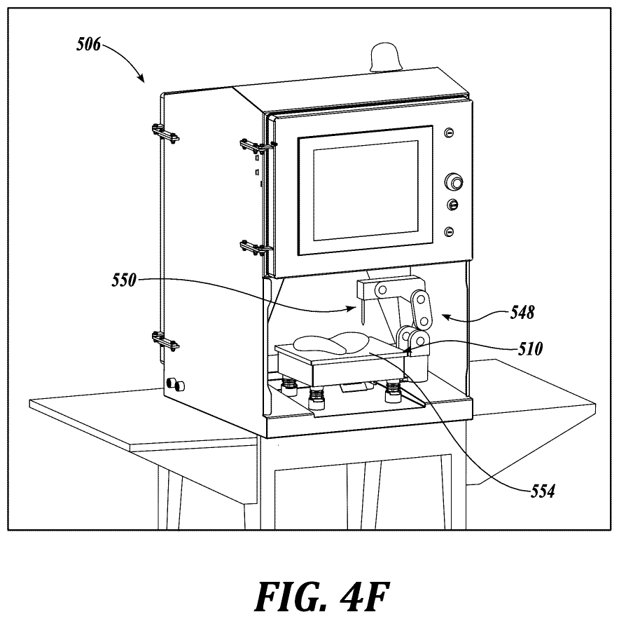

The temperature measurement assembly 146 may further include a temperature data output device 152 configured to output temperature measurement data to the QA computing device 111 or another computing device in communication therewith. For instance, data from a temperature probe can be transmitted to the QA computing device 111, either by hardwire or by wireless transmission. It should be appreciated that the temperature measurement assembly 146 may be integrated within the QA station 106, like that shown in FIGS. 4B, 4E, 5, FIG. 6, or the temperature measurement assembly 146 may instead be separate from or only partially integrated into the QA station 106.

In some examples, the temperature measurement device 150 is a temperature probe, and the movement assembly 148 is configured to move the temperature measurement device 150 into and out of engagement with a QA sample. The movement assembly 148 may be any suitable assembly configured to accurately and efficiently move the temperature probe within the physical constraints of the QA station 106 and/or the environment of the workpiece thermal processing management system 102. In some examples, the movement assembly 148 may include a main mover that is configured as an industrial robot, such as a SCARA, a 5-link robot, a 6-axis robot, or a cartesian (X-Y style) robot. If it is desired to insert a temperature probe into a QA sample at an angle, then a multi-axis robot may be preferred. In some examples, the movement assembly 148 is configured as a mirrored two bar linkage assembly powered by a linear rotary shaft actuator for simple insertion of the probe vertically into the QA sample, as will be described with respect to FIG. 4B. In examples where the temperature measurement device 150 is instead a thermal imaging system configured to determine a QA sample temperature using thermal image data, the movement assembly 148 may instead be simplified and/or eliminated.

The movement of a temperature probe may be in a prescribed manner. For instance, a probe may be initially inserted quite quickly to a sensing position that is somewhat above the middle of the thickness of the QA sample. Thereafter, the probe may be moved downwardly more slowly to approximately the center of the thickness of the QA sample and then somewhat beyond the center of thickness of the QA sample. Thereafter, the probe may be relatively quickly withdrawn upwardly. This prescribed motion of the probe may be based on the premise that the exact center of the thickness of the QA sample may not be accurately known, and there may be voids in the QA sample that can result in an erroneous reading. However, by taking many readings during the slower motion of the probes through the middle of the QA sample, the lowest temperature of the QA sample can be determined. This lowest temperature can then be analyzed regarding whether a thermal processing of the QA sample has properly occurred. Of course, if the QA sample is to be cooled or frozen, then through the prescribed motion of the temperature probe, the highest temperature of the QA sample can be found and/or other measurements may be obtained, as described further below.

In some examples described herein, the temperature measurement device 150 is a temperature probe, which may have one of various configurations for obtaining desired temperature data. In some examples, the temperature probe can be of a thermocouple construction. The temperature probe may be type K thermocouples or similar. Regardless of specific configuration, the temperature probe may be generally configured with a temperature sensor or measuring capacity at the tip of the probe. In this manner, the core temperature of the food product may be measured with minimal penetration. Moreover, the location of the temperature sensor within the food product is generally known. In some examples, the temperature probe may be generally configured with a temperature sensor or measuring capacity at the tip of the probe as well as along a length(s) of the probe for measuring the temperature at various locations in the QA sample.

The temperature probe may be of a diameter suitable for the QA application. In general, it is desirable to use a temperature probe that responds quickly and is durable (e.g., does not bend easily). In some examples, the probe must remain within the QA sample for a minimum amount of time to obtain a core temperature (e.g., the time needed for the probe to reach equilibrium with the product). In some examples, the probe must remain within the QA sample for a minimum amount of time to determine a process lethality. In some examples, the probe remains within the QA sample for a predetermined amount of time after leaving the thermal processing system 104, such as an amount of time for equilibration, an amount of time before a cooked product enters a freezer, a predetermined amount of time to determine a rate of temperature change, etc. For instance, for consistency for a given probe and workpiece type, a predetermined probe insertion time may be used (e.g., obtain temperature reading 8 seconds after inserting the probe). In some examples, the probe must remain within the QA sample until the measured core temperature reaches a minimum temperature (e.g., 165 F. for poultry), and if the core does not reach a minimum temperature within a certain duration of time, the probe remains inserted to track process lethality.

In that regard, a balance between probe response time and durability may be considered. For instance, in some examples, a 0.7-0.9 mm diameter temperature probe may have a response time of about 7-10 seconds for a meat product, and a 0.2-0.5 mm diameter temperature probe may have a response time of about 2-4 seconds for a meat product. Thus, a smaller diameter temperature probe may be preferred if a faster response time is desired, such as to maximize product throughput. However, a smaller diameter temperature probe may bend or damage more easily, so the nature of the workpiece (e.g., density, toughness, etc.) as well as the manner and number of times the probe is used may also be considered. Although a singular thermal probe is described and shown in FIGS. 4A-4D, instead two or more probes may be used, thereby to measure the temperature at different locations in the food product.

For frozen food products, a temperature probe may be inserted into a pilot hole drilled into or otherwise defined in the product (e.g., by the movement assembly 148 pushing an ice pick into the product) to allow probe penetration. In other examples, frozen food products may be stacked or placed adjacent to one another, and a temperature probe may be inserted between the frozen products to obtain a temperature measurement. In some examples, the movement assembly 148 or another assembly may be used to retain the frozen food product(s) in a substantially stationary position as a temperature measurement is taken. In any event, the temperature probe may remain inside and/or against a frozen food product(s) for a minimum amount of time to obtain a suitable temperature measurement (e.g., the time needed for the probe to reach equilibrium with the product(s)).

In some examples, the temperature measurement assembly 146 is configured to gauge the hardness (and therefore the frozen quality) of the frozen workpiece. In one example, the temperature measurement device 150 is a hardness tester defined by an end effector or indenter (e.g., a small sphere) at the end of a robotic arm or actuator. The indenter may be pressed into the QA sample by the movement assembly 148, and the temperature measurement assembly 146 may be used to measure force and deflection to gauge QA sample hardness. For instance, with reference to FIG. 4F, if a frozen QA sample is placed on a scale platform 554 of a weight measurement assembly 510, a robotic actuator 548 could press on the QA sample with the indenter to a certain level of force (as measured by the scale) for a certain displacement (as measured by the robot) at a certain angle of penetration (e.g., about 90 degrees). The QA sample's resistance to localized deformation can be used to determine hardness of the QA sample. As noted above, the movement assembly 148 or another assembly may be used to retain the frozen food product(s) in a substantially stationary position.

The hardness measurement(s) can be sent to the QA computing device 111 via the temperature data output device 152, as will be described further below. The QA computing device 111 can then process the hardness measurement data to assess frozen QA sample quality. Generally, the hardness can be correlated to the frozen state of the QA sample. For instance, a relatively “soft” QA sample may be under frozen (e.g., generally above the latent zone), an overly “stiff” QA sample may be over frozen (e.g., far below the latent zone). Periodically, the temperature probe or indenter may be cleaned or otherwise treated so that it remains in sanitary condition. This can be accomplished by numerous techniques, such as by induction or convection heating, heating by steam or hot air, heating by electromagnetic radiation, or heating by electrical current. The temperature probe or indenter may be sterilized after each use, or after a selected number of uses.

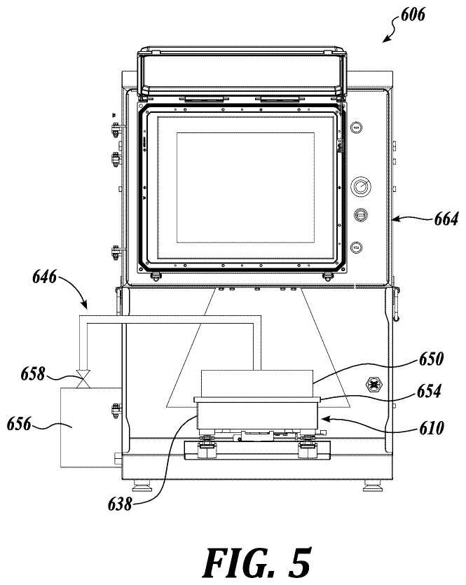

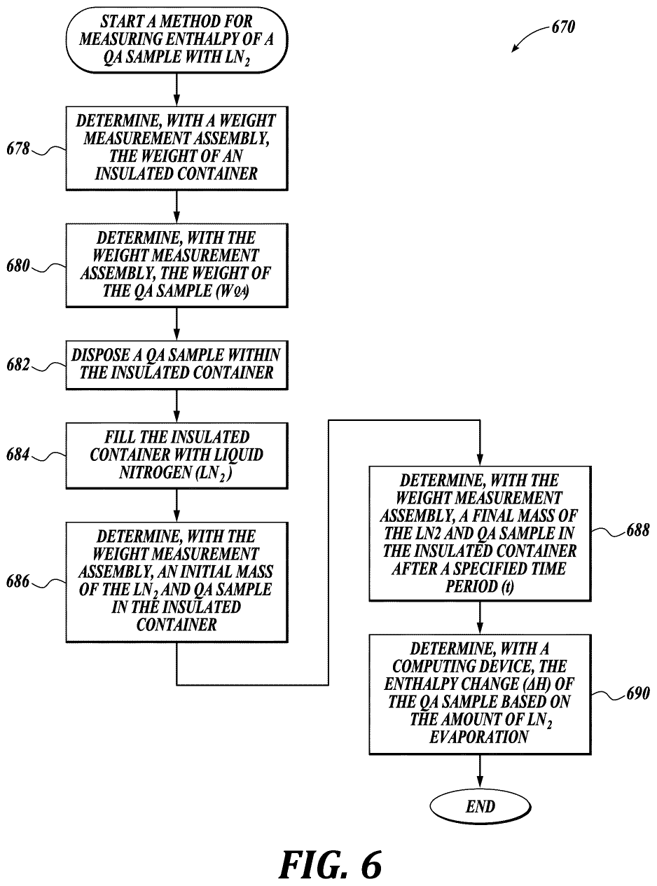

In some examples, the temperature measurement assembly 146 is configured to obtain an enthalpy measurement of a QA sample. For instance, an enthalpy measurement of a QA sample may be obtained using water, liquid nitrogen (LN₂), or both. Further detailed aspects of exemplary methods of measuring enthalpy of a QA sample will be described below with respect to FIGS. 5 and 6.

In some examples, the temperature measurement assembly 146 is configured to determine a density change, or a volume change rate of a frozen QA sample, to calculate QA sample freezing curve data, such as a starting temperature of the QA sample, a latent zone point (the latent zone point for the QA sample freezing curve, such as nearer a high/warm end of the latent zone or a low/cold end), a freezing curve point (e.g., how far above or below the latent zone), etc. As is known in the art, a frozen food product will decrease in volume (and increase in density) as it thaws from a frozen state. Thus, a volume change rate of a frozen QA sample can be monitored to assess a frozen QA sample freeze quality.

In some examples, the temperature measurement assembly 146 is configured to measure a volume change rate by submerging the frozen QA sample in warm or hot water (e.g., sufficiently warm to allow the frozen QA sample to be submerged in the water), and then a change in volume of the water is measured over time to assess the volume change rate of a frozen QA sample. Such a measurement may be taken while also measuring the enthalpy of the frozen QA sample with water, as will be described further below.

In some examples, the image sensor assembly 132 is used to obtain image sensor data of the frozen QA sample for generating a 2D and/or 3D models of the frozen QA sample. The 2D and/or 3D models of the frozen QA sample can be used to calculate a volume and any other relevant dimensional data of the frozen QA sample. The frozen QA sample volume can be monitored over time (e.g., using suitable image sensor data obtained by the image sensor assembly 132) to determine a volume change rate of a frozen QA sample.

In some examples, a frozen QA sample volume change rate can be used to determine a latent zone point of a frozen QA sample. For instance, a frozen QA sample at a high or warm end of the latent zone will likely have a smaller volume rate change than if it was at a cold or low end of the latent zone. If the QA sample volume change rate is small, it may be indicative of a frozen QA sample at a high or warm end of the latent zone (which has not yet fully undergone a phase change). In other words, if the frozen QA sample volume change rate is small, it may be indicative that the second stage of freezing has not completed. As noted above, an industrial freezing process must cool the food product at least through the second stage of freezing. If the product is still in the latent zone at the end of the industrial freezing process, the product is under-frozen.

In some examples, a frozen QA sample volume change rate can be used to determine a freezing curve point of the frozen QA sample (e.g., how far above or below the latent zone). The volume change rate is monitored, such as by scanning the frozen QA sample periodically (e.g., every 0.5-1 minutes) and comparing the scan data (e.g., comparing calculated volume from a scan-based 2D/3D generated model). The time in which the frozen QA sample is not changing in volume can be used for an estimate of the sensible heat in the frozen QA sample below the freezing point. The volume of the frozen QA sample volume changes over time as the sample undergoes a phase change from frozen to thawed. As noted above, image data (as well as any other relevant QA sample data) can be timestamped for later retrieval and/or correlation when carrying out a QA analysis.

The frozen QA sample volume change rate (e.g., determined by comparing calculated volume from a scan-based 2D/3D generated model), frozen QA sample weight data, etc., can be processed by a computing device (e.g., the QA analysis engine 716 of the QA computing device 111) together with relevant specific heat capacity values (e.g., the heat capacity of the QA sample above and below the latent zone), the latent heat of fusion for the QA sample (e.g., an estimated value associated with the same type of QA samples), etc., to determine a rate of heat pick-up for the frozen QA sample. The heat pick-up for the frozen QA sample can be processed by a computing device to determine a starting temperature of the frozen QA sample and the freezing curve point (e.g., how far below the latent zone).

In some examples, the frozen QA sample can be heated during a volume change rate analysis to expedite the process. For instance, the frozen QA sample can be heated with warm air circulated around/over the frozen QA sample, with a heated surface on which the frozen QA sample rests (e.g., a hot plate below the scale platform, a pre-heated slab below the scale platform, etc.), with a heat lamp, etc., or any combination thereof.

In some examples, an average volume change rate of multiple frozen QA samples is used to calculate QA sample freezing curve data, such as a starting temperature and/or latent zone point of the frozen QA samples. Using an average change rate from multiple QA samples can help account for errors in volume calculation due to shadowing, undercutting, voids, etc. In that regard, in some examples, the image sensor assembly 132 may be considered a part of the temperature measurement assembly 146, and/or vice versa.

An example of a QA station 406 formed in accordance with systems and methods disclosed herein will now be described with reference to FIGS. 4A-4D. Parts of the QA station 406 like those used in the QA station 106 are labeled with the same reference numeral except in the '400 series. Generally, the QA station 406 includes an integrated QA scanning system 408, a weight measurement assembly 410, a temperature measurement assembly 446, and at least one QA computing device (not shown).

With an integrated scanning system, weight measurement assembly, temperature measurement assembly, and computing device, the QA station 406 may be used to substantially simultaneously and accurately capture image data and weight data, while enabling accurate internal temperature measurement. In this manner, fast and accurate QA data may be obtained for performing a QA analysis of a QA sample. For instance, a QA station having an integrated QA scanning system, weight measurement assembly, temperature measurement assembly, and computing device, like the QA station 406 shown and described herein, avoids “double handling” of a QA sample, which is prone to error. More specifically, if a QA weight measurement of a QA sample is taken with an assembly or system separate from the QA scanning system, a correlation of data between the weight measurement assembly and the scanning system is needed to confirm that weight and scan data pertains to the same QA sample. Along the same lines, if a QA temperature measurement of a QA sample is taken with an assembly or system separate from the QA weight system, a correlation of data between the weight measurement assembly and the temperature measurement system is needed to confirm that weight and temperature data pertains to the same QA sample. Any discrepancy in data sequencing can cause errors, leading to invalid and unusable QA data.

Collecting size, weight, and temperature data together reduces a margin of error, allowing for finer thermal processing control. In other words, the temperature data is tied to a workpiece of a certain size and weight. In that regard, thermal processing parameters (e.g., oven dwell time and/or temperature) can be adjusted for workpieces of different sizes/weights. In some cases, workpiece size may remain substantially the same, but thermal processing parameters can be adjusted to account for workpiece size variation within the production run. For instance, dwell times and/or temperature could be adjusted to achieve a satisfactory margin of error for the target core temperature or time-temperature profile based on the largest, most difficult-to-cook workpieces.

The QA station 406 shown and described herein is one example of a QA station having an integrated QA scanning system, weight measurement assembly, temperature measurement assembly, and computing device(s). It should be appreciated that other configurations are possible.

The QA scanning system 408 of the QA station 406 will first be described. The QA scanning system 408 may include an image sensor assembly 432, a light assembly (not shown), and at least one image processor. A housing 464 may enclose at least some of the components of the QA station 406 for sanitation, ease of cleaning, ease of use/storage, etc.

The image sensor assembly 432 may include at least one still camera 450 and at least a structured light scanner 452 located above an imaging support surface 453 on which the QA sample may rest during imaging. The at least one still camera 450 may be mounted to an interior portion of the housing 464 or a structure within the housing. The at least one still camera 450 may be any suitable optical still camera(s) for the intended application, such as one or more of a greyscale camera, an RGB camera an IR camera, a UV camera, a CCD, multispectral or hyperspectral camera, etc.

The light assembly, which may also be mounted to an interior portion of the housing 464 or a structure within the housing, may be any suitable light assembly configured to provide sufficient lighting of the QA sample and imaging support surface 453 for capturing images by the at least one still camera 450. For instance, the light assembly may include a strobe light configured to illuminate the imaging support surface 453 when a snapshot is taken by the at least one still camera 450. In some examples, the at least one still camera 450 may be eliminated, in which case the light assembly may also be eliminated.

The structured light scanner 452 may also be mounted to an interior portion of the housing 464 or a structure within the housing. More particularly, the structured light scanner 452 is mounted to a linear actuator 460 that is mounted to an interior portion of the housing 464 or a structure within the housing. In this manner, the structured light scanner 452 is movable relative to the imaging support surface 453 such that a laser line of the scanner may sweep across a length of the imaging support surface 453. The linear actuator 460 may include an integrated encoder to track the movement of the structured light scanner 452 for accurately capturing image data relative to sweep distance of the laser line. In one example, the structured light scanner 452 is a SICK® TriSpector 1000 3Dlaser scanner and the linear actuator is a belt-driven linear actuator, such as the Festo® toothed belt axis ELGE-TB actuator with encoder.

The structured light scanner 452 may include an integrated image processor configured to run scanner software configurable for the intended application. The scanner software may be used to configure the structured light scanner 452 for the intended application, such as by defining parameters for objects, planes, region of interest, field of view, blobbing, pixel size, sensors, scan trigger points, etc. Configuration may include using a task module in the software to define a plane for the top surface of the imaging support surface 453 such that any height data and measurements may be determined with reference to the plane, as discussed above. Configuration may include using a task module in the software to set up any data pre-processing, data output transmission commands, etc. If a SICK® TriSpector 1000 3Dlaser scanner is used, the integrated SOPAS software may be used to configure the scanner as discussed above.

The weight measurement assembly 410 of the QA station 406 will now be described. The weight measurement assembly 410 may include a weight input device 438 generally configured as a high accuracy bench scale or load cell for capturing QA weight data. In the example shown, the load cell, which defines the platform 454, is positioned on adjustable legs and is removable from an interior compartment of the housing 464. However, in other examples, the weight input device 438 includes a load cell built into a bottom portion of the housing 464. In any event, if the weight input device 438 is intended for use in an industrial food processing setting, it may be washable and made from food grade materials. To help with cleaning, the platform 454 of the scale as well as any interior horizontal portions of the housing 464 may be at a slight angle to facilitate drainage from a front opening of the housing 464.

The weight measurement assembly 410 further includes an output device (not shown) for outputting the QA weight data to a processing device for QA analysis. The output device may be configured as a controller that is separate from or integrated into the weight input device 438. The output device may be configured to perform any pre-or post-processing of weight data and may send it to the QA computing device 111 and/or the machine computing device 130 though suitable wired or wireless means, such as through an ethernet, serial, or USB connection, Bluetooth, etc.

As noted above, the QA station 406 is configured to substantially simultaneously capture image and weight data. In other words, scans and still images of the QA sample may be captured by the image sensor assembly 432 when the QA sample is being weighed or while the QA sample is on the platform 454. In that regard, the platform 454 of the weight input device 438 also defines the imaging support surface 453. The platform 454 of the weight input device 438 may therefore be located beneath the image sensor assembly 432, such as beneath a window defined in an upper portion of the housing 464 through which imaging may occur. In this manner, when a QA sample is placed on the platform 454 to be weighed, the at least one still camera 450 and the structured light scanner 452 may capture still image and 3D laser scan data. Substantially simultaneously capturing image and weight data speeds up a QA process, such as compared to systems that include separate weight and imaging assemblies.

The temperature measurement assembly 446 of the QA station 406 will now be described with specific reference to FIG. 4B. The temperature measurement assembly 446 includes a temperature measurement device 451 moveable by the movement assembly 448 into a temperature measurement position. In the example shown, the temperature measurement device 451 is a temperature probe 466, and the movement assembly 448 is a mirrored two bar linkage assembly powered by a linear rotary shaft actuator assembly. The mirrored two bar linkage assembly is moveable by the linear rotary shaft actuator assembly to locate the temperature probe 466 in a desired X-Y location relative to a QA sample. Once in the desired X-Y location, the mirrored two bar linkage assembly is further moveable vertically by the linear rotary shaft actuator assembly to enable the temperature probe 466 to penetrate the QA sample for temperature measurement.

In the example shown, the movement assembly 448 includes a first linear rotary actuator 452 located on a first upper, interior portion of the housing 464, and a second linear rotary actuator 454 located on a second, opposite upper, interior portion of the housing 464. A cylinder 456 of each of the first linear rotary actuator 452 and second linear rotary actuator 454 may be located within the enclosure of the housing 464, and an extendable/rotatable rod 458 of the actuators may extend downward into a cavity in the housing 464 above the weight measurement assembly 410. In that regard, the rods 458 may pass through a suitable seal disposed in a housing wall such that the QA station 406 is washdown compatible.

The mirrored two bar linkage assembly generally includes four rigid bars connected by joints to facilitate movement of each of the bars about vertical axes, with the temperature probe 466 located at a center joint 470. A first side of the mirrored two bar linkage assembly will be described, with the understanding that the mirrored two bar linkage assembly is identical on the other side.

A first bar 460 is moveably secured to a distal end of the actuator rod 458 with a first single axis pivot assembly 462. The first single axis pivot assembly 462 allows the first bar 460 to pivot about a corresponding first substantially vertical axis. A second bar 464 is moveably secured to a distal end of the first bar 460 through a second single axis pivot assembly 468. Like the first single axis pivot assembly 462, the second single axis pivot assembly 468 facilitates movement of the second bar 464 about a corresponding second substantially vertical axis. A distal end the second bar 464 is moveably secured to the center joint 470. The center joint 470 facilitates movement of the second bar 464 about a third substantially vertical axis.

As noted above, the temperature probe 466 is located at the center joint 470. Specifically, the temperature probe 466 extends vertically downwardly from the center joint 470 such that a probe axis is substantially aligned with the third substantially vertical axis of the center joint 470. In that manner, movement of the first and second bars 460 and 464 about the substantially vertical axes of the first single axis pivot assembly 462, second single axis pivot assembly 468, and center joint 470 on each side of the mirrored two bar linkage assembly adjusts the X-Y location of the temperature probe 466. The first and second bars 460 and 464 are moved about the axes of the first single axis pivot assembly 462, second single axis pivot assembly 468, and center joint 470 by rotation of the rods 458 of the corresponding first linear rotary actuator 452 and second linear rotary actuator 454.

A schematic illustration of the mirrored two bar linkage assembly is shown in FIG. 4E, where identical reference numerals used in FIG. 4B are used to reference the same part shown schematically in FIG. 4B. The mirrored two bar linkage assembly is shown in a first position, with the temperature probe 466 in solid lines, and a second, “home” position, with the temperature probe 466 shown in dashed lines. As can be appreciated, the first and second bars 460 and 464 pivot relative to each other about vertical axes to adjust an X-Y position of the temperature probe 466.

When the temperature probe 466 is in a desired X-Y position, the first and second linear rotary actuators 452 and 454 simultaneously move the rods 458 linearly along the first and second vertical axes of the first single axis pivot assemblies 462 to move the probe into or out of engagement with the QA sample. In other words, the entire mirrored two bar linkage assembly is moved linearly along the first, second, and third substantially vertical axes to move the probe into or out of engagement with the QA sample. Any suitable (preferably food-grade) linear rotary actuators may be used, such as a linear rotary motor available from Linmot USA Inc. of Lake Geneva, WI.

The at least one QA computing device of the QA station 406 will now be described. The at least one QA computing device may be defined by a single device or a collection of devices. For instance, the at least one QA computing device may incorporate one or more functional aspects of the QA computing device 111, described further below, and/or the machine computing device 130. In addition, the at least one QA computing device may include any necessary controllers, adapters, etc., of any of the components of the QA scanning system 408, the weight measurement assembly 410, and the temperature measurement assembly 146. Of note, the at least one still camera 450, structured light scanner 452, linear actuator 460, weight measurement assembly 410, and first and second linear rotary actuators 452 and 454 may be I/O link capable to allow for ease of installation and control. Any wired connections between components may be either enclosed inside the housing 464 or passed through a suitable seal received in a housing wall such that the QA station 406 is washdown compatible.

The QA station 406 may include a display unit 468 secured within an upper portion of the housing 464. The display unit 468 may be configured to display information to a user through a graphical user interface (GUI), such as a GUI associated with the scanner software (e.g., SOPAS) or another computing device (e.g., the QA computing device 111 or machine computing device 130). The display unit 468 may be coverable/sealable by a cover to ensure washdown capability.

Another example of a QA station 506 formed in accordance with systems and methods disclosed herein will now be described with reference to FIG. 4F. Parts of the QA station 506 like those used in the QA station 406 are labeled with the same reference numeral except in the '500 series. Generally, the QA station 506 is identical to the QA station 406 except that the movement assembly of the temperature measurement assembly is configured as a robotic arm 548. As can be seen, the robotic arm 548 is situated inside the cavity of the housing and next to the scale, although the robotic arm 548 may instead be in any suitable area of the QA station 506. As noted above, the robotic arm 548 may also or instead be used to move an indenter into engagement with a frozen QA sample for gauging hardness of the QA sample.

Moreover, although in the examples shown, the movement assembly of the temperature measurement assembly is arranged inside of or otherwise integrated into the QA station, it should be appreciated that in some examples, the movement assembly of the temperature measurement assembly may be arranged at least partially outside of or otherwise separate from the QA station. In such an example, the temperature measurement data need not be correlated to the image and/or weight data, as discussed herein.

Another example of a QA station 606 formed in accordance with systems and methods disclosed herein will now be described with reference to FIG. 5. In one example, the QA station 606 includes an integrated QA scanning system, weight measurement assembly, and an optional movement assembly, like the QA station 406 and QA station 506. In some examples, the QA scanning system and weight measurement assembly are substantially the same as that described above with reference to the QA station 406 and/or the QA station 506. In that regard, the same parts and assemblies are labeled with the same reference numerals except in the '600 series (e.g., the QA station 606 includes a QA scanning system (not shown) and a weight measurement assembly 610). The QA station 606 may be communicatively coupled to a computing device(s) for controlling aspects of the QA station, such as the QA computing device 111 and/or the machine computing device 130. A housing 664 may enclose at least some of the components of the QA station 606 for sanitation, ease of cleaning, ease of use/storage, etc. It should be appreciated that other configurations are possible.

The QA station 606 further includes an integrated temperature measurement assembly 646 that is generally configured to measure the enthalpy of a QA sample. In some examples, the temperature measurement assembly 646 is configured to measure the enthalpy of a food product using liquid nitrogen (LN₂). Enthalpy testing with LN₂ (also known as a form of cryogenic calorimetry or LN₂ calorimetry) typically involves measuring the heat energy associated with phase changes or heat transfer at cryogenic temperatures, often utilizing the evaporation rate of LN₂ to determine the heat load of a workpiece. Measuring the enthalpy of a food product using LN₂ may be employed to determine the specific heat capacity or the total heat to be removed during freezing. This technique operates on the principle that the heat released by the food product as it cools equals the heat absorbed by the nitrogen, causing it to vaporize. The enthalpy change (ΔH) of the food may be determined by calculating the total heat transferred, which is the sum of sensible heat (cooling to freezing point) and latent heat (freezing the water in the food).

Any suitable components and techniques may be used to carry out enthalpy testing with LN₂. In some examples, to facilitate enthalpy testing, the integrated temperature measurement assembly 646 includes an insulated container 650 (e.g., a “calorimeter”) for holding the workpiece to be analyzed and the LN₂. The insulated container 650 may optionally be a part of the weight measurement assembly 610. For instance, the insulated container 650 may define a contained portion of a platform 654 of a bench scale 638 of the weight measurement assembly 610.

The integrated temperature measurement assembly 646 may further include an LN₂ source, such as a LN₂ tank 656 and valve assembly 658. The valve assembly 658 may be controllable by the QA computing device 111 and/or the machine computing device 130 to enable LN₂ to flow into the insulated container 650. A suitable pump assembly, not shown, may be used to flow LN_{2.} Also, a suitable safety assembly, such as to allow for proper ventilation and protection from LN₂, may also be used. For instance, an open side of the housing 664 may be enclosable with a door during testing, and/or a fluid evacuation system may be configured to withdraw fluids from inside or beneath a hood of the housing 664. In some examples, the QA station 606 includes a movement assembly, not shown, that may be configured to carry out tasks associated with enthalpy measurement of a QA sample. For instance, the movement assembly may include a linkage assembly and/or a robotic arm (e.g., like that shown in FIGS. 4E and 4F, respectively) configured to move one or more components of the integrated temperature measurement assembly 646.

Using the integrated temperature measurement assembly 646 or other suitable components, an enthalpy test (LN₂ calorimetry) may be carried out on a QA sample in any suitable manner. Various exemplary steps for measuring enthalpy of a QA sample with LN₂ using the integrated temperature measurement assembly 646 will now be described.

In a first step, the weight of the insulated container 650 may be determined. For instance, the insulated container 650 may be disposed on the platform 654 of the bench scale 638 of the weight measurement assembly 610, and the weight can be automatically determined and recorded by the weight measurement assembly 610 (e.g., using the QA computing device 111).

A next step may include determining the weight of the QA sample (W_{QA}). The weight of the QA sample may be determined with the weight measurement assembly 610. For instance, the QA sample may be placed inside the insulated container 650 on the bench scale platform (such as manually and/or with a movement assembly). The total weight of the QA sample and the insulated container 650 may be determined (W_{QA+C}), and then the QA sample weight is calculated by subtracting the weight of the insulated container 650 (W_{C}) (e.g., via one or more engines of the QA computing device 111). In another example, the weight of the QA sample may be taken after the insulated container 650 is filled with LN₂. In another example, the weight of the QA sample is determined by using the QA scanning system to determine the size of the QA sample, and a known density is used to determine the weight. In another example, the weight measurement assembly 610 may include first and second bench scales for determining the weight of the QA sample and the weight of the LN₂ filled insulated container 650.

In a next step, the insulated container 650 is partially filled with liquid nitrogen (LN₂), such as to about 75% of the container volume. The insulated container 650 may be partially filled with LN₂ by activating the valve assembly 658 to flow a selective volume of LN₂ to the insulated container 650. The insulated container 650 may be covered by a lid (such as manually and/or with a movement assembly).

A next step may include determining an initial mass of the LN₂ and QA sample in the insulated container 650 (W_{QA+C+LN2}). For instance, if the insulated container 650 defines a portion of the platform 654 of the bench scale 638 of the weight measurement assembly 610, the initial mass may be automatically determined and recorded by the weight measurement assembly 610 (e.g., using the QA computing device 111) after the container is filled with the QA sample and LN₂.

A next step may include measuring a boil-off rate of LN₂ when the container is filled with the QA sample and LN₂ (BR_{QA}), such as in grams per minute (g/min). The BR_{QA} may be determined after a specified time period (t) (e.g., about the time at which the QA sample has reached the temperature of the LN₂), such as about 5 minutes. The BR_{QA} can be determined by tracking the weight loss with the weight measurement assembly 610 (e.g., BR_{QA} =(W_{C+LN2}−W_{QA+C+LN2})/t).

In some examples, another step may include determining an amount of LN₂ (grams) that evaporates naturally (BR_{EV}) from the insulated container 650 per time unit (g/min). The BR_{EV} is due to environment and is thus determined before the QA sample is added to the insulated container 650 (BR_{EV}). If BR_{EV} is determined, the QA sample weight may be determined after the insulated container 650 is filled with LN₂. In such an example, a step for measuring enthalpy of a QA sample may include determining the weight of the LN₂ filled insulated container 650 (W_{C+LN2}) and then immediately placing the QA sample into the LN₂ filled insulated container 650. The weight of the LN₂ filled insulated container 650 may be determined in the same manner as the initial mass of the LN₂ and the insulated container 650 is determined.

A next step may include determining the enthalpy change (ΔH) of the QA sample based on the amount of LN₂ evaporation. For instance, the enthalpy change may be calculated as follows for a QA sample, where Lᵥₐₚ is the latent heat of vaporization of LN₂ (199 kJ/kg):

a. ΔH=(BR_{QA}−BR_{EV})*t)*Lᵥₐₚ

With reference to FIG. 6, a non-limiting example of a method 670 for measuring enthalpy of a QA sample with LN₂ with the integrated temperature measurement assembly 646 or similar may include:
at step 678, determining, with a weight measurement assembly (such as the weight measurement assembly 610), the weight of an insulated container;
at step 680, determining, with the weight measurement assembly, the weight of the QA sample (W_{QA});
at step 682, disposing a QA sample within the insulated container;
at step 684, filling the insulated container with liquid nitrogen (LN₂);
at step 686, determining, with the weight measurement assembly, an initial mass of the LN₂ and QA sample in the insulated container (W_{b(QA+C+LN2)});
at step 688, determining, with the weight measurement assembly, a final mass of the LN₂ and QA sample in the insulated container after a specified time period (t) (W_{a(QA+C+LN2)});
at step 690, determining, with a computing device, the enthalpy change (ΔH) of the QA sample based on the amount of LN₂ evaporation.

In some examples, a QA station temperature measurement assembly (e.g., the temperature measurement assembly 646, the temperature measurement assembly 146, etc.) is configured to measure the enthalpy of a food product using water. For instance, a weighed, dimensioned, frozen QA sample can be submerged within a set amount of water at a set temperature (sufficiently warm or hot to enable the QA sample to be submerged). The temperature of the water is monitored, and when a change in water temperature substantially stops (indicating that the temperature of the water and the QA sample are substantially the same), the time and temperature are recorded. A starting temperature and/or freezing stage of the QA sample can be calculated using known heat transfer calculations.

Generally, a starting temperature and/or freezing stage of the QA sample can be calculated using heat balances between the water, the QA sample, and the environment (e.g., evaporation of water to the atmosphere, QA sample water absorption, water density change, etc.), measured weights/volumes of the water and the QA sample (e.g., QA Sample volume and weight before and after the test, volume ratio of water to QA sample, etc.), measured temperature changes of the water (with an assumption that the final water temperature and the QA sample temperature are substantially the same), and determined or assumed heat constants (e.g., the relevant specific heat capacity values (e.g., the heat capacity of the QA sample above and below the latent zone), the latent heat of fusion for the QA sample (e.g., an estimated value associated with the same type of QA samples and/or determined from an LN2 enthalpy test).

As noted above, a QA station temperature measurement assembly (e.g., the temperature measurement assembly 646, the temperature measurement assembly 146, etc.) may be configured to measure a volume change rate by submerging the QA sample in warm or hot water (e.g., sufficiently warm to allow the QA sample to be submerged in the water), and then a change in volume of the water is measured over time to assess the volume change rate of a QA sample. Such a test for QA sample volume change rate can be done substantially simultaneously with an enthalpy test using water to increase efficiency of a QA analysis.

Moreover, by obtaining both an enthalpy measurement and a volume change rate of a QA sample, as well as any other QA sample data (e.g., volume, weight, hardness, etc.), accuracy of a QA analysis output can increase. In other words, a freezing stage can be determined using a first technique (e.g., an enthalpy measurement), and the result of that first technique can essentially be verified or otherwise modified by a second technique (e.g., a volume change rate of a QA sample). Further, the various QA sample datum can be used as input by a machine learning model(s) to output a QA sample starting temperature, a freezing stage, etc.

Although specific aspects of the thermal processing QA systems and methods are described with respect to the QA stations shown in FIGS. 4A-4F, 5, and 6, it should be appreciated that such aspects may be used with any suitable QA station or system. In that regard, any of the components, assemblies, techniques, etc., described with respect to the QA stations shown in FIGS. 4A-4F, 5, and 6, or any other QA system herein (e.g., the QA station 106) may be combined with, in whole or in part, the components, assemblies, techniques, etc., described with respect to any of the other QA stations.

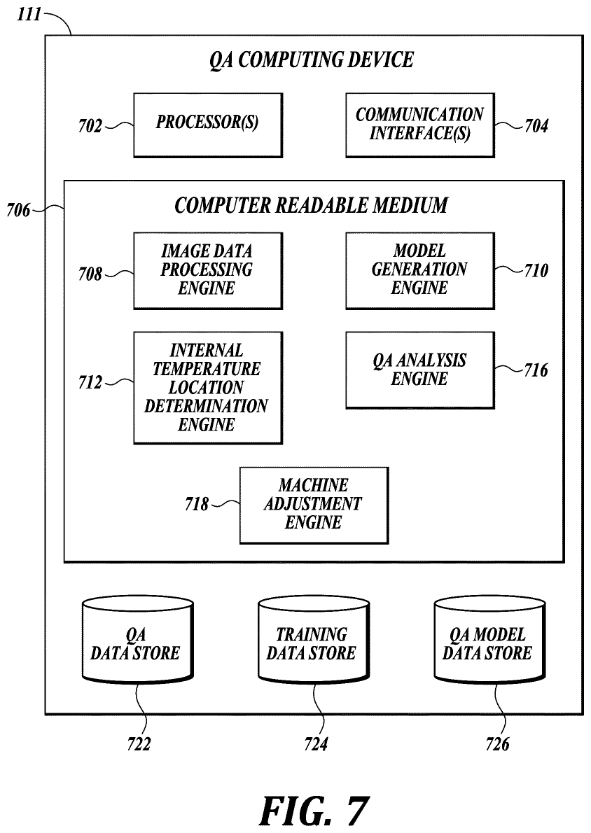

FIG. 7 depicts a block diagram that illustrates aspects of a non-limiting example of a QA computing device 111 configured to carry out some or all of the functions of the thermal processing QA systems and methods described herein. It should be appreciated that certain functions may instead be carried out by another computing device, such as the image processor 134 of the QA scanning system 108, the machine computing device 130 of the processing system 104, or both, and/or another computing device, such as the monitoring system 112 and/or the model management computing device 113. The QA computing device 111 may be in networked communication with any of the other devices of the workpiece thermal processing management system 102, such as the image processor 134 of the QA scanning system 108, the output device 140 of the weight measurement assembly 110, the temperature data output device 152 of the temperature measurement assembly 146, the machine computing device 130, the monitoring system 112, and the model management computing device 113. Although the QA computing device 111 is described with reference to the QA station 106, it should be appreciated that the function of the QA computing device 111 may be incorporated into any suitable QA station.

In general, the QA computing device 111 includes a processor(s)s 702, a communication interface(s)s 704, and computer readable medium 706, and one or more data stores (e.g., a QA data store 722, a training data store 724, and a QA model data store 726).

The QA computing device 111 may be implemented by any computing device or collection of computing devices, including but not limited to a desktop computing device, a laptop computing device, a mobile computing device, an edge computing device, a PLC, a server computing device, a computing device of a cloud computing system, and/or combinations thereof. In some examples, the processor(s) 704 may include any suitable type of general-purpose computer processor. In some examples, the processor(s) 704 may include one or more special-purpose computer processors or AI accelerators optimized for specific computing tasks, including but not limited to graphical processing units (GPUs), vision processing units (VPTs), and tensor processing units (TPUs).

In one example, the QA computing device 111 may be configured as a NVIDIA Jetson Orin package, such as an Advantech MIC-711-OX. A TCP/IP connection may be used to transfer data between the QA computing device 111 and the machine computing device 130 and/or another computing device (e.g., the monitoring system 112 or the model management computing device 113).

In some examples, data speed between the QA computing device 111 and the machine computing device 130 and/or another computing device (e.g., the monitoring system 112 or the model management computing device 113) may be increased by using PCI firewire or other communication bridges. In other examples, data speed between the QA computing device 111 and other computing devices may be increased by continuing to use a general network protocol connection like TCP/IP, but while increasing the processing power of the QA computing device 111.

A communication protocol may be used to reliably and efficiently send data between the QA computing device 111 and other computing devices. The communication protocol may be configured as a high-level protocol that is not platform dependent and allows for simple commands to be used. For instance, the communication protocol may enable two-way communication between the QA computing device 111 other computing devices. Protocol Buffers (Protobufs) may be utilized to optimize efficiency of data transport. The protocol may support both synchronous and asynchronous communications. In some examples, a high level, restricted API implemented on the QA computing device 111 and/or the machine computing device 130 may be used to verify transmitted sensor data.

In some examples, the communication interface(s)s 704 include one or more hardware and or software interfaces suitable for providing communication links between components. The communication interface(s) 704 may support one or more wired communication technologies (including but not limited to Ethernet, FireWire, and USB), one or more wireless communication technologies (including but not limited to Wi-Fi, WiMAX, Bluetooth, 2G, 3G, 4G, 5G, and LTE), and/or combinations thereof.

As shown, the computer readable medium 706 has stored thereon logic that, in response to execution by the one or more processor(s) 702, may cause the QA computing device 111 to provide an image data processing engine 708, a model generation engine 710, an internal temperature location determination engine 712, a process lethality module, a QA analysis engine 716, and a machine adjustment engine 718.

Exemplary aspects of the image data processing engine 708 will first be described. The image data processing engine 708 may be generally configured to process, format, store, and/or transmit any image sensor data received and/or retrieved from the image sensor assembly 132 and/or the image processor 134 of the QA scanning system 108. As noted above, the QA scanning system 108 may include an image processor 134, which may receive still image and 3D image sensor data from the image sensor assembly 132. The image processor 134 may package and send the image sensor data (“QA image data”) to the image data processing engine 708, which may process the QA image data, store the QA image data in the QA data store 722 for later retrieval, and/or transmit the QA image data to another device or engine (e.g., the model generation engine 710).

In some examples, the image data processing engine 708 may include circuitry for generating views/images from the scan data and/or processing data from the different views (in addition to or instead of the image processor 134). For instance, the image data processing engine 708 may be configured to generate at least one of a fat recognition (FRS) object view of a QA sample, a laser scatter object view of a QA sample, and a height mode object view of a QA sample from the QA image data (e.g., a 2D representation of the height or elevation of the scene). The image data processing engine 708 may include circuitry for executing one or more feature recognition modules for identifying features of the QA sample, such as object outline, shape, color, breading gaps, texture, markings, etc. In that regard, metadata may be added to a file to describe any identified features (e.g., tags, descriptions, etc.). Metadata may be used for identifying a workpiece in a data set, training one or more machine learning models used for QA analysis and/or workpiece processing, etc. The image data processing engine 708 may also process the QA image data to generate a height map for producing a 3D model of the QA sample.

The image data processing engine 708 may be configured to eliminate any background image data when generating QA image data. In that regard, the image data processing engine 708 may be programmed to exclude image data of a certain color (e.g., if the surface on which the product is imaged is of a certain color) and/or image data at a certain depth (e.g., the known distance of the surface relative to the camera). Background data or other data may instead be excluded from data processing in any other suitable manner. For instance, in addition or in the alternative, an imaging support surface (see, e.g., imaging support surface 453 shown in FIGS. 4B and 4C) may be calibrated for each scan (e.g., defined as a reference plane) by defining the imaging support surface as a plane using the 3D laser scanner integrated software (e.g., SOPAS) or plane calculation method as described above. In this manner, anything below the plane can be eliminated when processing QA image data (e.g., the plane is defined or otherwise calibrated for each scan).

A QA sample isolation image segmentation machine learning model, such as that described in International Patent Application No. PCT/US2024/050559, entitled “System And Method For Processing Workpieces”, may also be used to isolate a QA sample on an imaging support surface 453. Using a QA sample isolation image segmentation machine learning model may be useful when an imaging support surface is uneven. In that regard, a QA sample isolation image segmentation machine learning model may improve upon known methods of accounting for an uneven bottom surface of a QA sample (e.g., voids), such as those described in U.S. Pat. No. 11,570,998, incorporated by reference herein. The method described in U.S. Pat. No. 11,570,998 can be used to account for an uneven bottom surface of a product in calculating height or weight/mass of a QA sample. However, such methods do not account for an uneven imaging support surface. Thus, the method described in U.S. Pat. No. 11,570,998 may be improved by using a QA sample image segmentation machine learning model described herein to account for imaging support surface height differences.

The image data processing engine 708 may be configured to generate an image of a QA sample having multiple channels or layers. For instance, the image data processing engine 708 may combine image files into a file(s) with one or more corresponding channels or layers. For instance, an FRS image and a height map image may be combined into a single file with two channels. By combining images into a single file having multiple channels, all the necessary image data can be sent to the model generation engine 710 or another computing device in a single file rather than in separate files. As such, the QA computing device 111 or another computing device can process the file at optimal speeds and with higher accuracy.

In some examples, the image data processing engine 708 may include one or more formatting modules configured to format QA image data for optimal transport to and/or processing by another engine of the QA computing device 111 or another computing device, such as one or more of the machine computing device 130, the monitoring system 112, and the model management computing device 113. For instance, formatting modules of the image data processing engine 708 may perform at least one of transforming QA image data, re-sizing the QA image data, labeling the QA image data, augmenting the QA image data, etc. In the specific example of an image, formatting modules may perform at least one of gray-scaling the image, translating the image, rotating the image, scaling/re-sizing the image, adjusting contrast of the image, changing the contrast of the image data, adapting the image to certain model constraints, etc. Any suitable image processing libraries (e.g., Python) available to the QA computing device 111 may be used to process or format the image data. Processed/formatted QA image data may be saved to the QA data store 722, sent to another engine of the QA computing device 111, and/or sent to another computing device, such as one or more of the machine computing device 130, the monitoring system 112, and the model management computing device 113.

In one example, the image data processing engine 708 sends processed/formatted QA image data for a QA sample to the model management computing device 113 or a computing device (e.g., a cloud-based computing device) in communication with the model management computing device 113. The QA image data may be used to train one or more machine learning models executable by the QA computing device 111 for QA analysis and/or the machine computing device 130 for workpiece thermal processing and/or machine management. In that regard, the same or substantially similar processing/formatting may be done for any data used for both training and using the machine learning models for optimal consistency, reliability, and speed.

In one example, the image data processing engine 708 (and/or the image processor 134) may use one or more image processing modules and/or machine learning models trained to identify the QA sample for QA analysis. For instance, if a variety of thermally processed pieces are being conveyed on a belt, the image data processing engine 708 may be configured to identify the pieces required for QA analysis.

In some examples, the image data processing engine 708 may run an image data optimization module to select conflicting/competing sensor data (e.g., 3D point cloud data from) originating from different image sensors and/or sensor sources. As discussed above, the image sensor assembly 132 may include more than one type of sensor assembly and/or a plurality of sensors of the same type, such as for capturing images showing various views of the product to help generate an accurate 3D or 2D model. For instance, the image sensor assembly 132 may include at least one of a 3D vision system or a 3D laser scanning technology like LiDAR (Light Detection and Ranging), structured light scanning, or photogrammetry, a stereo camera, a Time-of-Flight (ToF) stereoscopic camera, or the like, or combinations thereof. In that regard, if more than one sensor or more than one type of sensor is used, conflicting/competing sensor data (e.g., sensor data pertaining to the same 3D point cloud data of the product) may be captured for the QA sample.

In that regard, the image data processing engine 708 may run an image data optimization module to select conflicting/competing sensor data. The image data optimization module may select 3D point cloud data, for instance, depending on the resolution of the image sensor data, the processing power required to use the image sensor data, the compatibility of the image sensor data with other modules, etc.

The 3D point cloud data selected may also depend on the intended use of the 3D or 2D model. For instance, if a 3D model is being generated for determining the height and/or volume of a QA sample, such as for combining with a weight measurement to determine a temperature measuring location of the product and/or a centroid of the product, to determine a QA sample volume rate change, etc., the 3D point cloud data selected may include 3D laser scan data. If a 3D model is also being generated for determining the surface texture of a QA sample, the 3D point cloud data selected may include stereo camera data (which may produce clearer images of texture). In that regard, different types of sensor data may be selected to generate one or more 3D or 2D models showing different attributes of the QA sample.

In some examples, the image data optimization module of the image data processing engine 708 uses one or more machine learning models (e.g., stored in the QA model data store 726) to identify 3D point cloud data from conflicting/competing sensor data as output based on the accuracy/efficiency/etc., of the model generated for use in a QA analysis as input. For instance, when a sensor data type is selected for generation of a certain type of model (e.g., a 3D model showing volume), the sensor data used for that model can be stored in the QA data store 722 and categorized based on the accuracy/efficiency/etc., of the model for use in a QA analysis (such as confirmed by secondary manual testing or other criteria). The machine learning models may be trained to select 3D point cloud data for each model using model accuracy/efficiency/etc., data or other criteria as training data. The selected 3D point cloud data and/or the 2D or 3D models generated with the 3D cloud point data may be stored in the training data store 724 and/or sent to or retrieved by the model generation engine 710 for training the machine learning models.

It should be noted that any aspects of the image data processing engine 708 may instead or additionally be carried out by the model generation engine 710.

Exemplary aspects of the model generation engine 710 will now be described. The model generation engine 710 may be generally configured to produce a 2D or 3D model of the QA sample using image data and/or 3D laser scan data (e.g., 3D point cloud data) from the image processor 134, the image data processing engine 708, and/or the QA data store 722. In that regard, the model generation engine 710 may include software modules suitable for processing the image data and 3D point cloud data and generating 3D models (showing contour, shape, volume, texture, etc.), 2D models (e.g., showing a height and outline), or other images. For instance, the model generation engine 710 may run the proprietary DSI Q-LINK™ Portioning Software developed by Design Systems, Inc. of Redmond, Washington.

In the examples described herein, QA weight data for the QA sample may be ascertained using the weight measurement assembly 110 (and in preferred embodiments, the weight is obtained substantially simultaneously with the QA image data as discussed above). In that regard, the model generation engine 710 and/or the image data processing engine 708 may be configured to associate QA weight data with QA image data of the QA sample. QA weight data may be specified in metadata of the image data and/or in any 2D or 3D models generated from the QA image data. In this manner, the weight of the QA sample can be considered together with data in the 2D/3D models when performing a QA analysis of the QA sample.

In some examples, the weight measurement assembly 110 may be configured to capture QA weight data for a plurality of related QA samples, such as a plurality of cooked chicken nuggets. It may be beneficial to obtain weight data for each of the plurality of related QA samples to ensure consistency in cooked yield across the plurality of related QA samples. In that regard, a QA analysis may include determining whether each of the plurality of related QA samples has substantially the same weight.

In one example, the weight measurement assembly 110 may be configured to capture QA weight data for each of the plurality of related QA samples as each of the samples are added to a stationary or displaceable platform of the weight measurement assembly 110. For instance, the weight measurement assembly 110 may generate weight data for each of the plurality of related QA samples as each of the plurality of related QA samples are placed on a weight platform, such as a platform of a bench scale, on a conveyor system having a load cell, on a vertically displaceable surface imaged by the QA station 106, etc. A controller of the weight measurement assembly 110 and/or the QA computing device 111 or another computing device may determine, in real time, an individual weight of each of the plurality of related QA samples using a first total weight having N QA samples and a second, subsequent total weight having N+1 QA samples. For instance, the first total weight may be subtracted from the second, subsequent total weight to determine the weight of the Nth+1 QA sample. In that regard, each of the weights may be stored in a data store of the controller/computing device for use in the weight calculation.

In addition or in the alternative, the weight measurement assembly 110 may be configured to may generate QA weight data for each of the plurality of related QA samples after the controller/computing device of the weight measurement assembly receives an input indicating that a sample will be added to the weight platform. For instance, after an operator hits an “Add” button or similar, a QA sample of the plurality of related QA samples may be added to the weight platform. A weight is captured each time after the “Add” input (or similar), and controller of the weight measurement assembly 110 and/or the QA computing device 111 or another computing device may determine, in real time, an individual weight of each of the plurality of related QA samples. Similar to above, the individual weight of each of the plurality of related QA samples may be determined using a first total weight having N QA samples and a second, subsequent total weight (prompted by the “Add” input or similar) having N+1 QA samples and subtracting the first total weight from the second, subsequent total weight to determine the weight of the Nth+1 QA sample. In that regard, each of the weights may again be stored in a data store of the controller/computing device for use in the weight calculation. In other examples, the weight may be zeroed out each time the “Add” input is received, and the weight for the added QA sample may be obtained and recorded.

In another aspect, either of the above techniques for obtaining QA weight data for each of the plurality of related QA samples may be done by performing the technique in reverse. For instance, instead of obtaining a weight measurement each time a QA sample is added to a weight platform, the weight measurement may instead be obtained by first adding all the related QA samples to the platform, and then obtaining individual measurements as each piece is removed from the platform.

In another example, the weight measurement assembly 110 may be configured to capture a total weight for all of the plurality of related QA samples, and the (optionally simultaneously captured) QA image data may be used together with the total weight to determine QA weight data for each of the plurality of related QA samples. For instance, all of the plurality of related QA samples may be placed on a weight platform (e.g., a platform of a bench scale, on a conveyor system having a load cell, on a vertically displaceable surface imaged by the QA station 106, etc.) and a total weight measurement for all of the samples may be obtained. A total volume for all of the plurality of related QA samples and a piece-by-piece volume for each of the plurality of related QA samples may be obtained using QA image data, such as in accordance with one of the techniques described herein. Knowing the total volume of all the samples and the piece-by-piece volume, the ratio of volume for each of the plurality of related QA samples relative to the total volume of all of the samples may be obtained. That volume ratio may then be used to determine a weight for each of the plurality of related QA samples using the total weight for all of the plurality of related QA samples. In other words, each of plurality of related QA samples will have an individual weight to total weight ratio that is substantially the same as the individual volume to total volume ratio.

In any event, the QA weight data for all of the plurality of related QA samples as well as piece-by-piece QA weight data for each of the plurality of related QA samples may be correlated to QA image data capturing all of the plurality of related QA samples. For instance, QA weight data may be specified in metadata of the image data and/or in any 2D or 3D models generated from the QA image data for all of the plurality of related QA samples. In this manner, the QA weight data for all of the plurality of related QA samples as well as piece-by-piece QA weight data for each of the plurality of related QA samples can be considered together with data in the 2D/3D models of all of the plurality of related QA samples when determining a temperature measurement location of a QA sample and/or when performing a QA analysis of the QA sample.

Exemplary aspects of the internal temperature location determination engine 712 will now be described. The internal temperature location determination engine 712 may be generally configured to determine a location of the coldest or hottest expected temperature of the QA sample (hereinafter sometimes simply “internal temperature location”, “centroid”, “core”, or the like). The internal temperature location determination engine 712 may use image data of the image data processing engine 708, 2D and/or 3D model data of the model generation engine 710, weight data of the weight measurement assembly 110, and other data to determine the internal temperature location of the QA sample.

In some examples, the internal temperature location determination engine 712 may use a 3D model and/or height map of the QA sample (e.g., generated by the model generation engine 710) to determine a thickest and/or most central area of the QA sample, and the centroid of the QA sample may be defined as generally halfway through the thickest and/or most central area of the QA sample. Such a simple method may be useful for formed products having a generally consistent shape or where processing speed is crucial.

In some examples, the internal temperature location determination engine 712 may use a 3D model and/or height map of the QA sample (e.g., generated by the model generation engine 710) to divide the QA sample into one or more virtual sections, such as in the method described in U.S. Pat. No. 7,156,730, entitled “Method and system for achieving acceptable process time”, the entire disclosure of which is incorporated herein. The internal temperature location determination engine 712 may locate the centroid of a QA sample at generally the center of the virtual section having the largest cross-sectional area. In some examples, the internal temperature location determination engine 712 may calculate process-time data (i.e., cook-time data) for each virtual section according to a predefined process-time algorithm, and the internal temperature location determination engine 712 may locate the centroid at generally the center of the virtual section having the longest predicted process time.

In some examples, the internal temperature location determination engine 712 may execute a region of interest (ROI) machine learning model configured to generate an ROI of a QA sample as output based on a QA image as input. The ROI may be a proposed portion or outline of an area/object of a QA sample. The ROI may be represented as a binary mask image (e.g., in the mask image, pixels that belong to the ROI are set to 1 and pixels outside the ROI are set to 0) or in another format usable by QA analysis engine 716. The model output may further include symbolic (textual) labels added to the ROI, such as to describe its content in a compact manner, as well as individual points of interest (POI) within the ROI.

The ROI in the QA image may be used to locate a feature in the QA sample or otherwise designate an area in the QA sample for a thickness measurement. In some examples, the ROI output of a ROI machine learning model is used to define an area on a QA sample likely containing a meat area and/or a bone. For instance, for chicken drumsticks, a portion of the drumstick meat located in a certain area relative to the larger tibia bone may have the coldest temperature and should be used to define a centroid.

In some examples, the image sensor assembly 132 of the QA scanning system 108 includes an X-ray assembly for capturing X-ray images of the sample for bone detection and location. An example of x ray scanning devices are disclosed in U.S. Pat. No. 5,585,605, entitled “Optical-scanning system employing laser and laser safety control”, U.S. Pat. No. 10,654,185, entitled “Cutting/portioning using combined X-ray and optical scanning”, U.S. Pat. No. 5,585,603, entitled “Method and system for weighing objects using X-rays”, as well as U.S. Pat. No. 10,721,947 (referenced above), incorporated herein by reference in their entirety. The X-ray image may be combined with any optical image, such as by generating a registered scan of the QA sample. For instance, a registered scan of the QA sample may be generated by mapping an X-ray image of the QA sample onto an optical image of the QA sample. A portion of QA sample meat located in a certain area relative to bone, as identified in the registered scan of the QA sample, may have the coldest temperature and may be used to define a centroid.

In some examples, the ROI output of a ROI machine learning model is used to define an area on a QA sample likely defining a peak thickness/height of the QA sample. For instance, chicken breast fillets are not uniform in thickness/height across the width/length of the chicken breast. Rather, a peak thickness/height of the chicken breast is typically at a rounded end of the chicken breast, and the slimmer part of the breast is near a pointy end of the breast. If part of a chicken breast is thicker than the other, it will take longer for the thicker part to get to a safe temperature during a cooking process. As the thicker part reaches the safe temperature, the slimmer part will dry out. Accordingly, adjustments to chicken breast thermal processing made by made by the machine adjustment engine 718 in response to output of the QA analysis engine 716.

An ROI indicating a peak height area of a chicken breast may include an area in a rounded end of the chicken breast (which is the thickest/tallest area of the breast) that is substantially level. By finding the flattest spot in a peak thickness region of the chicken breast, the ROI will likely exclude any ridges and meat protrusions. The ROI output may also include a POI indicating the precise peak height for the chicken breast. The internal temperature location determination engine 712 may use the ROI/POI output of the ROI machine learning model to determine where the centroid is located. For instance, the centroid may be generally halfway through the ROI/POI of the QA sample.

In examples where a plurality of related QA samples are simultaneously imaged and/or weighed, the internal temperature location determination engine 712 may locate the QA sample(s) having the largest volume and weight, and then the internal temperature location determination engine 712 can locate a thickest part of that largest QA sample(s) to define the centroid. Temperature data for the largest QA sample could be representative of the entire group of QA samples because the centroid temperature of smaller mass QA samples may necessarily be higher. In some examples, the internal temperature location determination engine 712 may additionally or instead locate the QA sample(s) having the smallest volume and weight, and then the internal temperature location determination engine 712 can locate a thickest part of that smallest QA sample(s) to define the centroid. Temperature data for the largest QA sample could be useful because small products typically lose heat faster than larger products. Thus, the temperature measurement assembly 146 may be instructed to measure the smallest QA sample(s) first, within a certain amount of time, etc.

In some examples, the internal temperature location determination engine 712 considers one or more restrictions or restraints for defining the centroid. For instance, the internal temperature location determination engine 712 may be limited to defining a centroid that is more than a certain distance from an edge or outer surface of the QA sample. For instance, if a QA sample is wedged, and the thickest part of the QA sample is at an edge/outer surface, the centroid would be offset from the edge/outer surface a calculated amount. In some examples, the internal temperature location determination engine 712 may be limited to defining the centroid within a portion the QA sample having a minimum width, length, and/or area. In some examples, the internal temperature location determination engine 712 may be limited to defining the centroid within a certain ROI of the QA sample or outside a certain ROI (e.g., outside a scalded portion of the QA sample). It should be appreciated than any suitable restrictions or limitations on centroid determination may be used to best accommodate the QA sample characteristics and thermal processing trends.

The internal temperature location determination engine 712 may output data regarding the centroid location of a QA sample(s) to the controller 154 of the movement assembly 148 to move the temperature measurement device 150 into a temperature measuring position relative to the QA sample. Data regarding the centroid location of a QA sample(s) may include a coordinate location of the outer surface of the QA sample and the centroid location in relation thereto, such as using a polar coordinate system. Any suitable technique may be used to define instructions for moving the temperature measurement device 150, such as a temperature probe, into position for measuring the QA sample temperature substantially at the centroid. Temperature data captured by the temperature measurement device 150 may be sent to and/or retrieved by the QA analysis engine 716 for carrying out a QA analysis for the QA sample.

The internal temperature location determination engine 712, model generation engine 710 and/or the image data processing engine 708 may be configured to associate QA centroid location data, QA weight data, and QA image data with the QA sample. In some examples, the internal temperature location determination engine 712, the model generation engine 710, and/or the image data processing engine 708 may include one or more formatting modules configured to format QA data for optimal transport to and/or processing by the QA computing device 111 or another computing device. For instance, formatting modules of the internal temperature location determination engine 712, the model generation engine 710, and/or the image data processing engine 708 may perform at least one of transforming QA data, re-sizing the QA data, labeling the QA data, augmenting the QA data, etc. Any suitable image processing libraries (e.g., Python) available to the QA computing device 111 may be used to process or format the QA data. Processed/formatted QA data may be saved to the QA data store 722, sent to another engine of the QA computing device 111, and/or sent to another computing device, such as one or more of the machine computing device 130, the monitoring system 112, and the model management computing device 113.

In one example, the internal temperature location determination engine 712, the model generation engine 710, and/or the image data processing engine 708 sends processed/formatted QA data for a QA sample to the model management computing device 113 or a computing device (e.g., a cloud-based computing device) in communication with the model management computing device 113, optionally after being stored in the training data store 724. The QA data may be used to train one or more machine learning models executable by the QA computing device 111 and/or the machine computing device 130. In that regard, the same or substantially similar processing/formatting may be done for any data used for both training and using the machine learning models for optimal consistency, reliability, and speed. In some examples, the one or more machine learning models may be executable by the internal temperature location determination engine 712, the QA analysis engine 716, and/or the machine adjustment engine 718 of the QA computing device 111.

Exemplary aspects of the QA analysis engine 716 will now be described. The QA analysis engine 716 of the QA computing device 111 may be generally configured to analyze QA data, including 2D and/or 3D models or other image data generated by the model generation engine and any associated weight data and associated temperature data (including hardness data, enthalpy data, rate of volume change data, etc.) for performing a QA analysis of QA samples. A QA analysis may include comparing physical parameters/characteristics of a QA sample to a specification for that QA sample and comparing QA sample temperature data to a required lethality temperature or freezing curve stage/point.

A QA analysis for comparing physical parameters/characteristics of a QA sample to a specification for that QA sample may include referencing a QA sample specification. A QA sample specification may include required values for the parameters/characteristics (e.g., minimum, maximum, average, maximum standard deviation, etc.). The QA analysis may be performed to compare any of the physical parameters/characteristics of a QA sample described herein or any other relevant physical parameters/characteristics of a QA sample to a specification for that QA sample. In some examples, the physical parameters/characteristics include breading coverage, color, char marks, and texture. In some examples, the QA analysis includes the techniques described in International Patent Application No. PCT/US2024/012617, entitled “QA System and Method,” the entire disclosure of which is incorporated herein in its entirety.

The specification for a QA sample may be represented as reference data in tabular format, as a 3D model, as a drawing, or as any other suitable format. The specification may be stored for instance, in the QA data store 722 and/or in a data store of the machine computing device 130 or another computing device. The QA analysis engine 716 may retrieve relevant processing specification information stored in the QA data store 722 or another data store for running various modules configured to analyze various aspects of the QA samples.

Based on the results of the QA analysis engine 716, the machine adjustment engine 718 may be used to make or suggest adjustments to the thermal processing machine(s) (including any upstream and downstream machines), it may be used to divert the QA sample or any thermally processed workpieces for further processing, it may be used to provide information to a technician or management personnel (such as through a user interface provided by the communication interface(s) 306, such as via a tablet or monitor positioned near the QA station 106), etc. For instance, notifications and/or alarms may be generated if an out-of-spec QA sample is detected.

In one aspect, the QA analysis engine 716 may run a process lethality module that may include processing the QA temperature, volume, and weight data to determine the process lethality profile for the QA sample. QA enthalpy data may also be processed by the process lethality module. The calculated process lethality profile may be compared to a process lethality profile specification of the QA sample for assessing thermal processing quality of the QA sample. If the process lethality profile falls within a fixed threshold level, then the process lethality module may indicate that the QA sample conforms to the thermal processing specifications. If the process lethality profile falls outside a fixed threshold level, then the process lethality module may indicate that the QA sample is out of thermal processing spec, and in some instances, how far out of spec (e.g., the percentage temperature difference).

In some examples, one or more of various process lethality modules called for execution may depend on the type of temperature measurement used, and vice versa. For instance, the process lethality module(s) called for execution may depend on the type of measurement device used (e.g., probe v. thermal imaging system) and the duration of temperature measurement. The process lethality module(s) called for execution may also or instead depend on other factors, such as workpiece type, thermal processing specifications, etc.

The process lethality profile may be used to determine whether or not the QA sample has been sufficiently thermally treated, for example, if heated to a sufficiently high temperature to be cooked to a desired level. If the process lethality profile indicates, for instance, that the QA sample is overcooked, one or more of the belt speed, the belt loading density, the temperature, moisture, and air velocity settings on the thermal processing device may be automatically adjusted to decrease the level of cooking.

As an alternative to directly varying the process parameters of the thermal processing system 104 or operational parameters at other locations of the workpiece thermal processing management system 102, the QA computing device 111 may instead cause the machine computing device 130 or another computing device to send a notification to operational personnel that adjustments are required in the processing of the food products or that significant problems exist at the thermal processing system 104 or elsewhere. Notification of operational personnel can be via different means, including email, telephone call or message, pager, horn, or other audio signal, flashing lights, etc.

In addition to or as an alternative to sending notifications to operational personnel, the QA computing device 111 and/or the machine computing device 130 could stop the processing of the food product, including shutting down the thermal processing station. Control specifications or limits can be set in advance so that a desired action(s) is/are taken depending on the extent of the deviation between the measured internal temperature and the desired range or limits in internal temperature of the food products.

As noted above, a temperature probe may remain within the QA sample for a predetermined amount of time after leaving the thermal processing system 104, such as an amount of time for carryover cooking and/or an amount of time before a cooked product enters a freezer. The temperature profile may be recorded for the entire duration of probe insertion, and/or just before probe removal (e.g., the probe may obtain a temperature reading 8 seconds after inserting the probe, which may be a typical time between an oven and freezer). Based on the calculated process lethality profile for that predetermined amount of time, a process lethality profile may be calculated for a duration longer than the duration of probe insertion.

In some examples, the probe must remain within the QA sample until the measured core temperature reaches a minimum temperature (e.g., 165 F. for poultry), and if the core does not reach a minimum temperature within a certain duration of time, the probe remains inserted to track process lethality. In some examples, a process lethality module executes one or more machine learning models to determine a process lethality profile of the QA sample for a certain duration of time longer than the duration of probe insertion. Such a machine learning model(s) may be trained using historical temperature/time data of QA samples having similar attributes (e.g., size, shape, thickness, centroid location, etc.) and/or processed under similar conditions (e.g., oven/freezer temperature, humidity, air flow velocity, etc. ; belt loading density; belt speed, etc.).

In some examples, a temperature prediction machine learning model may be executed in order to predict the core temperature of the QA sample as well as to predict the change in the core temperature of the QA sample occurring during an equilibration period. This information can be used to model the level of killing or elimination of the pathogenic microorganisms within the QA sample achieved. If the lethality achieved is insufficient, the operating parameters of the oven and/or other parameters can be adjusted. Likewise, if the lethality achieved is more than sufficient, the operating parameters of the oven and/or other parameters can be adjusted accordingly.

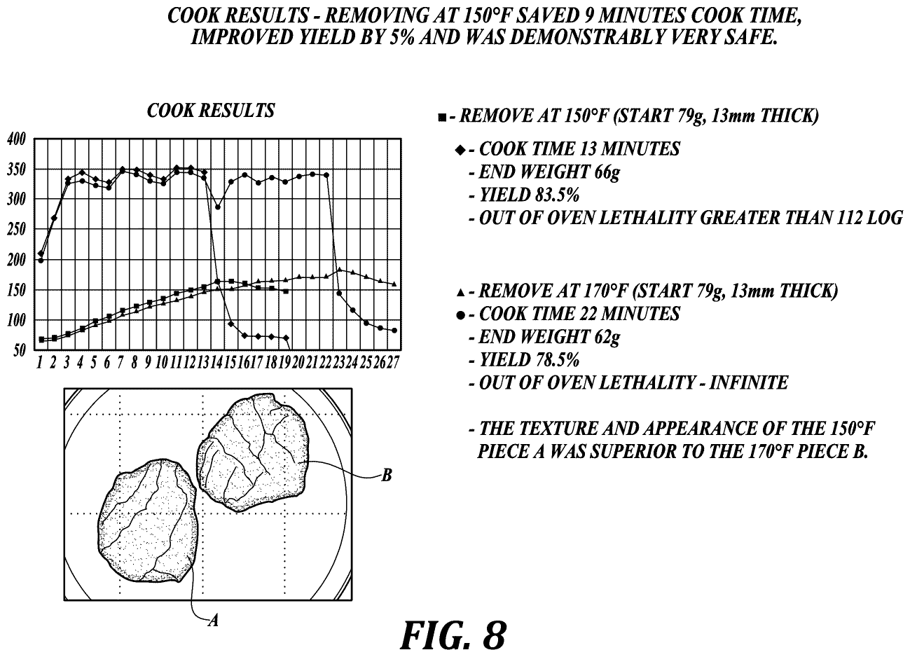

In some examples, a temperature prediction machine learning model may be executed to predict a core temperature of all workpieces for the thermal processing system 104 using a measured core temperature(s) of a QA sample as input. Training data for a temperature prediction machine learning model may be generated using QA sample core time-temperature data. For instance, if a core temperature measurement is captured for a QA sample over a period of time, such as shown in FIG. 8, a rate of temperature change for the QA sample can be estimated with various curve fitting approaches. In that regard, core temperature estimations can be predicted for desired periods of time, and future core temperatures of the QA sample can be predicted. In some examples, the rate of temperature change data could be averaged over all workpieces of a production run or over all QA samples for the run. In some examples, only the data for the most difficult to heat or thickest QA samples may be used to provide predicted results. In any case, suitable margins of error for setting thermal processing target temperatures can be included using a variety of statistical methods. Time-temperature curves for a core of a product are generally very consistent because they are based on internal heat transfer rates, which are more consistent than rates of heat transfer into the products from the air, and lag heat transfer into the product by at least a few minutes (or many logs of lethality).

In some examples, a thermal image of a QA sample is captured by a thermal imaging camera, and the thermal image is provided to an image segmentation machine learning model that segments the thermal image to identify pixels that depict the QA sample. Features extracted from the segmented thermal image (including, but not limited to, the measured surface temperature of the QA sample) may be provided to a temperature prediction machine learning model in order to predict the internal temperature of the QA sample. Along with the measured surface temperature, additional features may be provided to the temperature prediction machine learning model, including one or more of: the 2D and/or 3D image data showing the size and shape of the QA sample; the total surface area of the QA sample; the thickness profile of the QA sample; the volume distribution of the QA sample; a SKU of the QA sample; cooking time or duration; oven temperature/humidity/air velocity, etc. Training data for the temperature prediction machine learning model may be obtained by using temperature probes to generate ground truth internal temperature information.

A temperature prediction machine learning model may be a regression-based model and may include features that represent the thermodynamics of the cooking/cooling/energy distribution process. Output of the temperature prediction machine learning model may be presented to an operator on a dashboard as a trend line in order to identify problems and/or other issues that may arise within the processing line, and/or to provide information that may allow the operator to adjust one or more aspects or parameters of the processing line (including, but not limited to, thermal processing temperature, humidity level, air flow velocity, conveyor speed, etc.).

The output of the temperature prediction machine learning model may alternatively, or in addition, cause the machine computing device 130 to automatically adjust one or more operating parameters of the thermal processing system 104. Further, the control system may send a warning or alert to the operator or even cause the thermal processing system to cease operation.

If the process lethality module indicates that the QA sample has been underprocessed, then the temperature measurement device 150 may need to be sanitized, so as not to cross-contaminate subsequent QA samples of which the temperature is measured. Even if the temperature measurements indicate that the QA sample has been properly and sufficiently processed, good practice indicates that the instrumentation used to physically determine the temperature of food products, especially if a probe or other device is inserted into the food product, sanitation thereof should occur on a periodic basis. As noted above, this can take place by various means, such as by subjecting the temperature probe or other equipment to steam, placing the temperature probe or other equipment in boiling water, or in a stream of very hot air, etc.

An illustrative example of optimizing a thermal processing system to increase cooked product yield will be described with reference to the graph and photograph shown in FIG. 8. In an experiment, chicken breast fillets starting at 79 g and 13 mm thick were removed from an oven after 13 minutes and 22 minutes (see the graph). The 13-minute cooked fillet had an internal temperature of 150 F. (and an out of oven lethality greater than 112 log, according to the “FSIS Cooking Guideline for Meat and Poultry Products (Revised Appendix A), dated December, 2021, Document ID: FSIS-GD-2021-14), and the 22-minute cooked fillet had an internal temperature of 170 F. (with an infinite out of oven lethality). The end weight of the 13-minute cooked fillet was 66 g, resulting in a cooked product yield of 83.5%. The end weight of the 22-minute cooked fillet was 62 g, resulting in a cooked product yield of only 78.5%. Thus, removing the fillet at 150 F. internal temperature saved about 9 minutes of cook time and improved yield by about 5%. As can be seen in the photograph, the texture and appearance of the 13-minute cooked fillet was also superior to the texture and appearance of the 22-minute cooked fillet.

Returning to FIG. 7, in some examples, the QA analysis engine 716 may run a freezing curve module that may include processing, for a frozen QA sample, QA sample temperature data (e.g., if a probe and/or thermal imaging system is used), QA sample hardness data (e.g., if an indenter is used), QA sample volume change rate data, and/or QA sample enthalpy data, in addition to any initial and subsequent QA sample volume and weight data to determine whether the QA sample is appropriately frozen. Using this frozen QA sample measurement data, the freezing curve for a QA sample can be calculated, a freezing stage/point may be determined, a starting frozen temperature of the QA sample may be determined, etc. (“frozen QA sample freezing curve data” or the like), with a computing device (e.g., the QA computing device 111). The frozen QA sample freezing curve data may be compared to a corresponding frozen QA sample specification(s), with a computing device (e.g., the QA computing device 111), for assessing thermal processing quality of the QA sample.

For instance, frozen QA sample calculated freezing curve data may be compared to a freezing curve specification data of the QA sample for assessing thermal processing quality of the QA sample. If the calculated QA sample freezing curve data falls within a fixed threshold level, then the freezing curve module may indicate that the QA sample conforms to the thermal processing specifications. If the calculated QA sample freezing curve data falls outside a fixed threshold level (e.g., the frozen QA sample freezing curve data indicates that the frozen QA sample is still above or in the latent zone), then the freezing curve module may indicate that the QA sample is out of thermal processing spec, and in some instances, how far out of spec. In some examples, one or more of various freezing curve modules called for execution may depend on the type of frozen QA sample measurement(s) used, and vice versa. For instance, the freezing curve module(s) called for execution may depend on the type of measurement device(s) used (e.g., probe, thermal imaging system, indenter, enthalpy measurement assembly (e.g., LN₂ v. water), volume rate of change measurement systems (e.g., scanning v. water), etc.). The freezing curve module(s) called for execution may also or instead depend on other factors, such as workpiece type, thermal processing specifications, etc.

The frozen QA sample freezing curve data may be used to determine whether or not the QA sample has been sufficiently thermally treated, for example, if it has been sufficiently frozen or over frozen. If the calculated freezing curve data indicates, for instance, that the QA sample is underfrozen, one or more of the belt speed, the belt loading density, the temperature, moisture, and air velocity settings on the thermal processing device may be automatically adjusted to appropriately shift and/or change the freezing process.

As noted above, as an alternative to directly varying the process parameters of the thermal processing system 104 or operational parameters at other locations of the workpiece thermal processing management system 102, the QA computing device 111 may instead cause the machine computing device 130 or another computing device to send a notification to operational personnel that adjustments are required in the processing of the food products or that significant problems exist at the thermal processing system 104 or elsewhere. Notification of operational personnel can be via different means, including email, telephone call or message, pager, horn, or other audio signal, flashing lights, etc.

In addition to or as an alternative to sending notifications to operational personnel, the QA computing device 111 and/or the machine computing device 130 could stop the processing of the food product, including shutting down the thermal processing station. Control specifications or limits can be set in advance so that a desired action(s) is/are taken depending on the extent of the deviation between the calculated freezing curve data and the desired range or threshold.

In some examples, a temperature prediction machine learning model may be executed to predict and/or determine the frozen QA sample freezing curve data. For instance, a temperature prediction machine learning model may output frozen QA sample freezing curve data using a combination of an enthalpy measurement(s), and a volume change rate(s) of a QA sample, and any other QA sample data (e.g., volume, weight, hardness, etc.) as input. The frozen QA sample freezing curve data can include a QA sample starting temperature, a freezing stage/point, etc.

The frozen QA sample freezing curve data can be used to assess the quality of the frozen QA sample. For instance, the frozen QA sample freezing curve data may be processed by the QA analysis engine 716 of the QA computing device 111, to determine whether the frozen QA sample is within spec, and if out of spec, how far out of spec. If the achieved freezing stage is insufficient, the operating parameters of the freezer and/or other parameters can be adjusted. Likewise, if the QA sample freezing curve is more than sufficient, the operating parameters of the freezer and/or other parameters can be adjusted accordingly.

In some examples, a temperature prediction machine learning model may be executed to predict freezing curve data of all frozen workpieces for the thermal processing system 104 using a calculated freezing curve data of a frozen QA sample as input. Training data for a temperature prediction machine learning model may be generated using frozen QA sample freezing curve data. For instance, a machine learning model may be trained to output freezing curve data of a frozen QA sample based on a hardness level, a sensed temperature, an enthalpy measurement(s), a volume change rate(s), a weight, a volume, etc., of a frozen QA sample corresponding to various thermal processing parameters.

In some examples, a thermal image of a frozen QA sample is captured by a thermal imaging camera, and the thermal image is provided to an image segmentation machine learning model that segments the thermal image to identify pixels that depict the QA sample. Features extracted from the segmented thermal image (including, but not limited to, the measured surface temperature of the frozen QA sample) may be provided to a temperature prediction machine learning model in order to predict the freezing curve of the frozen QA sample. Along with the measured surface temperature, additional features may be provided to the temperature prediction machine learning model, including one or more of: the 2D and/or 3D image data showing the size and shape of the QA sample; the total surface area of the QA sample; the thickness profile of the QA sample; the volume distribution of the QA sample; a SKU of the QA sample; freezer time or duration; freezer temperature/humidity/air velocity, etc. Training data for the temperature prediction machine learning model may be obtained with enthalpy testing, volume change rate testing, etc., such as described herein, to generate ground truth temperature information.

In some examples, one or more machine optimization machine learning models can be executed to determine a thermal processing machine optimization plan (e.g., machine setting adjustments, including the thermal processing machine and/or one or more upstream or downstream processing machines) for achieving a thermal processing goal using the frozen QA sample freezing curve data and any machine settings as input. Training data for such a machine optimization learning model can include initial settings and any adjusted settings of one or more relevant machines (e.g., the thermal processing machine and/or one or more upstream or downstream processing machines) corresponding to the information in the frozen QA sample freezing curve data.

As noted above, a temperature prediction machine learning model may be a regression-based model and may include features that represent the thermodynamics of the cooking/cooling/energy distribution process. Output of the temperature prediction machine learning model may be presented to an operator on a dashboard as a trend line in order to identify problems and/or other issues that may arise within the processing line, and/or to provide information that may allow the operator to adjust one or more aspects or parameters of the processing line (including, but not limited to, thermal processing temperature, humidity level, air flow velocity, conveyor speed, etc.).

The output of the temperature prediction machine learning model may alternatively, or in addition, cause the machine computing device 130 to automatically adjust one or more operating parameters of the thermal processing system 104. Further, the control system may send a warning or alert to the operator or even cause the thermal processing system to cease operation.

Returning to FIG. 7, in some examples, the QA analysis engine 716 may run a texture analysis module that may include comparing texture data taken from the models or other image data generated by the model generation engine 710 to texture specification information for the QA sample (e.g., stored in the QA data store 722 or another data store of the thermal processing system 104). The texture analysis module may include analyzing image data generated by the QA scanning system 108 and/or the model generation engine 710 (e.g., 2D/3D models, color image data, FRS data, height map image data, greyscale image data, structured light data, etc.) and comparing that QA image data to image specification data for texture. It should be understood that “texture” may include any outer appearance of the QA sample, including breading surface profile, char marks, color, etc.

In some examples, the texture analysis module may run a feature recognition subroutine that is configured to match and/or compare features in each of the images. Based on a comparison, the texture analysis module may generate an output indicating whether the QA sample is within spec, such as whether the QA sample has sufficient brown color, adequate knuckling (maximum standard deviation of high ridges and dip pockets), sufficient char marks, minimal breading gaps, sufficient breading texture, etc.

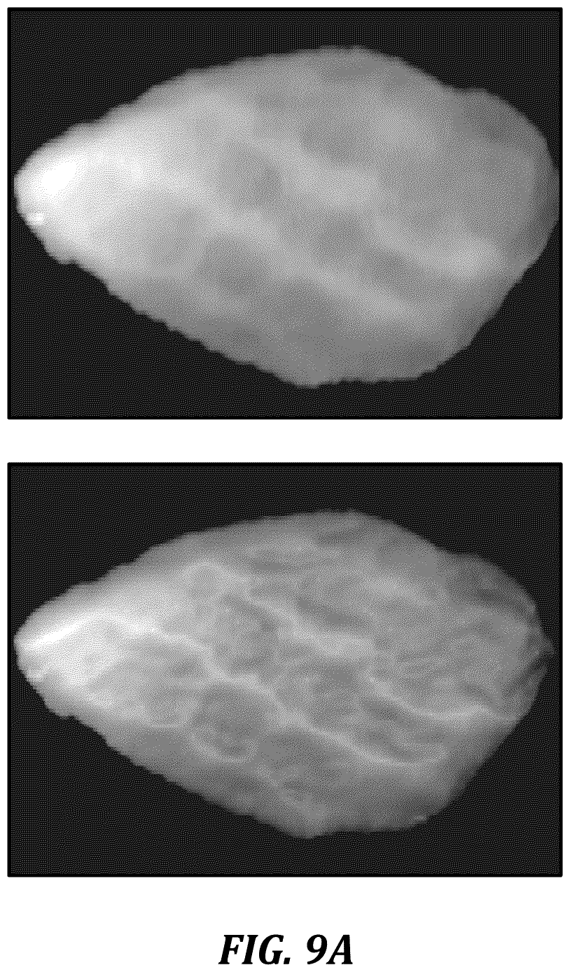

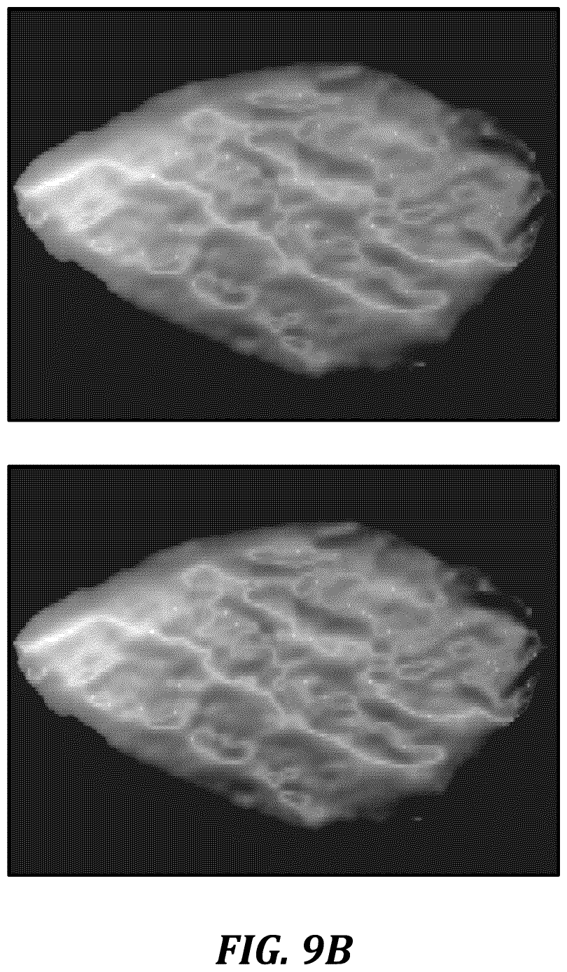

In some examples, the texture analysis module may use one or more filters to modify QA images to enhance features, reduce noise, etc. As noted above, any suitable image processing libraries (e.g., Python) available to the QA computing device 111 may be used to process or format the image data. The filtered QA image data may be used to define features of a QA sample for texture analysis, such as heights and valleys of breading, as shown in FIG. 9A and FIG. 9B (wherein the filter being applied is enhancing the image data in the progression of images shown).

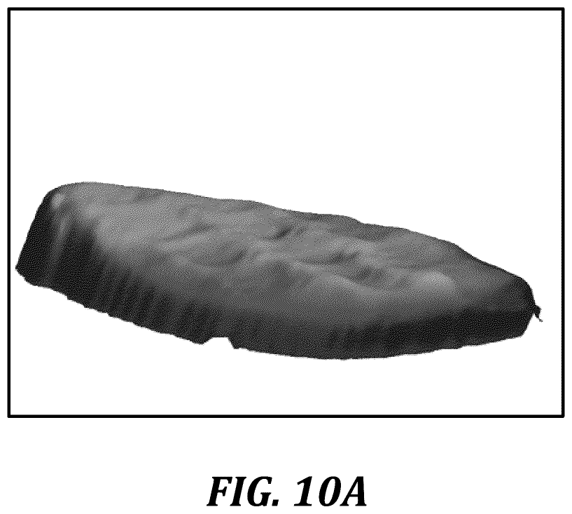

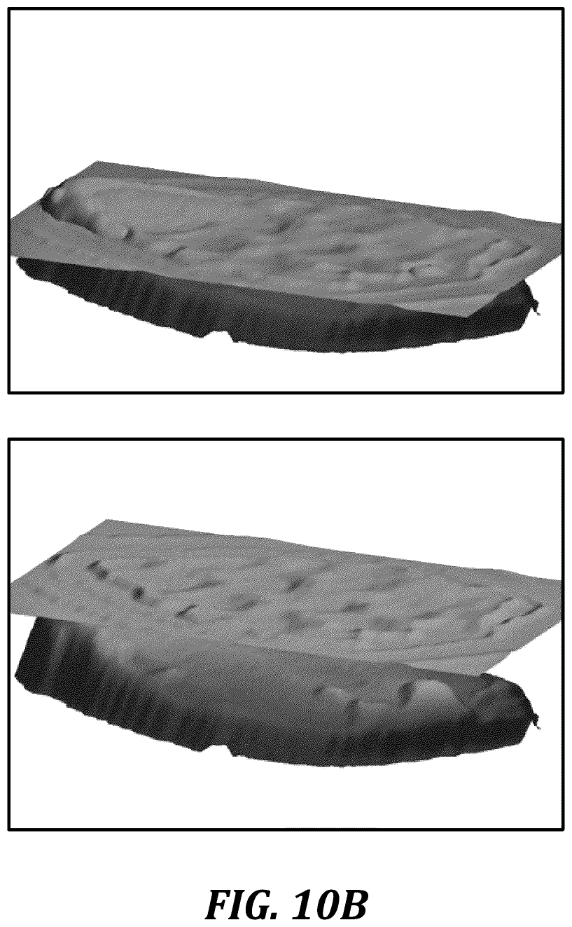

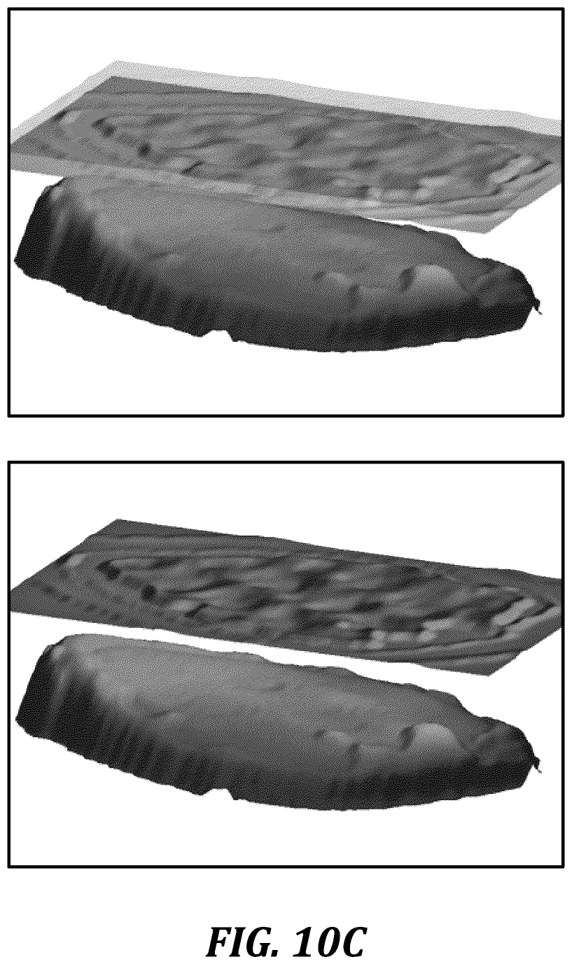

With reference to FIG. 10A, FIG. 10B, FIG. 10C, in some examples, the texture analysis module may include performing a surface extraction of the QA sample and analyzing the surface extraction data to determine whether the surface texture is within QA specification. Surface extraction may be used if the QA sample is warped and the surface irregularity would cause false positive or negative texture data. For instance, a first ridge of a warped sample may be at a height lower than a second ridge unless and until the outer surface is flattened overall. An example is shown in FIG. 10A, FIG. 10B, FIG. 10C, where a top surface of a warped QA sample is extracted and gradually flattened in the progression of images. The flattened top surface having the texture data can thereafter be analyzed by the QA analysis engine 716.

The data generated by the texture analysis module may be used by the machine adjustment engine 718 to send instructions to the machine computing device 130 to automatically adjust settings of the thermal processing system 104 if needed, provide a notification to an operator, etc. For example, if the QA sample has a color that indicates that the product is out of thermal processing spec (e.g., insufficient browning or charring), the machine computing device 130 may be instructed to adjust its thermal processor settings to ensure adequate thermal processing. The data generated by the texture analysis module may be used by the machine adjustment engine 718 to send instructions to a machine upstream or downstream of the thermal processing system 104, such as a coating machine (e.g., a breader).

In some instances, the data generated by the texture analysis module of the QA analysis module may be used to train one or more machine learning models (e.g., stored in the QA model data store 724) to provide adjustments in machine settings, instructions for machine adjustment, notifications, etc., as output based on texture image data as input. For instance, when QA analysis indicates that a QA sample has a color, marking, texture that is out of spec, the models may be used to automatically adjust processing instructions to ensure adequate processing (e.g., breading, coating, forming, charring, etc.). In that regard, the machine learning models may be trained, for instance, using training data generated from a correlation of the processing instruction adjustments made in response to different QA texture results (stored in the training data store 724).

In some examples, the QA computing device 111 may execute one or more machine learning models that output QA analysis information to the machine adjustment engine 718 and/or the machine computing device 130 using QA data as input. The information may be used to confirm or adjust processing of workpieces of the same or similar type to the QA sample. For instance, the QA analysis engine 716 of the QA computing device 111 may output information regarding a process lethality profile of the QA sample, freezing curve data of the QA sample, a texture of the QA sample, etc.

The QA analysis engine 716 may run various other modules for performing a QA analysis of QA samples. For instance, in some examples, the QA analysis engine 716 may run a product output module that may be used to estimate, for instance, the total volume and/or weight of a production run (the production run “output”), the total volume and/or weight of certain pieces of a production run (e.g., pieces of a certain size or type), etc. For example, a sensor may be used to count pieces or QA samples passing the sensor on the conveyor belt to generate a piece count rate, and the piece count rate may be multiplied by the average weight of each piece (as determined by QA data generated for at least some of the pieces) to provide a production rate in pounds. As another example, an average area of each piece (as determined by QA data generated for at least some of the pieces) may be combined with belt speed and/or piece count to provide belt coverage data. Data generated by the product output module may be used to determine any relevant production output data.

In some examples, the QA analysis engine 716 may train and/or run various other machine learning modules suitable for performing a QA analysis of QA samples, such as one or more of the machine learning modules described in International Patent Application No. PCT/US2024/050559, entitled “System And Method For Processing Workpieces” and/or International Patent Application No. PCT/US2024/012617, entitled “QA System and Method”, both incorporated herein. In that regard, the QA computing device 111 may be configured to store and execute machine learning models necessary for processing the QA data.

The machine learning models, as is typical, may require significant processing power and capacity. Moreover, as processing needs change or as machine learning models are improved, it can be appreciated that the ability to easily access, update, and/or upgrade a separate computing device for use with the thermal processing system 104 and optionally one or more additional processing systems in a facility would be beneficial. In that regard, it may be beneficial to configure aspects of the systems and methods described herein as including a QA computing device 111 that is a local, high power or edge computing device separate from the machine computing device 130, such as the data processing computing device described in International Patent Application No. PCT/US2024/050559. In some examples, the QA computing device 111 is an integrated component of the QA station 106 in wired communication with the components of the QA station 106 (e.g., the image sensor assembly 132, the image processor 134, the weight measurement assembly 110, and the temperature measurement assembly 146), such as through an I/O link master.

In some examples, at least some QA analysis of the QA sample occurs while the temperature measurement device 150 is being moved into a temperature measurement position relative to the QA sample, and/or while the temperature measurement device 150 is obtaining a temperature measurement of the QA sample. In that regard, the time required for performing a QA analysis can be offset by the time required for probing the QA sample and measuring the temperature.

As noted above, the QA image data, QA weight data, QA temperature data, QA hardness data, etc., may be associated to a specific QA sample. In that manner, a QA analysis can consider physical characteristics data, weight data, temperature data, hardness data, etc. of the QA sample. However, in some examples, a QA analysis is performed by the QA analysis engine 716 without correlating the QA image data and QA weight data with the QA temperature data, QA hardness data, etc. For instance, a QA analysis may be performed by the QA analysis engine 716 to determine a process lethality profile of the QA sample for making thermal processing adjustments without consideration of the physical characteristics data and/or weight data. Such a configuration may be useful to increase data processing time of the QA computing device 111.

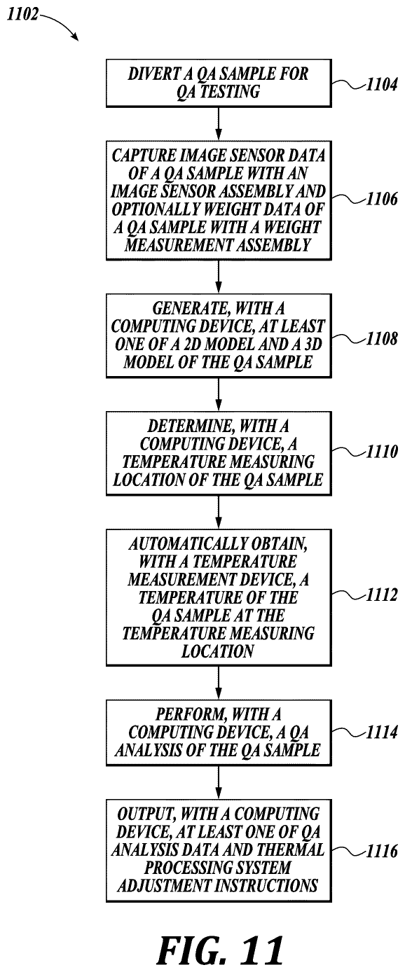

FIG. 11 is a flowchart that illustrates a non-limiting example of method 1102 of performing a quality assurance (QA) analysis for a QA sample, which may be carried out by one or more engines of the QA computing device 111 or any other computing device. The method 1102 may be carried out for workpieces processed by a workpiece thermal processing machine or system and/or to be processed by the machine or system, such as thermal processing system 104.

At block 1104, the method 1102 may include diverting a workpiece for QA analysis. In some examples, a scanning system is used to capture image data of thermally processed workpieces to determine which workpieces of a plurality of workpieces to analyze. For instance, a scanner may be placed near an outlet of a thermal processing system, and based on an analysis of the scan data (such as with an integrated image processor and/or the machine computing device 130 or another computing device), workpieces may be identified as QA samples and diverted to the QA station 106. Identification may occur by use of a sorter, a laser pointer, a light, or by any other suitable means. In some examples, workpieces are not identified as QA samples, and instead, a random selection of workpieces is selected for analysis.

The QA sample may be transferred to the QA station 106 in any suitable manner, such as by manual transport, robotic arm picking, or the like. For instance, is a laser pointer identifies a workpiece as a QA sample, a QA personnel may pick the identified workpiece (e.g., from a moving conveyor) and transport the workpiece to the QA station 106.

In some examples, the method 1102 includes tracking a time duration between picking of a QA sample and a measurement (e.g., temperature, hardness, etc.), wherein picking is generally done at the same point in the process (e.g., at oven or freezer exit). For instance, an operator may enter the time duration through a communication interface(s)s 704 (e.g., a touchscreen) of the QA computing device 111. In some examples, the method 1102 may include measuring a temperature of the QA sample after a predetermined length of time from when the QA sample is picked. The time data may be processed by the QA analysis engine 716 when determining the process lethality or freezing curve of the QA sample.

At block 1106, the method 1102 may include capturing image sensor data (e.g., one or more images) of a QA sample with an image sensor assembly. In some examples, the image sensor assembly is configured to generate at least one still color camera image and/or 3D point cloud data. For instance, the images of the QA sample may be captured using the image sensor assembly 132 described above, which may include at least one still camera and a structured light scanner system. Capturing image sensor data may include moving at least one image sensor of the image sensor assembly relative to the QA sample to capture an image of the QA sample at an oblique angle. The image sensor data may be captured by the image sensor assembly either when the QA sample is stationary or when the QA sample is being moved passed the image sensor assembly (such as with a conveyance system).

At block 1106, the method 1102 may include capturing weight data of the QA sample while simultaneously capturing image data of the QA sample. For instance, the QA sample may be weighed on a bench scale, which may also define the imaging support surface for the image sensor assembly 132.

At block 1108, the method 1102 may include generating, with a computing device, at least one of a 2D model and a 3D model of the QA sample. For instance, the image processor 134 may send still camera image data and/or 3D point cloud data generated from the image sensor data to the image data processing engine 708 of the QA computing device 111. The image data processing engine 708 may generate a height map using the 3D point cloud data to create at least one of a 2D model and a 3D model of the QA sample. The image data processing engine 708 may run an image data optimization module to select 3D point cloud data from conflicting and/or competing sensor data originating from different image sensors and/or different sensor sources of the image sensor assembly. In some examples, one or more machine learning models may be used to identify 3D point cloud data from conflicting/competing sensor data as output based on at least one of an accuracy and efficiency of generating the model with the selected data as input.

At block 1110, the method 1102 may include determining, with a computing device, a temperature measuring location of the workpiece. For instance, the internal temperature location determination engine 712 of the QA computing device 111 may be used to determine an expected coldest or hottest internal location of the workpiece. The internal temperature location determination engine 712 may use one of the techniques described above or any suitable technique.

At block 1112, the method 1102 may include obtaining, with a temperature measurement device, a temperature of the workpiece at the temperature measuring location. For instance, the movement assembly 148 of the temperature measurement assembly 146, which may be configured as a linear rotary actuator controlled linkage assembly (see, e.g., FIG. 4B), a robot (see, e.g., FIG. 6), an X-Y gantry, or the like, may move a temperature probe into a temperature measuring position relative to the QA sample. The temperature probe may be inserted within the QA sample such that the probe may obtain a temperature measurement of at least the temperature measuring location for a predetermined amount of time. As noted above, in some examples, the probe may remain within the QA sample until a certain temperature is obtained, for a prescribed duration of time, etc. Moreover, in some examples a thermal imaging system is used for obtaining a temperature of the workpiece, in which case the step of determining a temperature measuring location of the QA sample may be eliminated, and the movement assembly 148 may be eliminated. In some examples, an indenter or the like is used to determine a hardness of a frozen QA sample and/or an enthalpy measurement of a cooked or frozen QA sample may be obtained, in which case the step of determining a temperature measuring location of the QA sample may again be eliminated.

At block 1114, the method 1102 may include performing, with a computing device, a QA analysis of the QA sample. The QA analysis may be carried out by one or more modules of the QA analysis engine 716. For instance, a process lethality module may be executed to process the QA temperature, volume, and weight data to determine the process lethality profile for the QA sample. QA enthalpy data may also be processed by the process lethality module. The calculated process lethality profile may be compared to a process lethality profile specification of the QA sample for assessing thermal processing quality of the QA sample. If the process lethality profile falls within a fixed threshold level, then the process lethality module may indicate that the QA sample conforms to the thermal processing specifications. If the process lethality profile falls outside a fixed threshold level, then the process lethality module may indicate that the QA sample is out of thermal processing spec, and in some instances, how far out of spec (e.g., the percentage temperature difference).

A freezing curve module of the QA analysis engine 716 may include processing the QA sample temperature data (e.g., if a probe and/or thermal imaging system is used), QA sample hardness data (e.g., if an indenter is used), and/or enthalpy data, in addition to QA sample volume and weight data to determine whether the QA sample is appropriately frozen. The freezing curve data for a QA sample can be calculated, with a computing device (e.g., the QA computing device 111), and the calculated freezing curve data may be compared to a freezing curve specification data of the QA sample for assessing thermal processing quality of the QA sample. If the calculated QA sample freezing curve data falls within a fixed threshold level, then the freezing curve module may indicate that the QA sample conforms to the thermal processing specifications. If the calculated QA sample freezing curve data falls outside a fixed threshold level, then the freezing curve module may indicate that the QA sample is out of thermal processing spec, and in some instances, how far out of spec.

A texture analysis module of the QA analysis engine 716 may include comparing texture data taken from the models or other image data generated with QA image data to texture specification information for the QA sample.

In some examples, the method 1102 may include executing one or more machine learning models to output a QA analysis using QA data as input. For instance, any of the exemplary machine learning models described herein as being configured to be carried out by the QA analysis engine 716 may be used.

At block 1116, the method 1102 may include outputting, with a computing device, at least one of QA analysis data and thermal processing system adjustment instructions. For instance, if the QA analysis indicates that the internal temperature of the QA sample is within specification (e.g., not over or undercooked), the QA data may be stored in the QA data store 722 and/or sent to another computing device, such as the monitoring system 112 and/or model management computing device 113. If the QA analysis indicates that the internal temperature of the QA sample is not within specification (e.g., over or undercooked), the QA data may be sent to the machine adjustment engine 718 for determining and outputting thermal processing system adjustment instructions. Similarly, if the QA analysis indicates that the freezing curve of the QA sample is not within specification (e.g., over or under frozen), the QA data may be sent to the machine adjustment engine 718 for determining and outputting thermal processing system adjustment instructions. In some examples, QA analysis data may be stored in the training data store 724 and used as training data for a QA analysis machine learning model(s).

In some examples, the method 1102 may further include adjusting, with a computing device (such as with the machine adjustment engine 718 of the QA computing device 111), a setting of a machine (such as thermal processing system 104) configured for processing QA samples/workpieces based on the QA analysis of the QA sample.

Although the example method 1102 described above depicts particular operations, the sequence and/or combinations of operations may be altered without departing from the scope of the present disclosure. For example, some of the operations described may be performed in parallel or in a different sequence that does not materially affect the function of the method 1102. In yet some examples, some of the operations described may be omitted. In other examples, different components of an example device or system may be used to implement the method 1102. The method 1102 may be carried out using any of the aspects disclosed herein.

FIG. 12 is a block diagram that illustrates aspects of an exemplary computing device 1200 appropriate for use as a computing device of the present disclosure. While multiple different types of computing devices were discussed above, the exemplary computing device 1200 describes various elements that are common to many different types of computing devices. While FIG. 12 is described with reference to a computing device that is implemented as a device on a network, the description below is applicable to servers, personal computers, mobile phones, smart phones, tablet computers, embedded computing devices, and other devices that may be used to implement portions of examples of the present disclosure. Some examples of a computing device may be implemented in or may include an application-specific integrated circuit (ASIC), a field-programmable gate array (FPGA), or other customized device. Moreover, those of ordinary skill in the art and others will recognize that the computing device 1200 may be any one of any number of currently available or yet to be developed devices.

In its most basic configuration, the computing device 1200 includes at least one processor 1202 and a system memory 1210 connected by a communication bus 1208. Depending on the exact configuration and type of device, the system memory 1210 may be volatile or nonvolatile memory, such as read only memory (“ROM”), random access memory (“RAM”), EEPROM, flash memory, or similar memory technology. Those of ordinary skill in the art and others will recognize that system memory 1210 typically stores data and/or program modules that are immediately accessible to and/or currently being operated on by the processor 1202. In this regard, the processor 1202 may serve as a computational center of the computing device 1200 by supporting the execution of instructions.

As further illustrated in FIG. 12, the computing device 1200 may include a network interface 1206 comprising one or more components for communicating with other devices over a network. Examples of the present disclosure may access basic services that utilize the network interface 1206 to perform communications using common network protocols. The network interface 1206 may also include a wireless network interface configured to communicate via one or more wireless communication protocols, such as Wi-Fi, 2G, 3G, LTE, WiMAX, Bluetooth, Bluetooth low energy, and/or the like. As will be appreciated by one of ordinary skill in the art, the network interface 1206 illustrated in FIG. 12 may represent one or more wireless interfaces or physical communication interfaces described and illustrated above with respect to particular components of the computing device 1200.

In the example depicted in FIG. 12, the computing device 1200 also includes a storage medium 1204. However, services may be accessed using a computing device that does not include means for persisting data to a local storage medium. Therefore, the storage medium 1204 depicted in FIG. 12 is represented with a dashed line to indicate that the storage medium 1204 is optional. In any event, the storage medium 1204 may be volatile or nonvolatile, removable or nonremovable, implemented using any technology capable of storing information such as, but not limited to, a hard drive, solid state drive, CD ROM, DVD, or other disk storage, magnetic cassettes, magnetic tape, magnetic disk storage, and/or the like.

Suitable implementations of computing devices that include a processor 1202, system memory 1210, communication bus 1208, storage medium 1204, and network interface 1206 are known and commercially available. For ease of illustration and because it is not important for an understanding of the claimed subject matter, FIG. 12 does not show some of the typical components of many computing devices. In this regard, the computing device 1200 may include input devices, such as a keyboard, keypad, mouse, microphone, touch input device, touch screen, tablet, and/or the like. Such input devices may be coupled to the computing device 1200 by wired or wireless connections including RF, infrared, serial, parallel, Bluetooth, Bluetooth low energy, USB, or other suitable connections protocols using wireless or physical connections. Similarly, the computing device 1200 may also include output devices such as a display, speakers, printer, etc. Since these devices are well known in the art, they are not illustrated or described further herein.

While the concepts of the present disclosure are susceptible to various modifications and alternative forms, specific examples thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one example,” “an example,” etc., indicate that the example described may include a particular feature, structure, or characteristic, but every example may or may not necessarily include that particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described. Additionally, it should be appreciated that items included in a list in the form of “at least one A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C).

Language such as “up”, “down”, “left”, “right”, “first”, “second”, etc., in the present disclosure is meant to provide orientation for the reader with reference to the drawings and is not intended to be the required orientation of the components or graphical images or to impart orientation limitations into the claims.

In the drawings, some structural or method features may be shown in specific arrangements and/or orderings. However, it should be appreciated that such specific arrangements and/or orderings may not be required. Rather, in some examples, such features may be arranged in a different manner and/or order than shown in the illustrative FIGS. Additionally, the inclusion of a structural or method feature in a particular FIG. is not meant to imply that such feature is required in all examples and, in some examples, it may not be included or may be combined with other features.

The present application may include modifiers such as the words “generally,” “approximately,” “about”, or “substantially.” These terms are meant to serve as modifiers to indicate that, for instance, the “dimension,” “shape,” “temperature,” “time,” or other physical parameter in question need not be exact, but may vary as long as the function that is required to be performed can be carried out.

As used herein, the terms “about”, “approximately,” etc., in reference to a number, is used herein to include numbers that fall within a range of 10%, 5%, or 1% in either direction (greater than or less than) the number unless otherwise stated or otherwise evident from the context (except where such number would exceed 100% of a possible value).

Where electronic or software components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Headings of sections provided in this patent application and the title of this patent application are for convenience only and are not to be taken as limiting the disclosure in any way.

While preferred examples of the present invention have been shown and described herein, it will be apparent to those skilled in the art that such examples are provided by way of example only. Numerous variations, changes, and substitutions will now occur to those skilled in the art without departing from the invention. Various alternatives to the examples of the invention described herein may be employed in practicing the invention. It is intended that the following claims define the scope of the invention and that methods and structures within the scope of these claims and their equivalents be covered.

### LISTING OF EXEMPLARY INNOVATIONS

Clause 1. A computer-implemented method of performing a quality assurance (QA) analysis for a QA sample that is at least one of thermally processed by a thermal processing system and to be thermally processed by a thermal processing system, the method comprising: capturing QA image sensor data of a QA sample with an image sensor assembly of a QA system; generating, with a computing device, at least one of a 2D model and a 3D model of the QA sample using the QA image sensor data; determining, with a computing device, a temperature measuring location of the QA sample using the at least one of 2D model and 3D model of the QA sample; automatically obtaining, with a temperature measurement assembly, an internal temperature of the QA sample at the temperature measuring location; performing, with a computing device, a QA analysis of the QA sample including comparing the internal temperature of the QA sample at the temperature measuring location with a QA specification temperature of the QA sample; and outputting, with a computing device, at least one of QA analysis data and thermal processing system adjustment instructions based on the comparison of the internal temperature of the QA sample at the temperature measuring location with the QA specification temperature of the QA sample.

Clause 2. The computer-implemented method of clause 1, further comprising: obtaining a QA weight measurement of the QA sample with a weight measurement assembly; and determining, with a computing device, a temperature measuring location of the QA sample using the QA weight measurement and the at least one of 2D model and 3D model of the QA sample.

Clause 3. The computer-implemented method of clause 2, further comprising executing, with a computing device, one or more machine learning models to output a QA analysis of the QA sample using at least one of the 2D model and 3D model of the QA sample, the internal temperature of the QA sample, and the QA weight measurement as input.

Clause 4. The computer-implemented method of clause 3, wherein the one or more machine learning models, after receiving at least one of the 2D model and 3D model of the QA sample, the internal temperature of the QA sample, and the QA weight measurement as input, are configured to perform at least one of: determine a process lethality profile of the QA sample; and determine a process lethality profile of a plurality of workpieces to be thermally processed or being thermally processed by the thermal processing system.

Clause 5. The computer-implemented method of any one of clauses 1 to 4, further comprising diverting a QA sample from a plurality of workpieces that are at least one of thermally processed by a thermal processing system and to be thermally processed by the thermal processing system.

Clause 6. The computer-implemented method of clause 5, further comprising tracking, with a computing device, a time between the diverting of the QA sample and the temperature measurement of the QA sample.

Clause 7. The computer-implemented method of clause 1, further comprising: obtaining a QA weight measurement of the QA sample with a weight measurement assembly; and executing one or more machine learning models, with a computing device, to output a temperature measuring location of the QA sample using the at least one of 2D model and 3D model of the QA sample and the QA weight measurement of the QA sample as input.

Clause 8. The computer-implemented method of any one of clauses 1 to 4, further comprising adjusting, with a computing device, a setting of the thermal processing system based on the QA analysis of the QA sample.

Clause 9. The computer-implemented method of any one of clauses 1 to 4, further comprising outputting, with a computing device, at least one thermal processing system setting adjustment as a list of possible adjustments based on the QA analysis of the QA sample.

Clause 10. The computer-implemented method of clause 1, further comprising executing, with a computing device, one or more machine learning models to output a QA analysis of the QA sample using at least one of the 2D model and 3D model of the QA sample and the internal temperature of the QA sample as input.

Clause 11. The computer-implemented method of clause 10, wherein the one or more machine learning models, after receiving at least one of the 2D model and 3D model of the QA sample and the internal temperature of the QA sample as input, are configured to perform at least one of: determine a process lethality profile of the QA sample; and determine a process lethality profile of a plurality of workpieces to be thermally processed or being thermally processed by the thermal processing system.

Clause 12. The computer-implemented method of clause 1, wherein determining, with a computing device, a temperature measuring location of the QA sample using the at least one of 2D model and 3D model of the QA sample includes generating a region of interest (ROI) in an image of the QA sample to identify a thickest location of the QA sample.

Clause 13. The computer-implemented method of clause 12, wherein the ROI defines an area on a QA sample likely containing a meat area near a bone and/or a bone.

Clause 14. The computer-implemented method of clause 12 or 13, further comprising executing one or more machine learning models to output the ROI in an image of the QA sample using the at least one of 2D model and 3D model of the QA sample as input.

Clause 15. The computer-implemented method of clause 1, further comprising executing one or more machine learning models, with a computing device, to output a temperature measuring location of the QA sample using the at least one of 2D model and 3D model of the QA sample as input.

Clause 16. The computer-implemented method of clause 1, further comprising moving at least one image sensor of the image sensor assembly relative to the QA sample to capture an image of the QA sample at an oblique angle.

Clause 17. The computer-implemented method of clause 1, wherein the image sensor assembly includes at least one of stereo camera, a structure light scanner system, and a still camera.

Clause 18. The computer-implemented method of clause 1, further comprising running, with a computing device, an image data optimization module to select QA image sensor data from at least one of conflicting and competing sensor data originating from at least one of different image sensors and different sensor data sources of the image sensor assembly.

Clause 19. The computer-implemented method of clause 1, further comprising selecting, with a computing device, the QA image sensor data depending on at least one of resolution of the image sensor data, processing power required to use the image sensor data, compatibility of the image sensor data with modules of the computing device, accuracy and/or efficiency of generating the model with the selected data as input.

Clause 20. The computer-implemented method of clause 1, further comprising using, with a computing device, one or more machine learning models to select QA image sensor data from at least one of conflicting and competing sensor data as output based on at least one of an accuracy and efficiency of generating the model with the selected image sensor data as input.

Clause 21. The computer-implemented method of clause 1, further comprising conveying the QA sample beneath the image sensor assembly with a conveyance system.

Clause 22. The computer-implemented method of clause 1, further comprising: capturing color sensor data of the QA sample with the image sensor assembly; and using one or more machine learning models to grade a texture of the QA sample as output using one or more of color sensor data and the at least one of 2D model and 3D model of the QA sample as input.

Clause 23. The computer-implemented method of clause 1, further comprising: capturing color sensor data of the QA sample with the image sensor assembly; and performing, with a computing device, a QA analysis of the QA sample by comparing the color sensor data of the QA sample captured with the image sensor assembly with color data values from a QA specification of the QA sample.

Clause 24. The computer-implemented method of clause 1, further comprising: positioning the QA sample on a vertically displaceable surface; capturing one or more images with the image sensor assembly that show a vertical displacement of the vertically displaceable surface caused by a weight of the QA sample; and processing image data showing the vertical displacement of the vertically displaceable surface to obtain a QA weight measurement of the QA sample.

Clause 25. The computer-implemented method of clause 1, further comprising defining, with a computing device, an imaging support surface plane that is substantially parallel to an imaging support surface on which the QA sample rests during imaging, wherein the imaging support surface plane may be used as a reference from which all height measurements for the QA sample may be determined.

Clause 26. The computer-implemented method of clause 25, further comprising: obtaining a QA weight measurement of the QA sample with a bench scale having a platform that defines the imaging support surface; and determining, with a computing device, a temperature measuring location of the QA sample using the QA weight measurement and the at least one of 2D model and 3D model of the QA sample.

Clause 27. The computer-implemented method of clause 26, further comprising executing, with a computing device, one or more machine learning models to output a QA analysis of the QA sample using at least one of the 2D model and 3D model of the QA sample, the internal temperature of the QA sample, and the QA weight measurement as input.

Clause 28. The computer-implemented method of clause 27, wherein the one or more machine learning models, after receiving at least one of the 2D model and 3D model of the QA sample, the internal temperature of the QA sample, and the QA weight measurement as input, are configured to perform at least one of: determine a process lethality profile of the QA sample; and determine a process lethality profile of a plurality of workpieces to be thermally processed or being thermally processed by the thermal processing system.

Clause 29. The computer-implemented method of clause 28, further comprising adjusting, with a computing device, a setting of the thermal processing system based on the QA analysis of the QA sample.

Clause 30. The computer-implemented method of clause 1, further comprising: obtaining, with a weight measurement assembly, a QA weight measurement for each of a plurality of related QA samples; capturing, with the image sensor assembly, QA image sensor data of the plurality of related QA samples; identifying, with a computing device, each of the plurality of related QA samples in the QA image sensor data; correlating, with a computing device, a QA weight measurement for each of the plurality of related QA samples to each of the identified plurality of related QA samples in the QA image sensor data; determining, with a computing device, a temperature measuring location of at least one of the plurality of related QA samples using the QA image sensor data of the plurality of related QA samples and the QA weight measurement for each of the plurality of related QA samples; automatically obtaining, with a temperature measurement assembly, an internal temperature of the at least one of the plurality of related QA samples at the temperature measuring location; performing, with a computing device, a QA analysis of the at least one of the plurality of related QA samples including comparing the internal temperature of the at least one of the plurality of related QA samples at the temperature measuring location with a QA specification temperature of the at least one of the plurality of related QA samples; and outputting, with a computing device, at least one of QA analysis data and thermal processing system adjustment instructions based on the comparison of the internal temperature of the at least one of the plurality of related QA samples at the temperature measuring location with the QA specification temperature of the at least one of the plurality of related QA samples.

Clause 31. The computer-implemented method of clause 30, further comprising executing, with a computing device, one or more machine learning models to output a QA analysis of the at least one of the plurality of related QA samples using at least one of the QA image sensor data of the plurality of related QA samples, the internal temperature of the of the at least one of the plurality of related QA samples, and the QA weight measurement of the at least one of the plurality of related QA samples as input.

Clause 32. The computer-implemented method of clause 31, wherein the one or more machine learning models, after receiving at least one of the QA image sensor data of the plurality of related QA samples, the internal temperature of the of the at least one of the plurality of related QA samples, and the QA weight measurement of the at least one of the plurality of related QA samples as input, are configured to perform at least one of: determine a process lethality profile of the at least one of the plurality of related QA samples; and determine a process lethality profile of the plurality of related QA samples.

Clause 33. A quality assurance (QA) analysis system for performing a QA analysis of a QA sample that is at least one of thermally processed by a thermal processing system and to be thermally processed by a thermal processing system, the system comprising: an image sensor assembly configured for capturing QA image sensor data of a QA sample; a temperature measurement assembly configured for automatically obtaining an internal temperature of the QA sample at a temperature measuring location; a processor; and a memory storing instructions that, when executed by the processor, cause a computing device of the QA system to: generate at least one of a 2D model and a 3D model of the QA sample using the QA image sensor data; determine the temperature measuring location of the QA sample using the at least one of 2D model and 3D model of the QA sample; perform a QA analysis of the QA sample including comparing the internal temperature of the QA sample at the temperature measuring location with a QA specification temperature of the QA sample; and output at least one of QA analysis data and thermal processing system adjustment instructions based on the comparison of the internal temperature of the QA sample at the temperature measuring location with the QA specification temperature of the QA sample.

Clause 34. The system of clause 33, further comprising: a weight measurement assembly configured for obtaining a QA weight measurement of the QA sample; and wherein the memory storing instructions that, when executed by the processor, cause a computing device of the QA system to: determine a temperature measuring location of the QA sample using the QA weight measurement and the at least one of 2D model and 3D model of the QA sample.

Clause 35. The system of Clause 34, wherein the memory storing instructions that, when executed by the processor, cause a computing device of the QA system to: execute one or more machine learning models to output a QA analysis of the QA sample using at least one of the 2D model and 3D model of the QA sample, the internal temperature of the QA sample, and the QA weight measurement as input.

Clause 36. The system of clause 35, wherein the one or more machine learning models, after receiving at least one of the 2D model and 3D model of the QA sample, the internal temperature of the QA sample, and the QA weight measurement as input, are configured to perform at least one of: determine a process lethality profile of the QA sample; and determine a process lethality profile of a plurality of workpieces to be thermally processed or being thermally processed by the thermal processing system.

Clause 37. The system of any one of clauses 33 to 36, further comprising a diverting assembly for manually diverting a QA sample from a plurality of workpieces that are at least one of thermally processed by a thermal processing system and to be thermally processed by the thermal processing system.

Clause 38. The system of clause 33, further comprising a tracking assembly configured to track a time between the manual diverting of the QA sample and the temperature measurement of the QA sample.

Clause 39. The system of clause 33, further comprising: a weight measurement assembly configured for obtaining a QA weight measurement of the QA sample; and wherein the memory storing instructions that, when executed by the processor, cause a computing device of the QA system to: execute one or more machine learning models to output a temperature measuring location of the QA sample using the at least one of 2D model and 3D model of the QA sample and the QA weight measurement of the QA sample as input.

Clause 40. The system of any one of clauses 33 to 39, wherein the memory storing instructions that, when executed by the processor, cause a computing device of the QA system to: adjust a setting of the thermal processing system based on the QA analysis of the QA sample.

Clause 41. The system of any one of clauses 33 to 38, wherein the memory storing instructions that, when executed by the processor, cause a computing device of the QA system to: output at least one thermal processing system setting adjustment as a list of possible adjustments based on the QA analysis of the QA sample.

Clause 42. The system of clause 33, wherein the memory storing instructions that, when executed by the processor, cause a computing device of the QA system to: execute one or more machine learning models to output a QA analysis of the QA sample using at least one of the 2D model and 3D model of the QA sample and the internal temperature of the QA sample as input.

Clause 43. The system of clause 42, wherein the one or more machine learning models, after receiving at least one of the 2D model and 3D model of the QA sample and the internal temperature of the QA sample as input, are configured to perform at least one of: determine a process lethality profile of the QA sample; and determine a process lethality profile of a plurality of workpieces to be thermally processed or being thermally processed by the thermal processing system.

Clause 44. The system of clause 33, wherein the memory storing instructions that, when executed by the processor, cause a computing device of the QA system to: determine a temperature measuring location of the QA sample using the at least one of 2D model and 3D model of the QA sample includes generating a region of interest (ROI) in an image of the QA sample to identify a thickest location of the QA sample.

Clause 45. The system of clause 44, wherein the ROI defines an area on a QA sample likely containing a meat area near a bone and/or a bone.

Clause 46. The system of clause 44 or 45, wherein the memory storing instructions that, when executed by the processor, cause a computing device of the QA system to: execute one or more machine learning models to output the ROI in an image of the QA sample using the at least one of 2D model and 3D model of the QA sample as input.

Clause 47. The system of clause 33, wherein the memory storing instructions that, when executed by the processor, cause a computing device of the QA system to: execute one or more machine learning models, with a computing device, to output a temperature measuring location of the QA sample using the at least one of 2D model and 3D model of the QA sample as input.

Clause 48. The system of clause 33, wherein the at least one image sensor of the image sensor assembly is moveable relative to the QA sample to capture an image of the QA sample at an oblique angle.

Clause 49. The system of clause 33, wherein the image sensor assembly includes at least one of stereo camera, a structure light scanner system, and a still camera.

Clause 50. The system of clause 33, wherein the memory storing instructions that, when executed by the processor, cause a computing device of the QA system to: run an image data optimization module to select QA image sensor data from at least one of conflicting and competing sensor data originating from at least one of different image sensors and different sensor data sources of the image sensor assembly.

Clause 51. The system of clause 33, wherein the memory storing instructions that, when executed by the processor, cause a computing device of the QA system to: select the QA image sensor data depending on at least one of resolution of the image sensor data, processing power required to use the image sensor data, compatibility of the image sensor data with modules of the computing device, accuracy and/or efficiency of generating the model with the selected data as input.

Clause 52. The system of clause 33, wherein the memory storing instructions that, when executed by the processor, cause a computing device of the QA system to: execute one or more machine learning models to select QA image sensor data from at least one of conflicting and competing sensor data as output based on at least one of an accuracy and efficiency of generating the model with the selected image sensor data as input.

Clause 53. The system of clause 33, further comprising a conveyance assembly for conveying the QA sample beneath the image sensor assembly.

Clause 54. The system of clause 33, further comprising: a QA weight measurement assembly configured as a bench scale having a platform that defines an imaging support surface.

Clause 55. A computer-implemented method of performing a quality assurance (QA) analysis for a QA sample that is at least one of thermally processed by a thermal processing system and to be thermally processed by a thermal processing system, the method comprising: capturing QA image sensor data of a QA sample with an image sensor assembly of a QA system; generating, with a computing device, at least one of a 2D model and a 3D model of the QA sample using the QA image sensor data; calculating, with a temperature measurement assembly, freezing curve data of the QA sample; performing, with a computing device, a QA analysis of the QA sample including comparing the freezing curve data of the QA sample with QA specification freezing curve data; and outputting, with a computing device, at least one of QA analysis data and thermal processing system adjustment instructions based on the comparison of the freezing curve data of the QA sample with the QA specification freezing curve data.

Clause 56. The computer-implemented method of clause 55, further comprising executing, with a computing device, one or more machine learning models to output a QA analysis of the QA sample using at least one of the 2D model and 3D model of the QA sample and the freezing curve data of the QA sample as input.

Clause 57. The computer-implemented method of clause 55, further comprising determining, with a computing device, a volume of the QA sample using the at least one of 2D model and 3D model of the QA sample.

Clause 58. The computer-implemented method of clause 57, further comprising executing, with a computing device, one or more machine learning models to output a QA analysis of the QA sample using at least one of the 2D model and 3D model of the QA sample, the volume of the QA sample, and the freezing curve data of the QA sample as input.

Clause 59. The computer-implemented method of clause 55, further comprising: obtaining, with the temperature measurement assembly, an enthalpy measurement of the QA sample; and processing, with a computing device, the enthalpy measurement of the QA sample to determine the freezing curve data of the QA sample.

Clause 60. The computer-implemented method of clause 59, further comprising obtaining a QA weight measurement of the QA sample with a weight measurement assembly.

Clause 61. The computer-implemented method of clause 60, further comprising executing, with a computing device, one or more machine learning models to output freezing curve data of the QA sample using at least one of the 2D model and 3D model of the QA sample, the enthalpy measurement of the QA sample, and the weight measurement of the QA sample as input.

Clause 62. The computer-implemented method of clause 55, further comprising: obtaining, with the temperature measurement assembly, a hardness measurement of the QA sample; and processing, with a computing device, the hardness measurement of the QA sample to determine the freezing curve data of the QA sample.

Clause 63. The computer-implemented method of clause 62, further comprising obtaining a QA weight measurement of the QA sample with a weight measurement assembly.

Clause 64. The computer-implemented method of clause 63, further comprising executing, with a computing device, one or more machine learning models to output freezing curve data of the QA sample using at least one of the 2D model and 3D model of the QA sample, the hardness measurement of the QA sample, and the weight measurement of the QA sample as input.

Clause 65. The computer-implemented method of clause 57, 58, 59, or 62, further comprising obtaining a QA weight measurement of the QA sample with a weight measurement assembly.

Clause 66. The computer-implemented method of clause 61, 64, or 65, further comprising obtaining a QA weight measurement of the QA sample with a weight measurement assembly while substantially simultaneously capturing QA image sensor data of the QA sample.

Clause 67. The computer-implemented method of clause 66, further comprising executing, with a computing device, one or more machine learning models to output a QA analysis of the QA sample using at least one of the 2D model and 3D model of the QA sample, the freezing curve data of the QA sample, and the QA weight measurement as input.

Clause 68. The computer-implemented method of clause 67, wherein the one or more machine learning models, after receiving at least one of the 2D model and 3D model of the QA sample, the freezing curve data of the QA sample, and the QA weight measurement as input, are configured to determine freezing curve data of a plurality of workpieces to be thermally processed or being thermally processed by the thermal processing system.

Clause 69. The computer-implemented method of any one of clauses 55 to 68, further comprising diverting a QA sample from a plurality of workpieces that are at least one of thermally processed by a thermal processing system and to be thermally processed by the thermal processing system; and tracking, with a computing device, a time between the diverting of the QA sample and the temperature measurement of the QA sample.

Clause 70. The computer-implemented method of clause 55, further comprising: obtaining a QA weight measurement of the QA sample with a weight measurement assembly; and executing one or more machine learning models, with a computing device, to output freezing curve data of the QA sample using the at least one of 2D model and 3D model of the QA sample and the QA weight measurement of the QA sample as input.

Clause 71. The computer-implemented method of any one of clauses 55 to 70, further comprising adjusting, with a computing device, a setting of the thermal processing system based on the QA analysis of the QA sample.

Clause 72. The computer-implemented method of any one of clauses 57 to 70, further comprising outputting, with a computing device, at least one thermal processing system setting adjustment as a list of possible adjustments based on the QA analysis of the QA sample.

Clause 73. The computer-implemented method of clause 55, further comprising moving at least one image sensor of the image sensor assembly relative to the QA sample to capture an image of the QA sample at an oblique angle.

Clause 74. The computer-implemented method of clause 55, wherein the image sensor assembly includes at least one of a stereo camera, a structure light scanner system, and a still camera.

Clause 75. The computer-implemented method of clause 55, further comprising running, with a computing device, an image data optimization module to select QA image sensor data from at least one of conflicting and competing sensor data originating from at least one of different image sensors and different sensor data sources of the image sensor assembly.

Clause 76. The computer-implemented method of clause 55, further comprising selecting, with a computing device, the QA image sensor data depending on at least one of resolution of the image sensor data, processing power required to use the image sensor data, compatibility of the image sensor data with modules of the computing device, accuracy and/or efficiency of generating the model with the selected data as input.

Clause 77. The computer-implemented method of clause 55, further comprising using, with a computing device, one or more machine learning models to select QA image sensor data from at least one of conflicting and competing sensor data as output based on at least one of an accuracy and efficiency of generating the model with the selected image sensor data as input.

Clause 78. The computer-implemented method of clause 55, further comprising conveying the QA sample beneath the image sensor assembly with a conveyance system.

Clause 79. The computer-implemented method of clause 55, further comprising: capturing color sensor data of the QA sample with the image sensor assembly; and using one or more machine learning models to grade a texture of the QA sample as output using one or more of color sensor data and the at least one of 2D model and 3D model of the QA sample as input.

Clause 80. The computer-implemented method of clause 55, further comprising: capturing color sensor data of the QA sample with the image sensor assembly; and performing, with a computing device, a QA analysis of the QA sample by comparing the color sensor data of the QA sample captured with the image sensor assembly with color data values from a QA specification of the QA sample.

Clause 81. The computer-implemented method of clause 55, further comprising: positioning the QA sample on a vertically displaceable surface; capturing one or more images with the image sensor assembly that show a vertical displacement of the vertically displaceable surface caused by a weight of the QA sample; and processing image data showing the vertical displacement of the vertically displaceable surface to obtain a QA weight measurement of the QA sample.

Clause 82. The computer-implemented method of clause 55, further comprising defining, with a computing device, an imaging support surface plane that is substantially parallel to an imaging support surface on which the QA sample rests during imaging, wherein the imaging support surface plane may be used as a reference from which all height measurements for the QA sample may be determined.

Clause 83. The computer-implemented method of clause 55, further comprising: obtaining, with a weight measurement assembly, a QA weight measurement for each of a plurality of related QA samples; capturing, with the image sensor assembly, QA image sensor data of the plurality of related QA samples; identifying, with a computing device, each of the plurality of related QA samples in the QA image sensor data; correlating, with a computing device, a QA weight measurement for each of the plurality of related QA samples to each of the identified plurality of related QA samples in the QA image sensor data; determining, with a computing device, the QA weight measurement for each of the plurality of related QA samples; calculating, with a temperature measurement assembly, freezing curve data of at least one of the plurality of related QA samples; performing, with a computing device, a QA analysis of the at least one of the plurality of related QA samples including comparing the calculated freezing curve data of the at least one of the plurality of related QA samples with QA specification freezing curve data of the at least one of the plurality of related QA samples; and outputting, with a computing device, at least one of QA analysis data and thermal processing system adjustment instructions based on the comparison of the calculated freezing curve data of the at least one of the plurality of related QA with the QA specification freezing curve data of the at least one of the plurality of related QA samples.

Clause 84. The computer-implemented method of clause 83, further comprising executing, with a computing device, one or more machine learning models to output a QA analysis of the at least one of the plurality of related QA samples using at least one of the QA image sensor data of the plurality of related QA samples, the calculated freezing curve data of the of the at least one of the plurality of related QA samples, and the QA weight measurement of the at least one of the plurality of related QA samples as input.

Clause 85. The computer-implemented method of clause 84, wherein the one or more machine learning models, after receiving at least one of the QA image sensor data of the plurality of related QA samples, the calculated freezing curve data of the of the at least one of the plurality of related QA samples, and the QA weight measurement of the at least one of the plurality of related QA samples as input, are configured to calculate freezing curve data of the plurality of related QA samples.

Clause 86. The computer-implemented method of clause 55, further comprising: obtaining, with the temperature measurement assembly, a volume change rate of the QA sample; and processing, with a computing device, the volume change rate of the QA sample to determine the freezing curve data of the QA sample.

Clause 87. The computer-implemented method of clause 86, further comprising obtaining a QA weight measurement of the QA sample with a weight measurement assembly.

Clause 88. The computer-implemented method of clause 87, further comprising executing, with a computing device, one or more machine learning models to output freezing curve data of the QA sample using at least one of the 2D model and 3D model of the QA sample, the volume change rate of the QA sample, and the weight measurement of the QA sample as input.

Clause 89. The computer-implemented method of clause 87, wherein the volume change rate of the QA sample is measured by submerging the QA sample in sufficiently warm water to allow the QA sample to be submerged in the water and measuring a change in volume of the water over time.

Clause 90. The computer-implemented method of clause 89, wherein the volume change rate of the QA sample is measured while substantially simultaneously obtaining an enthalpy measurement of the QA sample with water.

Clause 91. The computer-implemented method of clause 87, wherein the volume change rate of the QA sample is measured by analyzing a change in the 2D model and 3D model of the QA sample over time.

Clause 92. The computer-implemented method of clause 55, further comprising: executing, with a computing device, one or more machine optimization machine learning models to output a thermal processing machine optimization plan for achieving a thermal processing goal using the QA sample freezing curve data and any corresponding thermal processing machine settings as input.

Clause 93. The computer-implemented method of clause 92, wherein training data for the machine optimization learning model includes initial settings and any adjusted settings of thermal processing machines corresponding to information in the QA sample freezing curve data.

Clause 94. The computer-implemented method of clause 92, wherein the thermal processing machine optimization plan includes thermal processing machine setting adjustments for achieving a thermal processing goal.

Clause 95. A quality assurance (QA) analysis system for performing a QA analysis of a QA sample that is at least one of thermally processed by a thermal processing system and to be thermally processed by a thermal processing system, the system comprising: an image sensor assembly configured for capturing QA image sensor data of a QA sample; a temperature measurement assembly configured for obtaining QA sample temperature data; a processor; and a memory storing instructions that, when executed by the processor, cause a computing device of the QA system to: generate at least one of a 2D model and a 3D model of the QA sample using the QA image sensor data; determine QA sample freeze curve data of the QA sample using the at least one of 2D model and 3D model of the QA sample and the QA sample temperature data; perform a QA analysis of the QA sample including comparing the freezing curve data of the QA sample with QA specification freezing curve data; and output at least one of QA analysis data and thermal processing system adjustment instructions based on the comparison of the freezing curve data of the QA sample with QA specification freezing curve data.

Clause 96. The system of clause 95, further comprising: a weight measurement assembly configured for obtaining a QA weight measurement of the QA sample while substantially simultaneously capturing QA image sensor data of the QA sample; and wherein the memory storing instructions that, when executed by the processor, cause a computing device of the QA system to: determine a density of the QA sample using the QA weight measurement and the at least one of 2D model and 3D model of the QA sample.

Clause 97. The system of clause 96, wherein the memory storing instructions that, when executed by the processor, cause a computing device of the QA system to: execute one or more machine learning models to output a QA analysis of the QA sample using at least one of the 2D model and 3D model of the QA sample, the QA sample freeze curve data, and the QA weight measurement as input.

Clause 98. The system of clause 95, 96, or 97, wherein the temperature measurement assembly is configured for obtaining one or more of QA sample enthalpy data, QA sample hardness data, and QA sample volume change rate.

Clause 99. The system of clause 95, wherein the memory storing instructions that, when executed by the processor, cause a computing device of the QA system to: carry out one or more of the steps recited in the computer-implemented method as recited in Clauses 55-94.

What is claimed is:

1. A computer-implemented method of performing a quality assurance (QA) analysis for a QA sample that is at least one of thermally processed by a thermal processing system and to be thermally processed by a thermal processing system, the method comprising:
capturing QA image sensor data of a QA sample with an image sensor assembly of a QA system;
generating, with a computing device, at least one of a 2D model and a 3D model of the QA sample using the QA image sensor data;
calculating, with a temperature measurement assembly, freezing curve data of the QA sample;
performing, with a computing device, a QA analysis of the QA sample including comparing the freezing curve data of the QA sample with QA specification freezing curve data; and
outputting, with a computing device, at least one of QA analysis data and thermal processing system adjustment instructions based on the comparison of the freezing curve data of the QA sample with the QA specification freezing curve data.

2. The computer-implemented method of claim 1, further comprising:
determining, with a computing device, a volume of the QA sample using the at least one of 2D model and 3D model of the QA sample; and
executing, with a computing device, one or more machine learning models to output a QA analysis of the QA sample using at least one of the 2D model and 3D model of the QA sample, the volume of the QA sample, and the freezing curve data of the QA sample as input.

3. The computer-implemented method of claim 1, further comprising:
obtaining, with the temperature measurement assembly, one or more of a hardness measurement of the QA sample, an enthalpy measurement of the QA sample, and a volume change rate of the QA sample; and
processing, with a computing device, one or more of the hardness measurement of the QA sample, the enthalpy measurement of the QA sample, and the volume change rate of the QA sample to determine the freezing curve data of the QA sample.

4. The computer-implemented method of claim 3, wherein the volume change rate of the QA sample is measured by submerging the QA sample in sufficiently warm water to allow the QA sample to be submerged in the water and measuring a change in volume of the water over time.

5. The computer-implemented method of claim 4, wherein the volume change rate of the QA sample is measured while substantially simultaneously obtaining an enthalpy measurement of the QA sample with water.

6. The computer-implemented method of claim 5, wherein the volume change rate of the QA sample is measured by analyzing a change in the 2D model and 3D model of the QA sample over time.

7. The computer-implemented method of claim 3, further comprising:
obtaining a QA weight measurement of the QA sample with a weight measurement assembly; and
executing, with a computing device, one or more machine learning models to output freezing curve data of the QA sample using at least one of the 2D model and 3D model of the QA sample, the weight measurement of the QA sample, and one or more of the hardness measurement of the QA sample, the enthalpy measurement of the QA sample, and the volume change rate of the QA sample as input.

8. The computer-implemented method of claim 7, further comprising obtaining a QA weight measurement of the QA sample with a weight measurement assembly while substantially simultaneously capturing QA image sensor data of the QA sample.

9. The computer-implemented method of claim 3, further comprising obtaining, with the temperature measurement assembly, an enthalpy measurement of the QA sample by:
determining, with a weight measurement assembly, a weight of an insulated container;
determining, with the weight measurement assembly, the weight of the QA sample (WQA);
disposing the QA sample within the insulated container;
filling the insulated container with liquid nitrogen (LN2);
determining, with the weight measurement assembly, an initial mass of the LN2 and QA sample in the insulated container (W_{b(QA+C+LN2)});
determining, with the weight measurement assembly, a final mass of the LN₂ and QA sample in the insulated container after a specified time period (t) (W_{a(QA+C+LN2)}); and
determining, with a computing device, enthalpy change (ΔH) of the QA sample based on the amount of LN₂ evaporation.

10. The computer-implemented method of claim 1, further comprising running, with a computing device, an image data optimization module to select QA image sensor data from at least one of conflicting and competing sensor data originating from at least one of different image sensors and different sensor data sources of the image sensor assembly.

11. The computer-implemented method of claim 1, further comprising:
capturing color sensor data of the QA sample with the image sensor assembly; and
using one or more machine learning models to grade a texture of the QA sample as output using one or more of color sensor data and the at least one of 2D model and 3D model of the QA sample as input.

12. The computer-implemented method of claim 1, further comprising:
capturing color sensor data of the QA sample with the image sensor assembly; and
performing, with a computing device, a QA analysis of the QA sample by comparing the color sensor data of the QA sample captured with the image sensor assembly with color data values from a QA specification of the QA sample.

13. The computer-implemented method of claim 1, further comprising defining, with a computing device, an imaging support surface plane that is substantially parallel to an imaging support surface on which the QA sample rests during imaging, wherein the imaging support surface plane may be used as a reference from which all height measurements for the QA sample may be determined.

14. The computer-implemented method of claim 1, further comprising:
obtaining, with a weight measurement assembly, a QA weight measurement for each of a plurality of related QA samples;
capturing, with the image sensor assembly, QA image sensor data of the plurality of related QA samples;
identifying, with a computing device, each of the plurality of related QA samples in the QA image sensor data;
correlating, with a computing device, a QA weight measurement for each of the plurality of related QA samples to each of the identified plurality of related QA samples in the QA image sensor data;
determining, with a computing device, the QA weight measurement for each of the plurality of related QA samples;
calculating, with a temperature measurement assembly, freezing curve data of at least one of the plurality of related QA samples;
performing, with a computing device, a QA analysis of the at least one of the plurality of related QA samples including comparing the calculated freezing curve data of the at least one of the plurality of related QA samples with QA specification freezing curve data of the at least one of the plurality of related QA samples; and
outputting, with a computing device, at least one of QA analysis data and thermal processing system adjustment instructions based on the comparison of the calculated freezing curve data of the at least one of the plurality of related QA with the QA specification freezing curve data of the at least one of the plurality of related QA samples.

15. The computer-implemented method of claim 14, further comprising executing, with a computing device, one or more machine learning models to output a QA analysis of the at least one of the plurality of related QA samples using at least one of the QA image sensor data of the plurality of related QA samples, the calculated freezing curve data of the of the at least one of the plurality of related QA samples, and the QA weight measurement of the at least one of the plurality of related QA samples as input.

16. The computer-implemented method of claim 15, wherein the one or more machine learning models, after receiving at least one of the QA image sensor data of the plurality of related QA samples, the calculated freezing curve data of the of the at least one of the plurality of related QA samples, and the QA weight measurement of the at least one of the plurality of related QA samples as input, are configured to calculate freezing curve data of the plurality of related QA samples.

17. The computer-implemented method of claim 1, further comprising:
executing, with a computing device, one or more machine optimization machine learning models to output a thermal processing machine optimization plan for achieving a thermal processing goal using the QA sample freezing curve data and any corresponding thermal processing machine settings as input.

18. The computer-implemented method of claim 17, wherein training data for the machine optimization learning model includes initial settings and any adjusted settings of thermal processing machines corresponding to information in the QA sample freezing curve data.

19. A computer-implemented method of performing a quality assurance (QA) analysis for a QA sample that is at least one of thermally processed by a thermal processing system and to be thermally processed by a thermal processing system, the method comprising:
capturing QA image sensor data of a QA sample with an image sensor assembly of a QA system;
generating, with a computing device, at least one of a 2D model and a 3D model of the QA sample using the QA image sensor data;
determining, with a computing device, a temperature measuring location of the QA sample using the at least one of 2D model and 3D model of the QA sample;
automatically obtaining, with a temperature measurement assembly, an internal temperature of the QA sample at the temperature measuring location;
performing, with a computing device, a QA analysis of the QA sample including comparing the internal temperature of the QA sample at the temperature measuring location with a QA specification temperature of the QA sample; and
outputting, with a computing device, at least one of QA analysis data and thermal processing system adjustment instructions based on the comparison of the internal temperature of the QA sample at the temperature measuring location with the QA specification temperature of the QA sample.

20. The computer-implemented method of claim 19, further comprising:
obtaining, with a weight measurement assembly, a QA weight measurement for each of a plurality of related QA samples;
capturing, with the image sensor assembly, QA image sensor data of the plurality of related QA samples;
identifying, with a computing device, each of the plurality of related QA samples in the QA image sensor data;
correlating, with a computing device, a QA weight measurement for each of the plurality of related QA samples to each of the identified plurality of related QA samples in the QA image sensor data;
determining, with a computing device, a temperature measuring location of at least one of the plurality of related QA samples using the QA image sensor data of the plurality of related QA samples and the QA weight measurement for each of the plurality of related QA samples;
automatically obtaining, with a temperature measurement assembly, an internal temperature of the at least one of the plurality of related QA samples at the temperature measuring location;
performing, with a computing device, a QA analysis of the at least one of the plurality of related QA samples including comparing the internal temperature of the at least one of the plurality of related QA samples at the temperature measuring location with a QA specification temperature of the at least one of the plurality of related QA samples; and
outputting, with a computing device, at least one of QA analysis data and thermal processing system adjustment instructions based on the comparison of the internal temperature of the at least one of the plurality of related QA samples at the temperature measuring location with the QA specification temperature of the at least one of the plurality of related QA samples.
